(19) United States
(12) Patent Application Publication
(10) Pub. No.: US 2024/0402901 A1
(43) Pub. Date: Dec. 5, 2024

(54) DEVICES, METHODS, AND GRAPHICAL USER INTERFACES FOR SCROLLING CONTENT

(71) Applicant: Apple Inc., Cupertino, CA (US)

(72) Inventors: Evgenii KRIVORUCHKO, San Francisco, CA (US); Danielle M. PRICE, Los Gatos, CA (US); Stephen O. LEMAY, Palo Alto, CA (US); Zoey C. TAYLOR, San Francisco, CA (US); Hugo D. VERWEIJ, Portola Valley, CA (US); Cedric BRAY, Sunnyvale, CA (US); Tom ADRIAENSSEN, Santa Clara, CA (US)

(21) Appl. No.: 18/620,690

(22) Filed: Mar. 28, 2024

Related U.S. Application Data
(60) Provisional application No. 63/528,407, filed on Jul. 23, 2023.
(60) Provisional application No. 63/470,914, filed on Jun. 4, 2023.
(60) Provisional application No. 63/470,877, filed on Jun. 3, 2023.

(51) Int. Cl. G06F 3/04855; G06F 3/01; G06F 3/0481; G06F 3/04845

(52) U.S. Cl. CPC G06F 3/04855; G06F 3/013; G06F 3/017; G06F 3/0481; G06F 3/04845; G06F 2203/04806

(57) ABSTRACT

The present disclosure generally relates to methods and user interfaces scrolling content using various inputs and/or changing an appearance of a scrolling indicator.

### CROSS-REFERENCE TO RELATED APPLICATIONS

This application claims priority to U.S. Patent Application No. 63/528,407, entitled “DEVICES, METHODS, AND GRAPHICAL USER INTERFACES FOR SCROLLING CONTENT,” filed on Jul. 23, 2023; and claims priority to U.S. Patent Application No. 63/470,914, entitled “DEVICES, METHODS, AND GRAPHICAL USER INTERFACES FOR SCROLLING CONTENT,” filed on Jun. 4, 2023; and claims priority to U.S. Patent Application No. 63/470,877, entitled “DEVICES, METHODS, AND GRAPHICAL USER INTERFACES FOR SCROLLING CONTENT,” filed on Jun. 3, 2023, the entire contents of which are hereby incorporated by reference in their entirety.

### TECHNICAL FIELD

The present disclosure relates generally to computer systems that are in communication with a display generation component and one or more input devices that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces scrolling content are cumbersome, inefficient, and limited. For example, systems that provide insufficient feedback for scrolling content, systems that require a series of inputs for scrolling content, and systems that control how content is scrolled are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for scrolling content to users that make interaction with the computer systems more efficient and intuitive for a user. Such methods and interfaces optionally complement or replace conventional methods for scrolling content. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has a touch-sensitive display (also known as a “touch screen” or “touch-screen display”). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for scrolling content. Such methods and interfaces may complement or replace conventional methods for scrolling content. Such methods and interfaces reduce the number, extent, reduce the amount of movement required to scroll content, improving ergonomics of the electronic device, and/or the nature of the inputs from a user and produce a more efficient human-machine interface. For battery-operated computing devices, such methods and interfaces conserve power and increase the time between battery charges.

In some embodiments, a computer system displays a set of controls associated with controlling playback of media content (e.g., transport controls and/or other types of controls) in response to detecting a gaze and/or gesture of the user. In some embodiments, the computer system initially displays a first set of controls in a reduced-prominence state (e.g., with reduced visual prominence) in response to detecting a first input, and then displays a second set of controls (which optionally includes additional controls) in an increased-prominence state in response to detecting a second input. In this manner, the computer system optionally provides feedback to the user that they have begun to invoke display of the controls without unduly distracting the user from the content (e.g., by initially displaying controls in a less visually prominent manner), and then, based on detecting a user input indicating that the user wishes to further interact with the controls, displaying the controls in a more visually prominent manner to allow for easier and more-accurate interactions with the computer system.

In accordance with some embodiments, a method performed at a computer system that is in communication with a display generation component and one or more input devices is described. The method comprises: displaying, via the display generation component, a graphical user interface including: a representation of content; and a scrolling indicator; detecting, via the one or more input devices, a first set of one or more inputs that includes a first input directed at the scrolling indicator; and in response to detecting the first set of one or more inputs: in accordance with a determination that the first input includes a first magnitude of movement, scrolling the representation of content at a first rate; and in accordance with a determination that the first input includes a second magnitude of movement, different from the first magnitude of movement, scrolling the representation of content at a second rate different from the first rate.

In accordance with some embodiments, a non-transitory computer-readable storage medium is described. The non-transitory computer-readable storage medium stores one or more programs configured to be executed by one or more processors of a computer system that is in communication with a display generation component and one or more input devices, the one or more programs including instructions for: displaying, via the display generation component, a graphical user interface including: a representation of content; and a scrolling indicator; detecting, via the one or more input devices, a first set of one or more inputs that includes a first input directed at the scrolling indicator; and in response to detecting the first set of one or more inputs: in accordance with a determination that the first input includes a first magnitude of movement, scrolling the representation of content at a first rate; and in accordance with a determination that the first input includes a second magnitude of movement, different from the first magnitude of movement, scrolling the representation of content at a second rate different from the first rate.

In accordance with some embodiments, a transitory computer-readable storage medium is described. The transitory computer-readable storage medium stores one or more programs configured to be executed by one or more processors of a computer system that is configured to communicate with a display generation component and one or more input devices, the one or more programs including instructions for: displaying, via the display generation component, a graphical user interface including: a representation of content; and a scrolling indicator; detecting, via the one or more input devices, a first set of one or more inputs that includes a first input directed at the scrolling indicator; and in response to detecting the first set of one or more inputs: in accordance with a determination that the first input includes a first magnitude of movement, scrolling the representation of content at a first rate; and in accordance with a determination that the first input includes a second magnitude of movement, different from the first magnitude of movement, scrolling the representation of content at a second rate different from the first rate.

In accordance with some embodiments, a computer system that is configured to communicate with a display generation component and one or more input devices is described. The computer system comprises: one or more processors; and memory storing one or more programs configured to be executed by the one or more processors, the one or more programs including instructions for: displaying, via the display generation component, a graphical user interface including: a representation of content; and a scrolling indicator; detecting, via the one or more input devices, a first set of one or more inputs that includes a first input directed at the scrolling indicator; and in response to detecting the first set of one or more inputs: in accordance with a determination that the first input includes a first magnitude of movement, scrolling the representation of content at a first rate; and in accordance with a determination that the first input includes a second magnitude of movement, different from the first magnitude of movement, scrolling the representation of content at a second rate different from the first rate.

In accordance with some embodiments, a computer system that is configured to communicate with a display generation component and one or more input devices is described. The computer system comprises: means for displaying, via the display generation component, a graphical user interface including: a representation of content; and a scrolling indicator; means for detecting, via the one or more input devices, a first set of one or more inputs that includes a first input directed at the scrolling indicator; and means for in response to detecting the first set of one or more inputs: in accordance with a determination that the first input includes a first magnitude of movement, scrolling the representation of content at a first rate; and in accordance with a determination that the first input includes a second magnitude of movement, different from the first magnitude of movement, scrolling the representation of content at a second rate different from the first rate.

In accordance with some embodiments, a computer program product is described. The computer program product comprises one or more programs configured to be executed by one or more processors of a computer system that is that is in communication with a display generation component and one or more input devices. The one or more programs include instructions for: displaying, via the display generation component, a graphical user interface including: a representation of content; and a scrolling indicator; detecting, via the one or more input devices, a first set of one or more inputs that includes a first input directed at the scrolling indicator; and in response to detecting the first set of one or more inputs: in accordance with a determination that the first input includes a first magnitude of movement, scrolling the representation of content at a first rate; and in accordance with a determination that the first input includes a second magnitude of movement, different from the first magnitude of movement, scrolling the representation of content at a second rate different from the first rate.

In accordance with some embodiments, a method performed at a computer system that is in communication with a display generation component and one or more input devices is described. The method comprises: displaying, via the display generation component, a graphical user interface including: a representation of content; and a scrolling indicator; detecting, via the one or more input devices, a request to scroll the representation of content; in response to detecting the request to scroll the representation of content: in accordance with a determination that the request to scroll the representation of content includes an input directed to a scrolling indicator, providing a first type of non-visual feedback while scrolling the representation of content; and in accordance with a determination that the request to scroll the representation of content includes an input directed to the representation of content, providing a second type non-visual feedback, different from the first type non-visual feedback, while scrolling the representation of content.

In accordance with some embodiments, a non-transitory computer-readable storage medium is described. The non-transitory computer-readable storage medium stores one or more programs configured to be executed by one or more processors of a computer system that is in communication with a display generation component and one or more input devices, the one or more programs including instructions for: displaying, via the display generation component, a graphical user interface including: a representation of content; and a scrolling indicator; detecting, via the one or more input devices, a request to scroll the representation of content; in response to detecting the request to scroll the representation of content: in accordance with a determination that the request to scroll the representation of content includes an input directed to a scrolling indicator, providing a first type of non-visual feedback while scrolling the representation of content; and in accordance with a determination that the request to scroll the representation of content includes an input directed to the representation of content, providing a second type non-visual feedback, different from the first type non-visual feedback, while scrolling the representation of content.

In accordance with some embodiments, a transitory computer-readable storage medium is described. The transitory computer-readable storage medium stores one or more programs configured to be executed by one or more processors of a computer system that is configured to communicate with a display generation component and one or more input devices, the one or more programs including instructions for: displaying, via the display generation component, a graphical user interface including: a representation of content; and a scrolling indicator; detecting, via the one or more input devices, a request to scroll the representation of content; in response to detecting the request to scroll the representation of content: in accordance with a determination that the request to scroll the representation of content includes an input directed to a scrolling indicator, providing a first type of non-visual feedback while scrolling the representation of content; and in accordance with a determination that the request to scroll the representation of content includes an input directed to the representation of content, providing a second type non-visual feedback, different from the first type non-visual feedback, while scrolling the representation of content.

In accordance with some embodiments, a computer system that is configured to communicate with a display generation component and one or more input devices is described. The computer system comprises: one or more processors; and memory storing one or more programs configured to be executed by the one or more processors, the one or more programs including instructions for: displaying, via the display generation component, a graphical user interface including: a representation of content; and a scrolling indicator; detecting, via the one or more input devices, a request to scroll the representation of content; in response to detecting the request to scroll the representation of content: in accordance with a determination that the request to scroll the representation of content includes an input directed to a scrolling indicator, providing a first type of non-visual feedback while scrolling the representation of content; and in accordance with a determination that the request to scroll the representation of content includes an input directed to the representation of content, providing a second type non-visual feedback, different from the first type non-visual feedback, while scrolling the representation of content.

In accordance with some embodiments, a computer system that is configured to communicate with a display generation component and one or more input devices is described. The computer system comprises: means for displaying, via the display generation component, a graphical user interface including: a representation of content; and a scrolling indicator; means for detecting, via the one or more input devices, a request to scroll the representation of content; means for in response to detecting the request to scroll the representation of content: in accordance with a determination that the request to scroll the representation of content includes an input directed to a scrolling indicator, providing a first type of non-visual feedback while scrolling the representation of content; and in accordance with a determination that the request to scroll the representation of content includes an input directed to the representation of content, providing a second type non-visual feedback, different from the first type non-visual feedback, while scrolling the representation of content.

In accordance with some embodiments, a computer program product is described. The computer program product comprises one or more programs configured to be executed by one or more processors of a computer system that is that is in communication with a display generation component and one or more input devices. The one or more programs include instructions for: displaying, via the display generation component, a graphical user interface including: a representation of content; and a scrolling indicator; detecting, via the one or more input devices, a request to scroll the representation of content; in response to detecting the request to scroll the representation of content: in accordance with a determination that the request to scroll the representation of content includes an input directed to a scrolling indicator, providing a first type of non-visual feedback while scrolling the representation of content; and in accordance with a determination that the request to scroll the representation of content includes an input directed to the representation of content, providing a second type non-visual feedback, different from the first type non-visual feedback, while scrolling the representation of content.

In accordance with some embodiments, a method performed at a computer system that is in communication with a display generation component and one or more input devices is described. The method comprises: displaying, via the display generation component, a user interface that includes: a representation of a first portion of scrollable content; and a scrolling indicator that includes: a scroll progress indicator; and a scrolling region that has a first visual characteristic, wherein the scroll progress indicator moves within the scrolling region while the scrollable content is being scrolled; while scrolling through the scrollable content based on a user input and while the first visual characteristic of the scrolling region has a first state, detecting that an end of the scrollable content has been reached; and in response to detecting that the end of the scrollable content has been reached, changing the first visual characteristic of the scrolling region from the first state to a second state, different from the first state.

In accordance with some embodiments, a non-transitory computer-readable storage medium is described. The non-transitory computer-readable storage medium stores one or more programs configured to be executed by one or more processors of a computer system that is in communication with a display generation component and one or more input devices, the one or more programs including instructions for: displaying, via the display generation component, a user interface that includes: a representation of a first portion of scrollable content; and a scrolling indicator that includes: a scroll progress indicator; and a scrolling region that has a first visual characteristic, wherein the scroll progress indicator moves within the scrolling region while the scrollable content is being scrolled; while scrolling through the scrollable content based on a user input and while the first visual characteristic of the scrolling region has a first state, detecting that an end of the scrollable content has been reached; and in response to detecting that the end of the scrollable content has been reached, changing the first visual characteristic of the scrolling region from the first state to a second state, different from the first state.

In accordance with some embodiments, a transitory computer-readable storage medium is described. The transitory computer-readable storage medium stores one or more programs configured to be executed by one or more processors of a computer system that is configured to communicate with a display generation component and one or more input devices, the one or more programs including instructions for: displaying, via the display generation component, a user interface that includes: a representation of a first portion of scrollable content; and a scrolling indicator that includes: a scroll progress indicator; and a scrolling region that has a first visual characteristic, wherein the scroll progress indicator moves within the scrolling region while the scrollable content is being scrolled; while scrolling through the scrollable content based on a user input and while the first visual characteristic of the scrolling region has a first state, detecting that an end of the scrollable content has been reached; and in response to detecting that the end of the scrollable content has been reached, changing the first visual characteristic of the scrolling region from the first state to a second state, different from the first state.

In accordance with some embodiments, a computer system that is configured to communicate with a display generation component and one or more input devices is described. The computer system comprises: one or more processors; and memory storing one or more programs configured to be executed by the one or more processors, the one or more programs including instructions for: displaying, via the display generation component, a user interface that includes: a representation of a first portion of scrollable content; and a scrolling indicator that includes: a scroll progress indicator; and a scrolling region that has a first visual characteristic, wherein the scroll progress indicator moves within the scrolling region while the scrollable content is being scrolled; while scrolling through the scrollable content based on a user input and while the first visual characteristic of the scrolling region has a first state, detecting that an end of the scrollable content has been reached; and in response to detecting that the end of the scrollable content has been reached, changing the first visual characteristic of the scrolling region from the first state to a second state, different from the first state.

In accordance with some embodiments, a computer system that is configured to communicate with a display generation component and one or more input devices is described. The computer system comprises: means for displaying, via the display generation component, a graphical user interface including: a representation of content; and a scrolling indicator; means for detecting, via the one or more input devices, a request to scroll the representation of content; means for in response to detecting the request to scroll the representation of content: in accordance with a determination that the request to scroll the representation of content includes an input directed to a scrolling indicator, providing a first type of non-visual feedback while scrolling the representation of content; and in accordance with a determination that the request to scroll the representation of content includes an input directed to the representation of content, providing a second type non-visual feedback, different from the first type non-visual feedback, while scrolling the representation of content.

In accordance with some embodiments, a computer program product is described. The computer program product comprises one or more programs configured to be executed by one or more processors of a computer system that is that is in communication with a display generation component and one or more input devices. The one or more programs include instructions for: displaying, via the display generation component, a user interface that includes: a representation of a first portion of scrollable content; and a scrolling indicator that includes: a scroll progress indicator; and a scrolling region that has a first visual characteristic, wherein the scroll progress indicator moves within the scrolling region while the scrollable content is being scrolled; while scrolling through the scrollable content based on a user input and while the first visual characteristic of the scrolling region has a first state, detecting that an end of the scrollable content has been reached; and in response to detecting that the end of the scrollable content has been reached, changing the first visual characteristic of the scrolling region from the first state to a second state, different from the first state.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing XR experiences in some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in some embodiments.

FIG. 3 is a block diagram illustrating a display generation component of a computer system that is configured to provide a visual component of the XR experience to the user in some embodiments.

FIG. 4 is a block diagram illustrating a hand tracking unit of a computer system that is configured to capture gesture inputs of the user in some embodiments.

FIG. 5 is a block diagram illustrating an eye tracking unit of a computer system that is configured to capture gaze inputs of the user in some embodiments.

FIG. 6 is a flow diagram illustrating a glint-assisted gaze tracking pipeline in some embodiments.

FIGS. 7A-7AF illustrate example techniques for scrolling content, in some embodiments.

FIG. 8 is a flow diagram of methods of scrolling content, in some embodiments.

FIG. 9 is a flow diagram of methods changing an appearance of a scroll bar, in some embodiments.

### DESCRIPTION OF EMBODIMENTS

The present disclosure relates to user interfaces for providing an extended reality (XR) experience to a user, in some embodiments.

The systems, methods, and GUIs described herein improve user interface interactions with virtual/augmented reality environments in multiple ways.

In some embodiments, a computer system allows a user to scroll content of user interface at different rates based on different magnitudes of movements. Conditionally scrolling the representation of content at different rates based on whether an input has one magnitude of movement or another magnitude of movement performs an operation when a set of conditions has been met without requiring any further input, improves how user interfaces are scrolled using various inputs, and improves how user interfaces are navigated using a rate-based scroll.

In some embodiments, a computer system allows a user to scroll content of user interface using different inputs. Different non-visual feedback is provided based on the input used to scroll the content. Detecting a request to scroll the representation of content and, in response, conditionally providing different non-visual feedback performs an operation when a set of conditions has been met without requiring any further input, provides feedback about how the content is being scrolled, and improves how user interfaces are scrolled using various inputs.

In some embodiments, a visual characteristic of a scrolling region changes. For example, while scrolling through the scrollable content and while a visual characteristic of the scrolling region has one state, the computer detects that an end of the scrollable content has been reached and, in response, changes the first visual characteristic of the scrolling indicator to a different state. Detecting that an end of the scrollable content has been reached while scrolling and, in response, changing the visual characteristic of the scrolling region to a different state provides visual feedback that an end of the content has been reached.

In some embodiments, a computer system displays content in a first region of a user interface. In some embodiments, while the computer system is displaying the content and while a first set of controls are not displayed in a first state, the computer system detects a first input from a first portion of a user. In some embodiments, in response to detecting the first input, and in accordance with a determination that a gaze of the user is directed to a second region of the user interface when the when the first input is detected, the computer system displays, in the user interface, the first set of one or more controls in the first state, and in accordance with a determination that the gaze of the user is not directed to the second region of the user interface when the first input is detected, the computer system forgoes displaying the first set of one or more controls in the first state.

In some embodiments, a computer system displays content in a user interface. In some embodiments, while displaying the content, the computer system detects a first input based on movement of a first portion of a user of the computer system. In some embodiments, in response to detecting the first input, the computer system displays, in the user interface, a first set of one or more controls, where the first set of one or more controls are displayed in a first state and are displayed within a first region of the user interface. In some embodiments, while displaying the first set of one or more controls in the first state: in accordance with a determination that one or more first criteria are satisfied, including a criterion that is satisfied when attention of the user is directed to the first region of the user interface based on a movement of a second portion of the user that is different from the first portion of the user, the computer system transitions from displaying the first set of one or more controls in the first state to displaying a second set of one or more controls in a second state, where the second state is different from the first state.

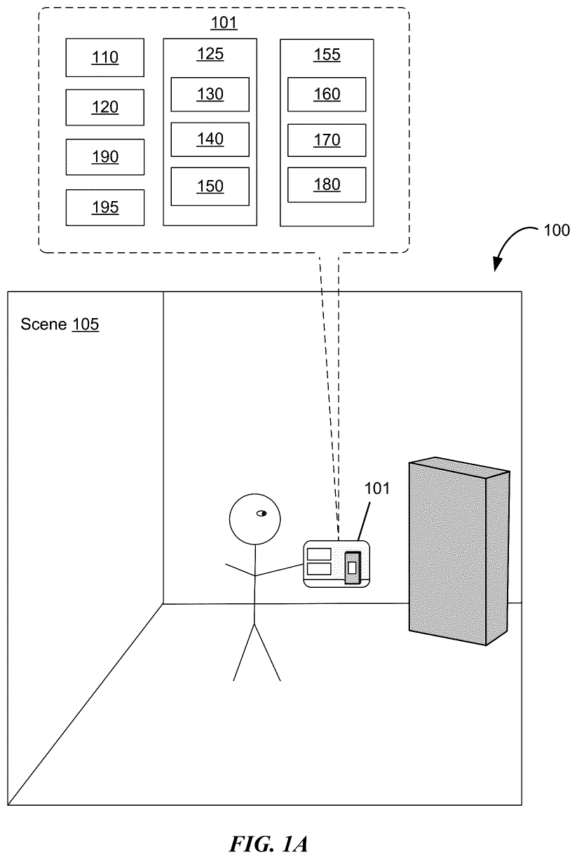

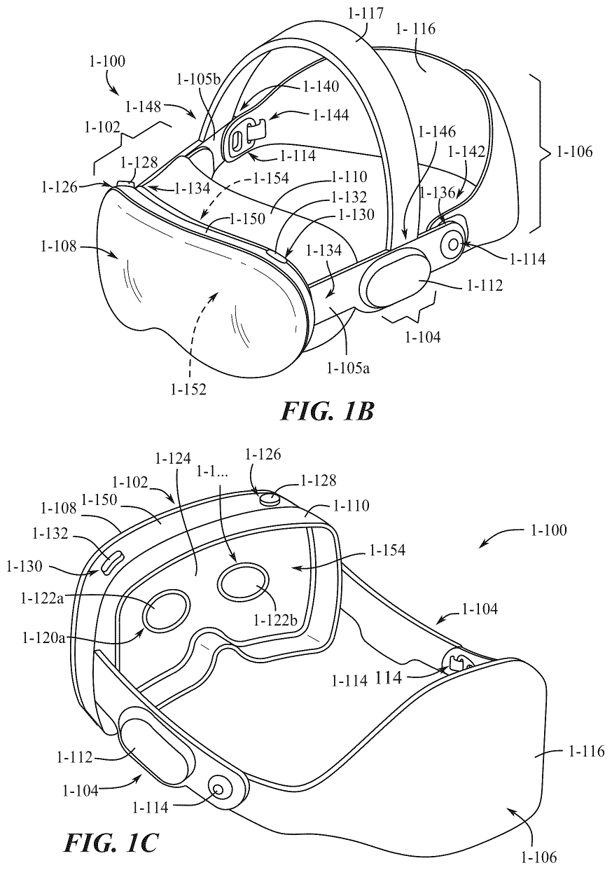

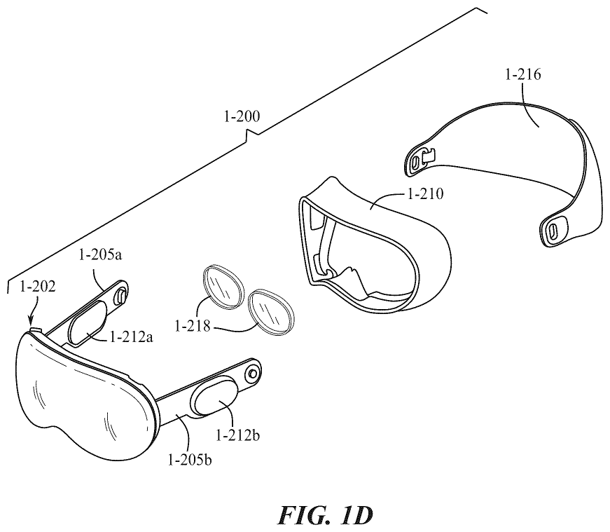

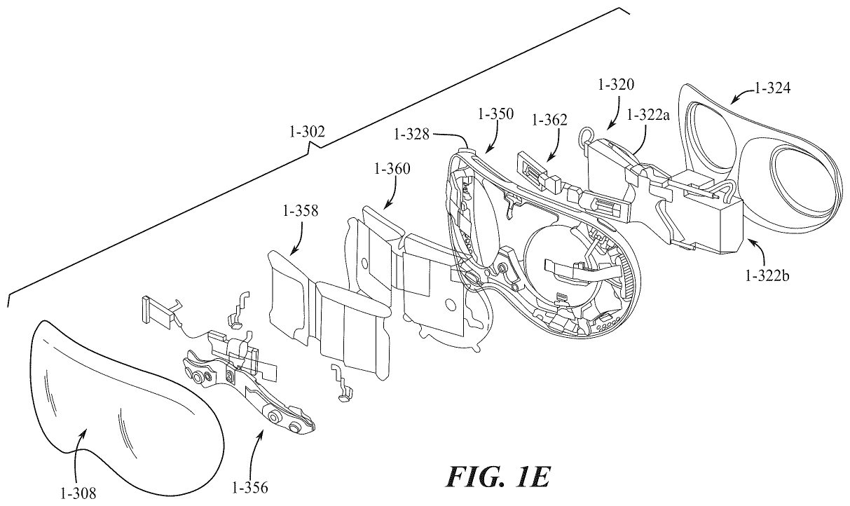

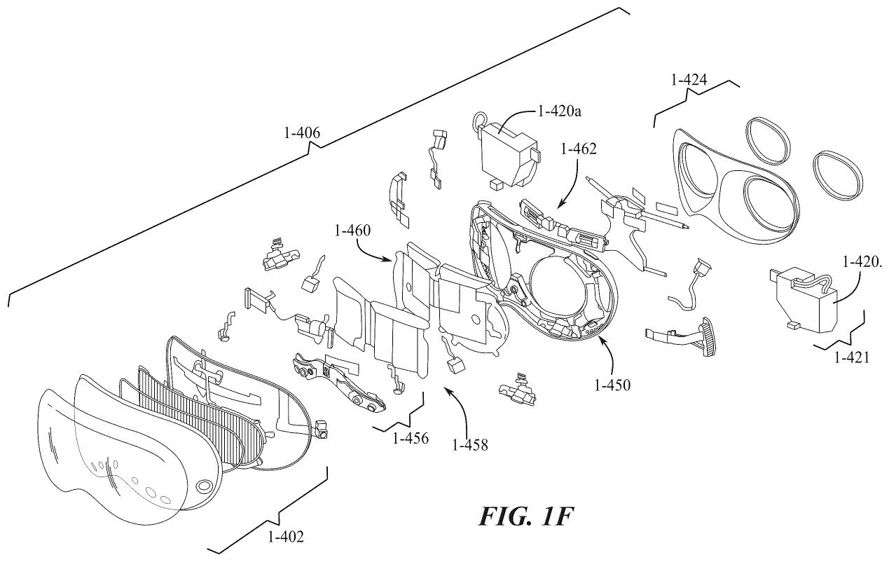

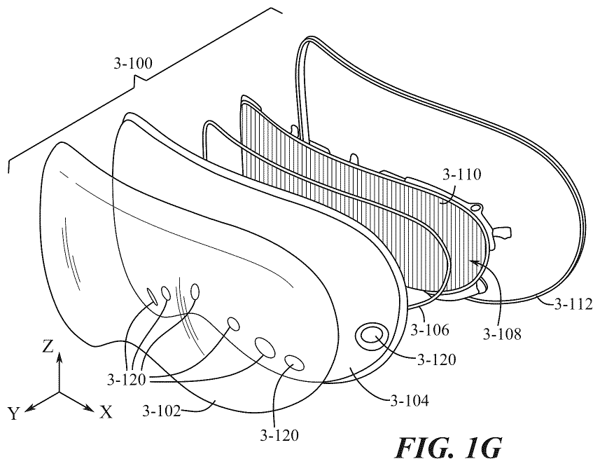

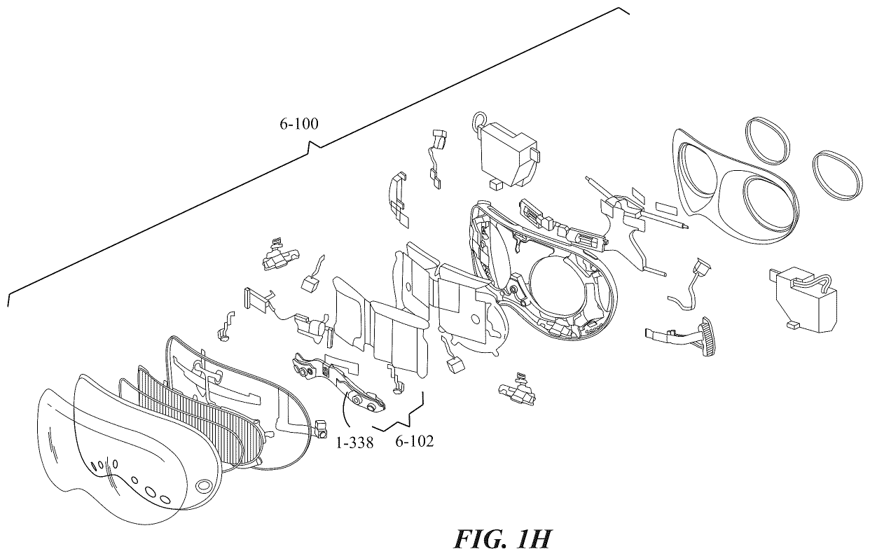

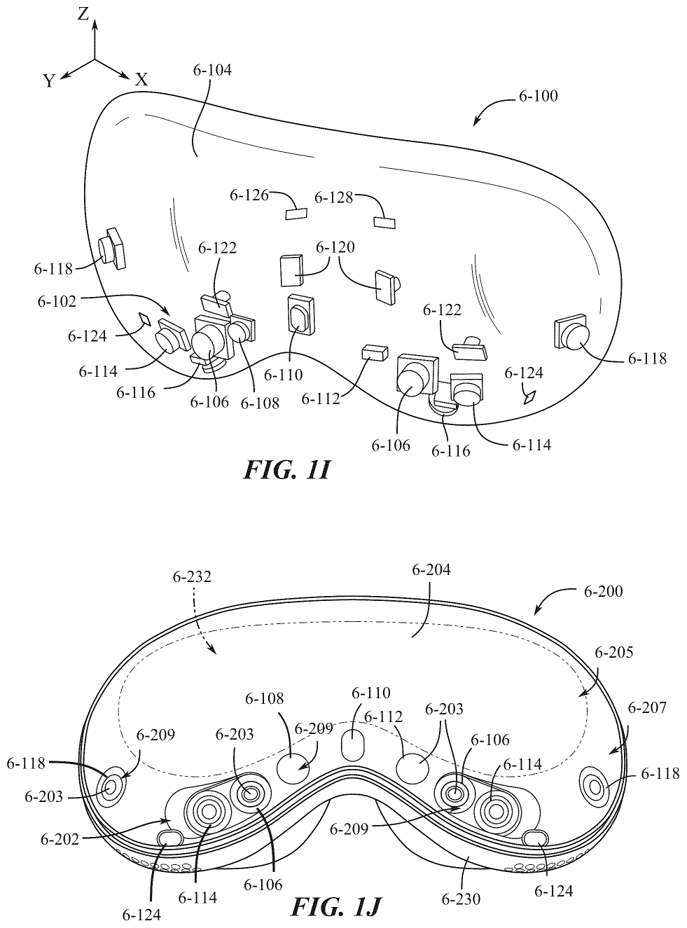

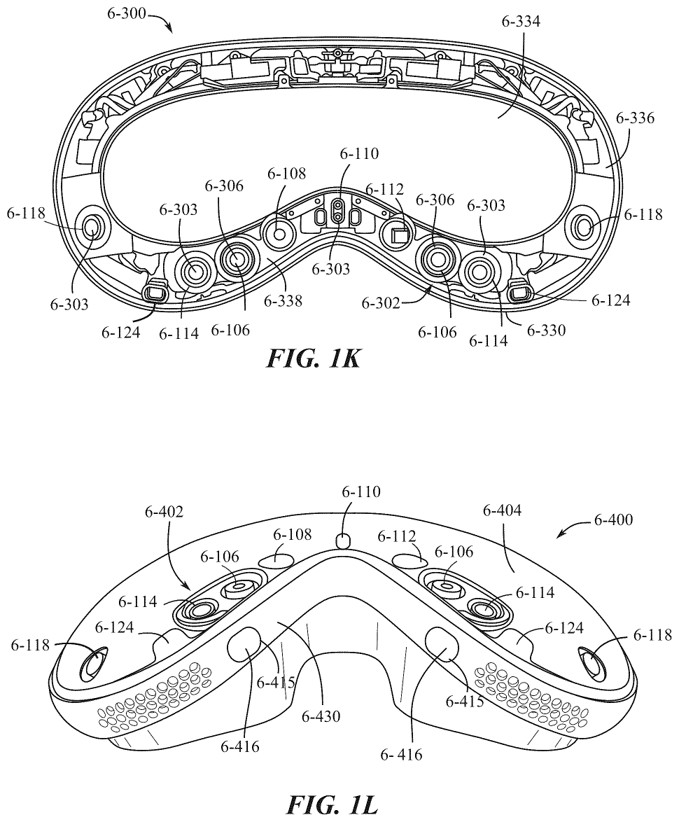

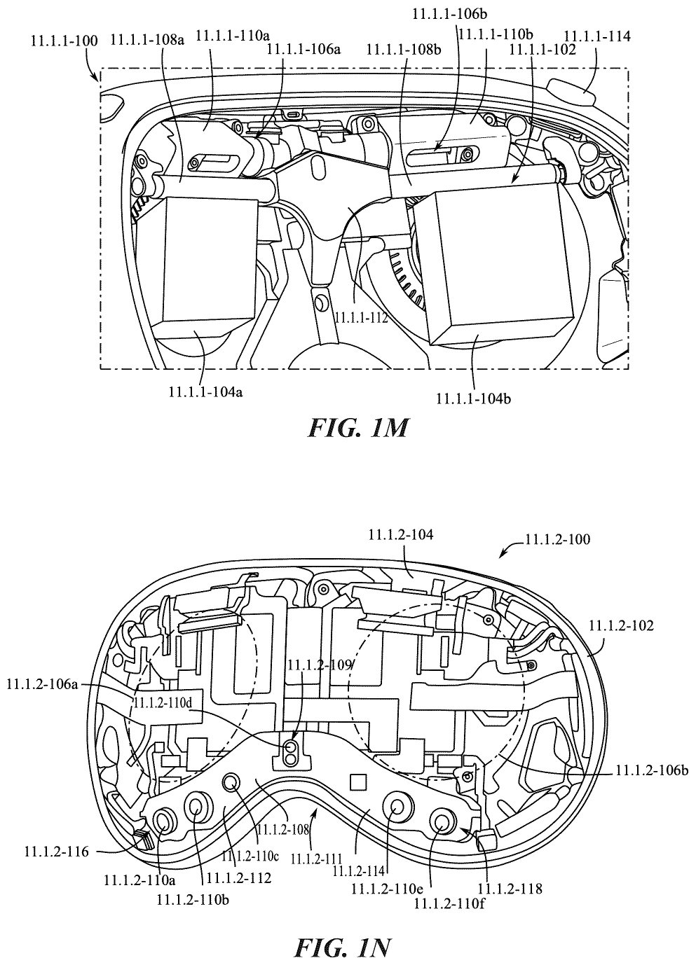

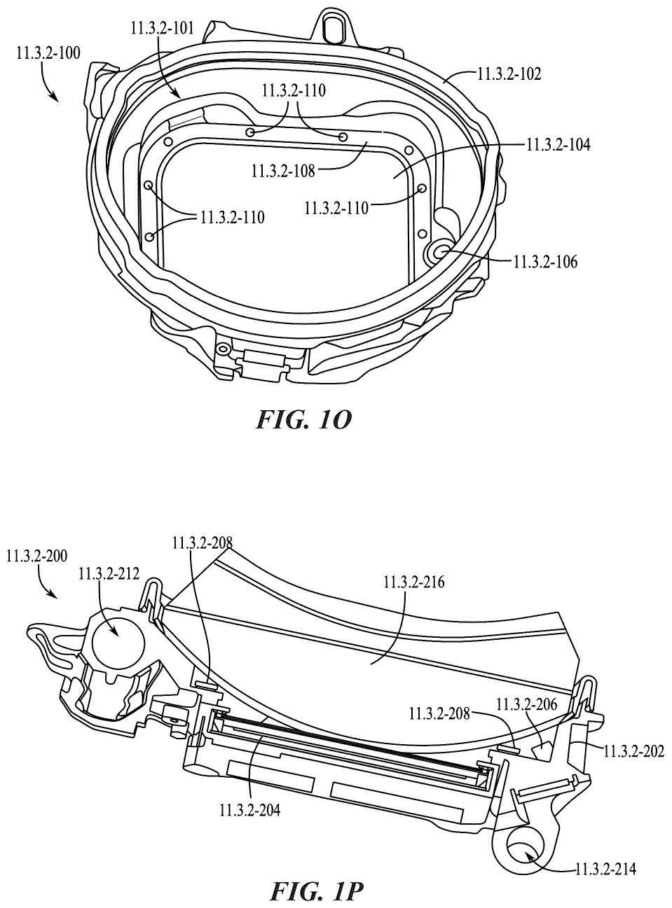

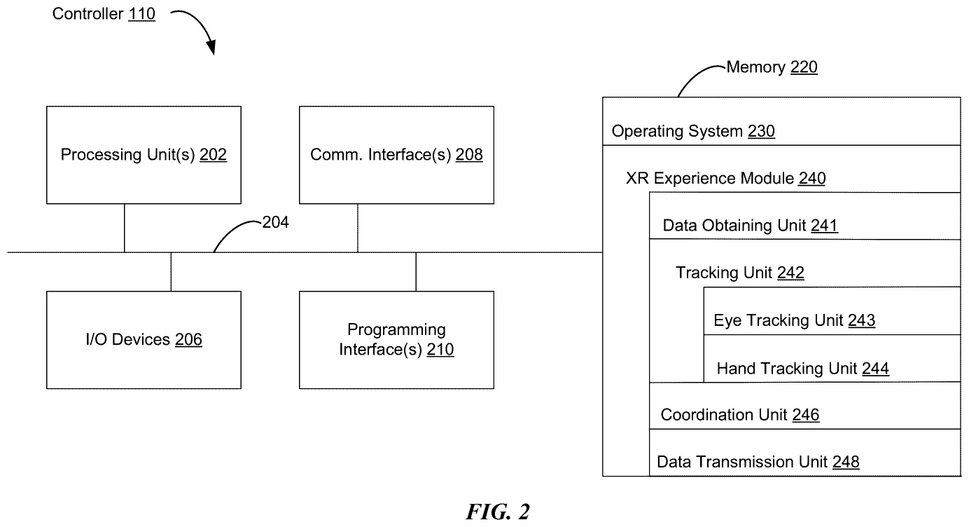

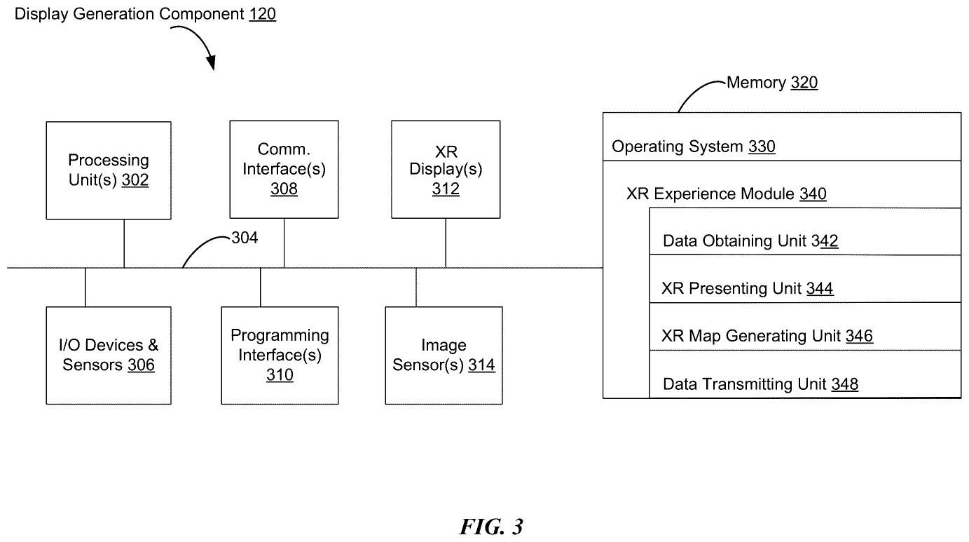

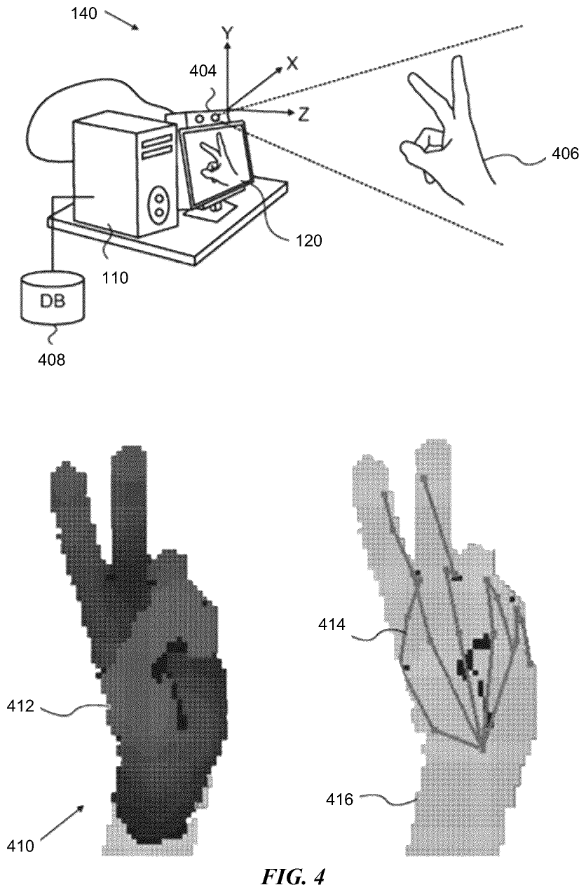

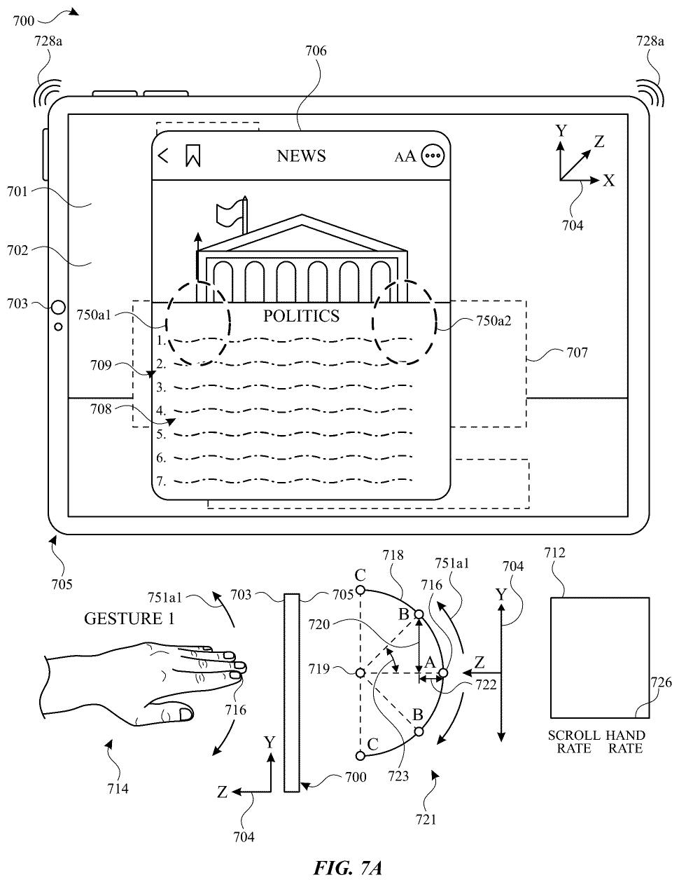

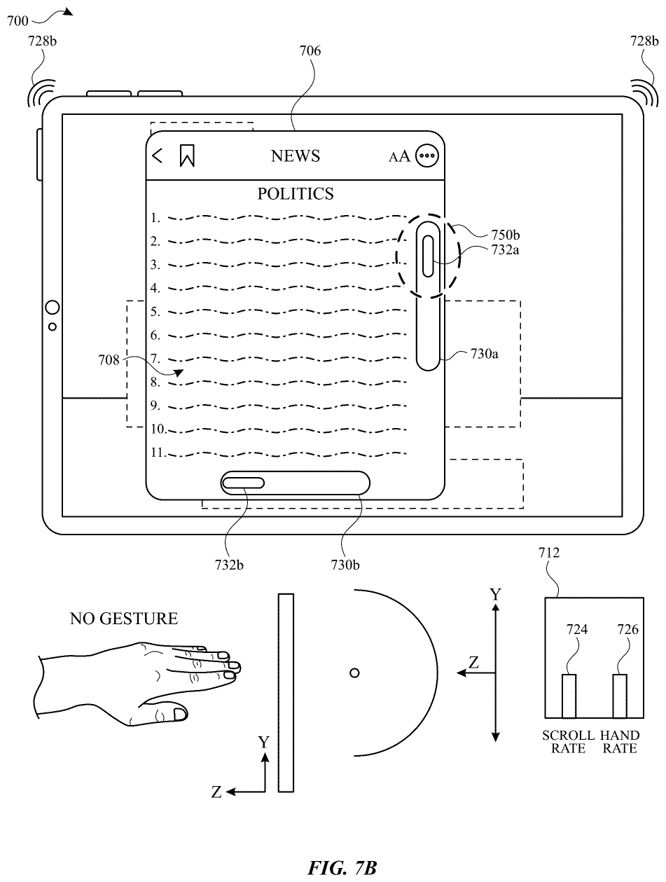

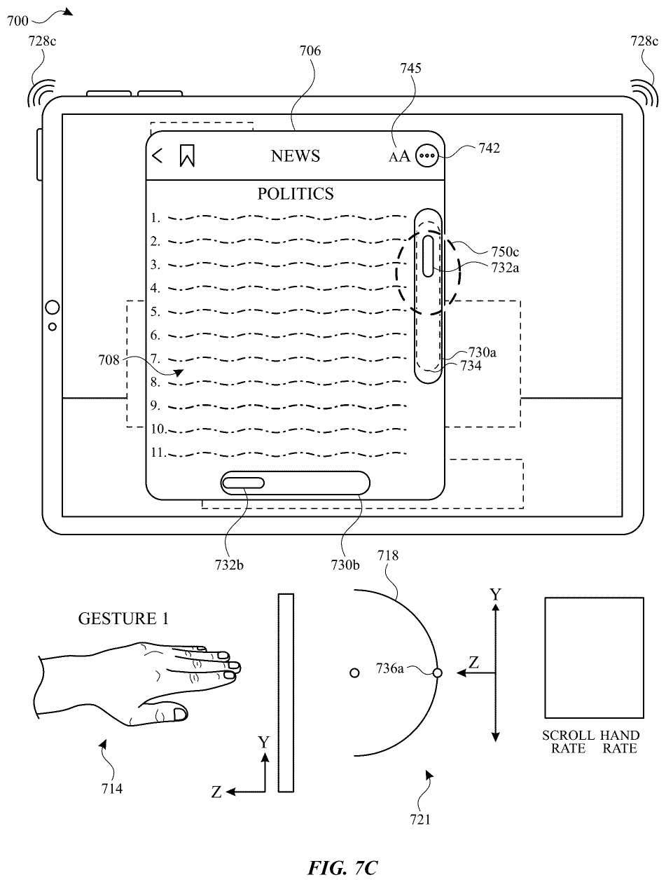

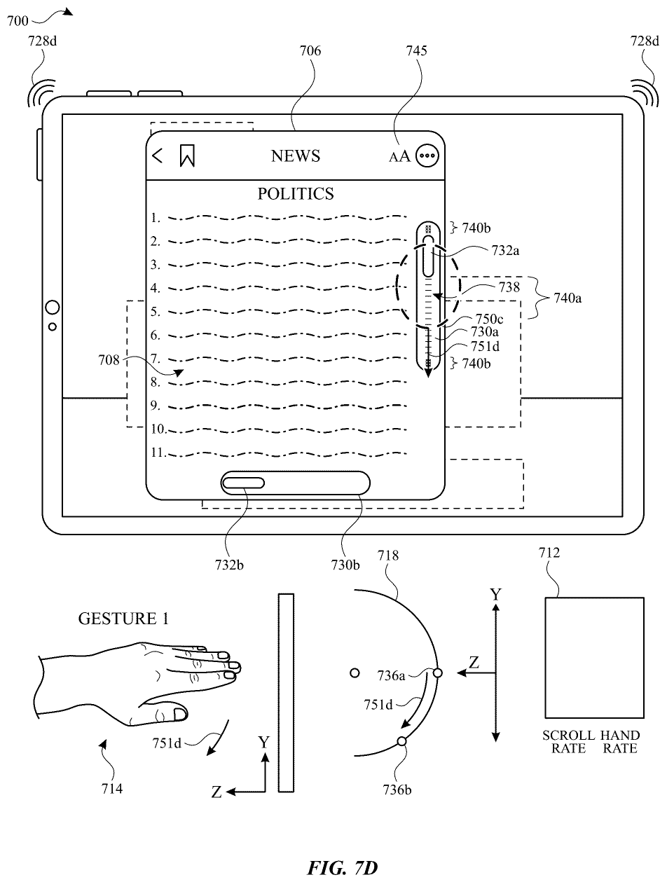

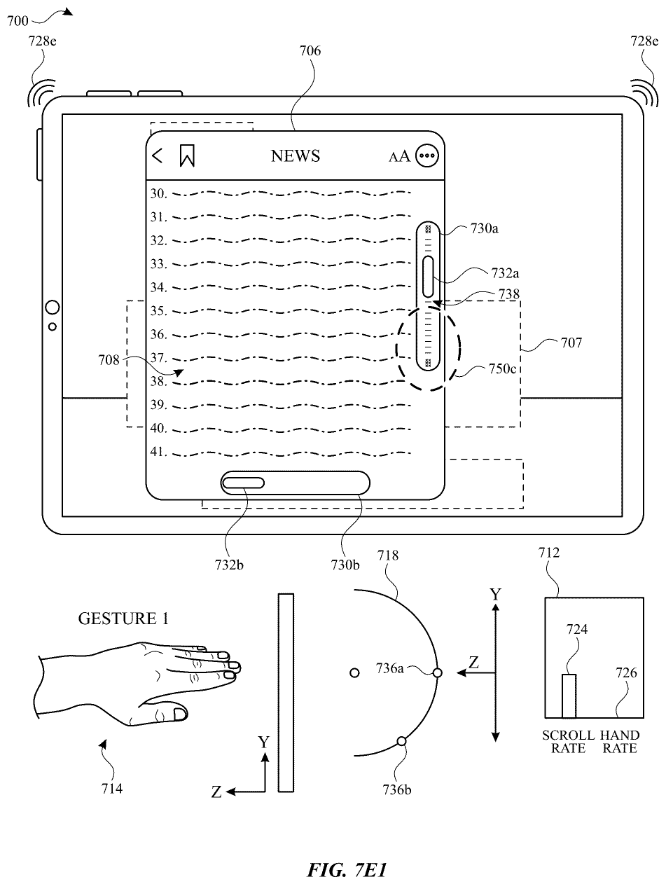

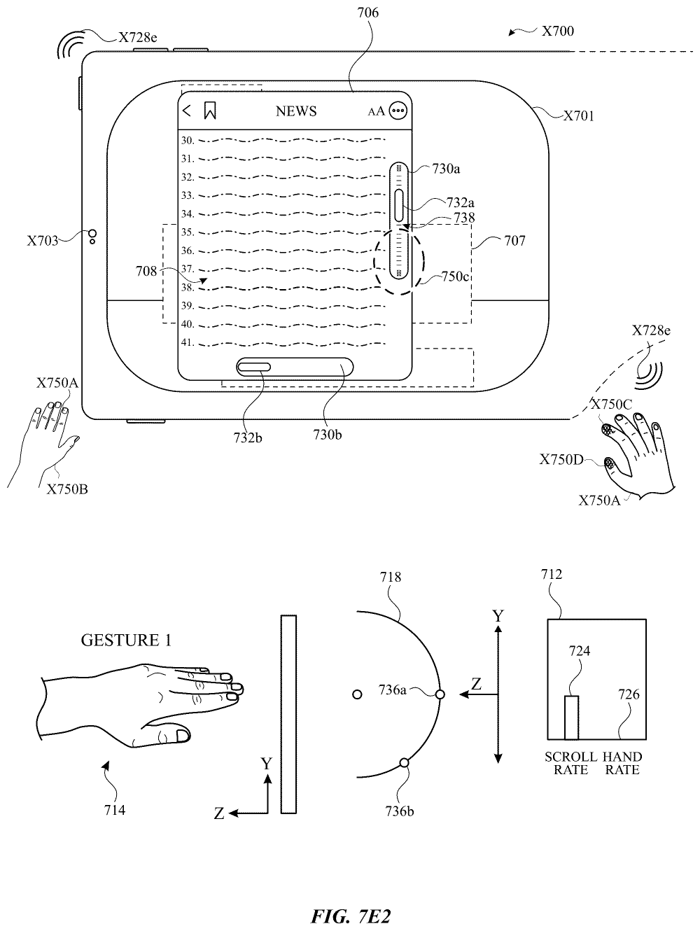

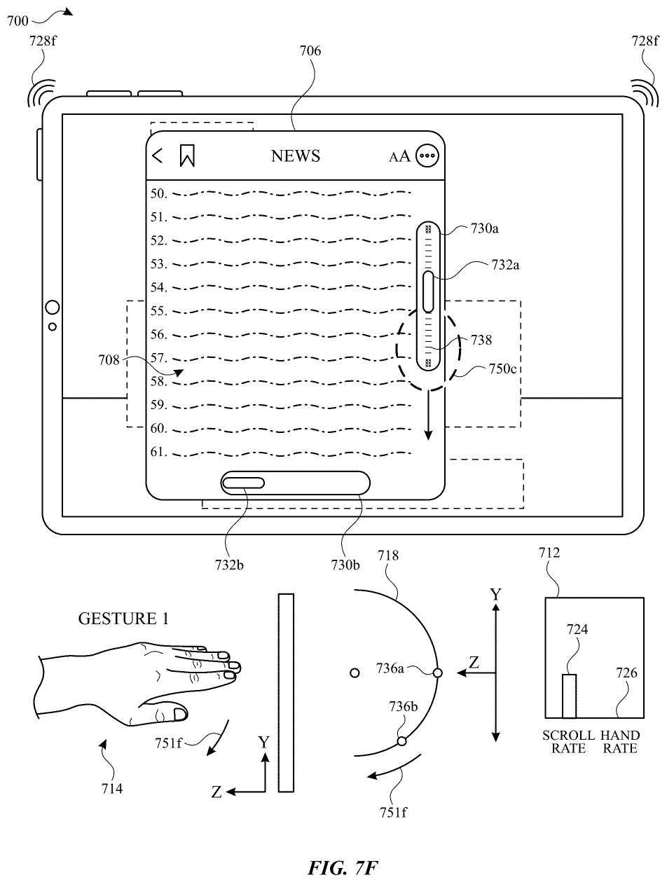

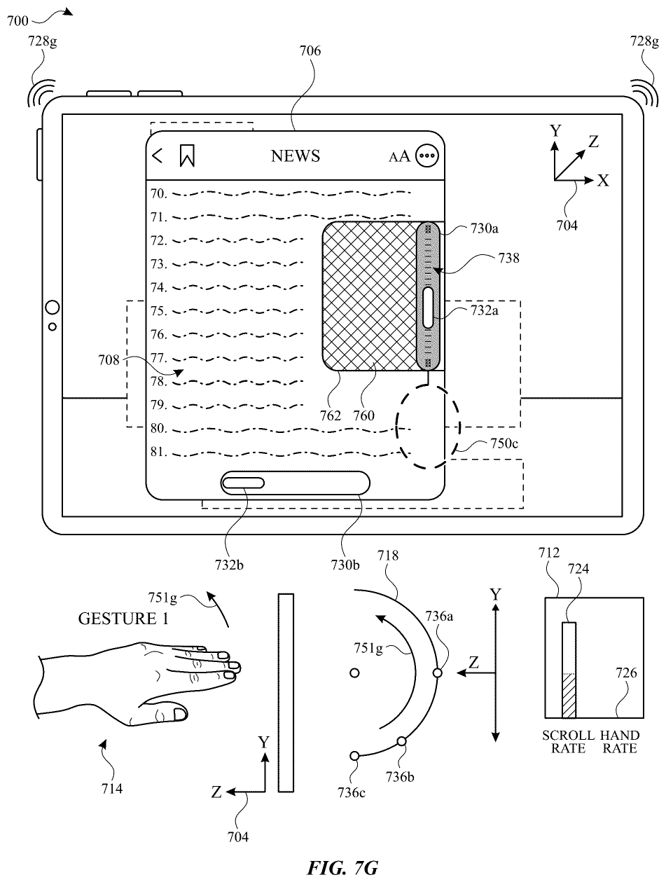

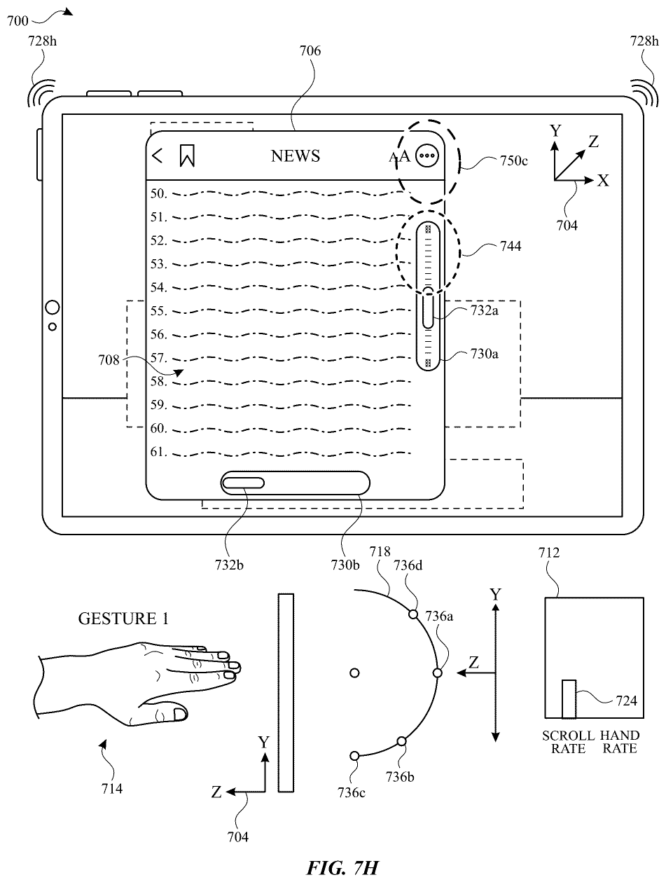

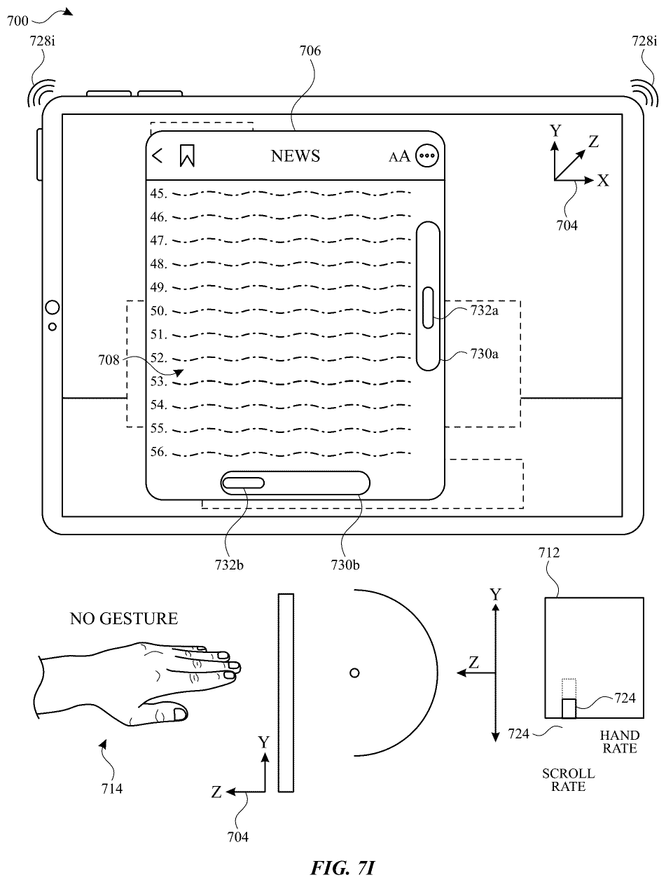

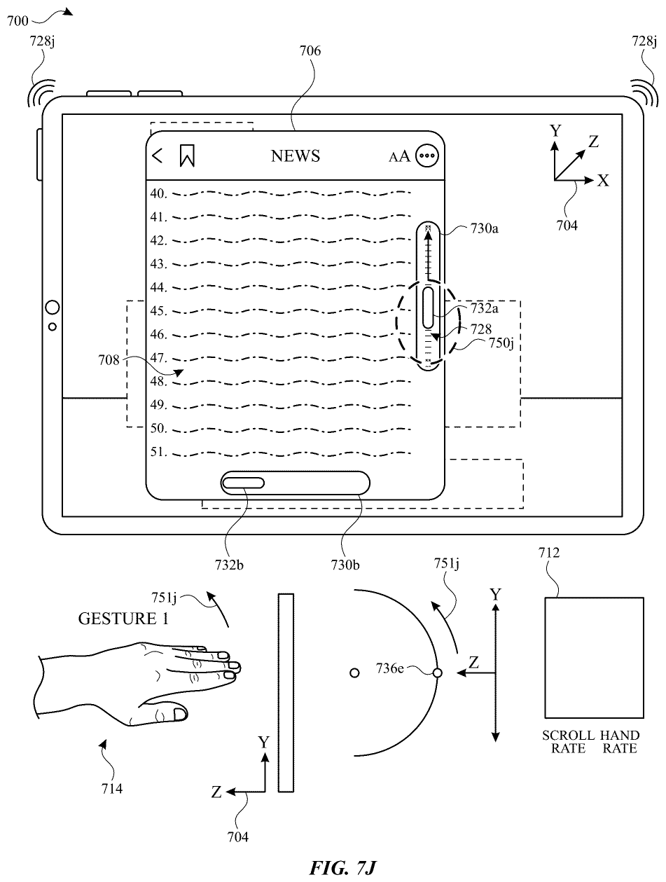

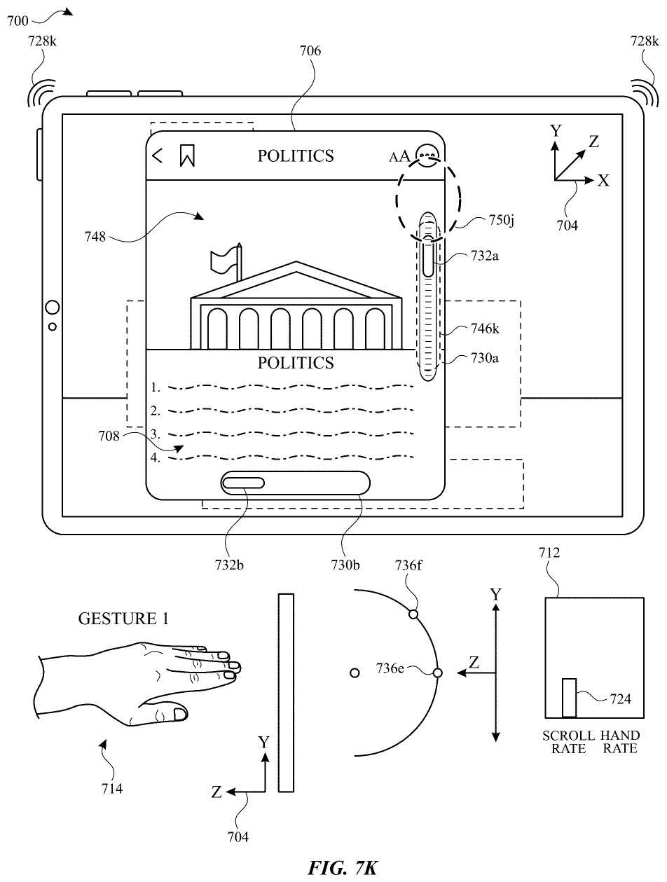

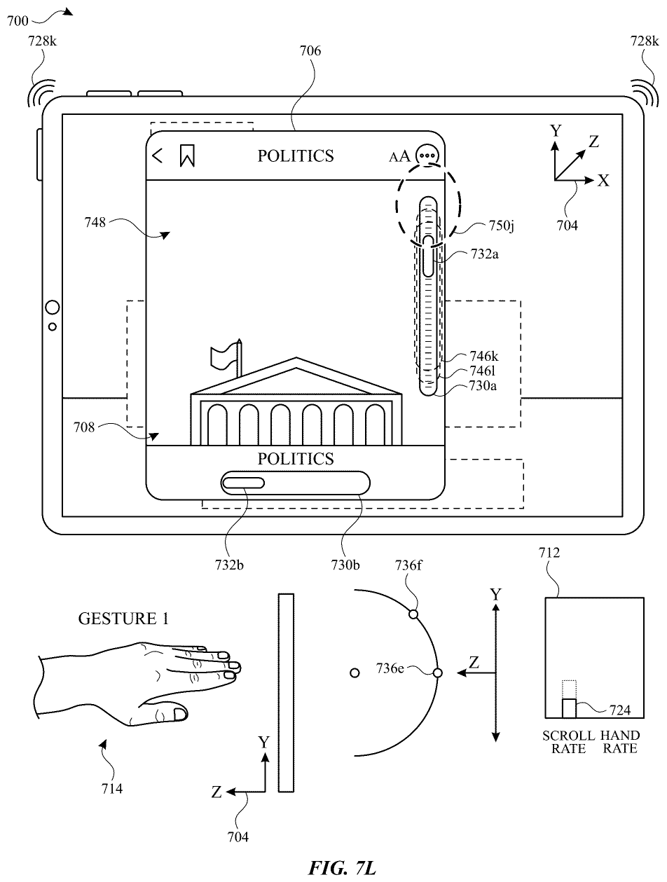

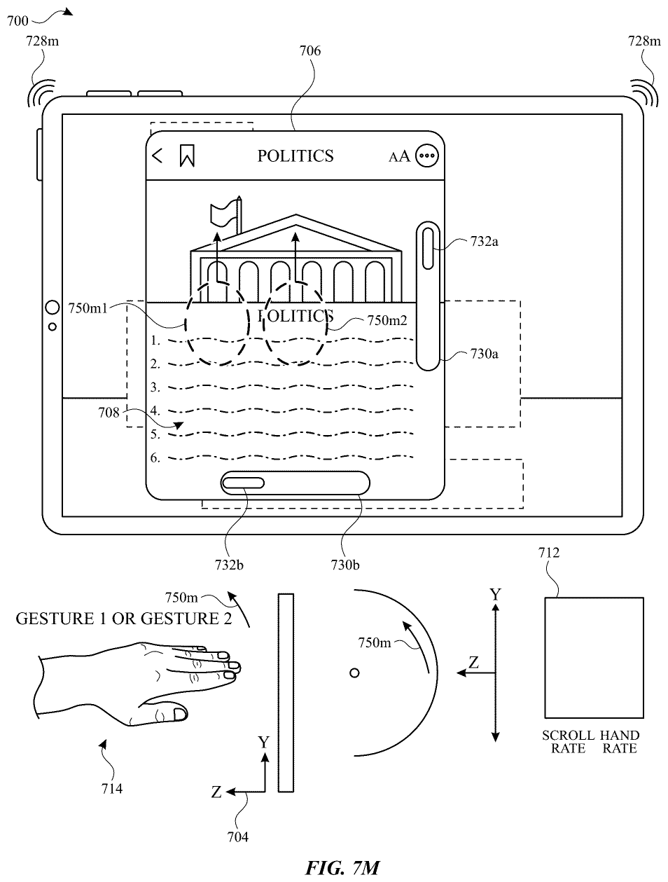

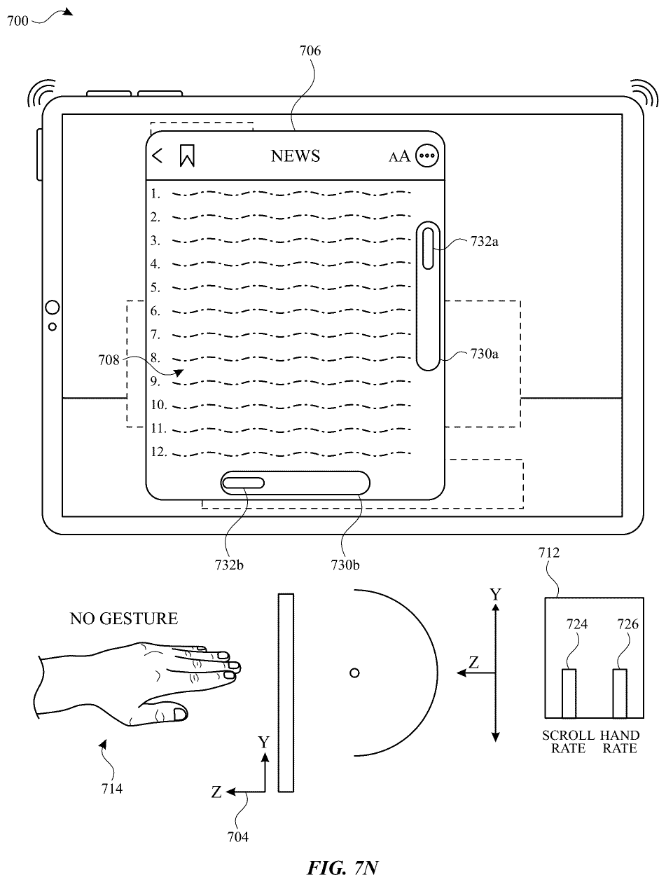

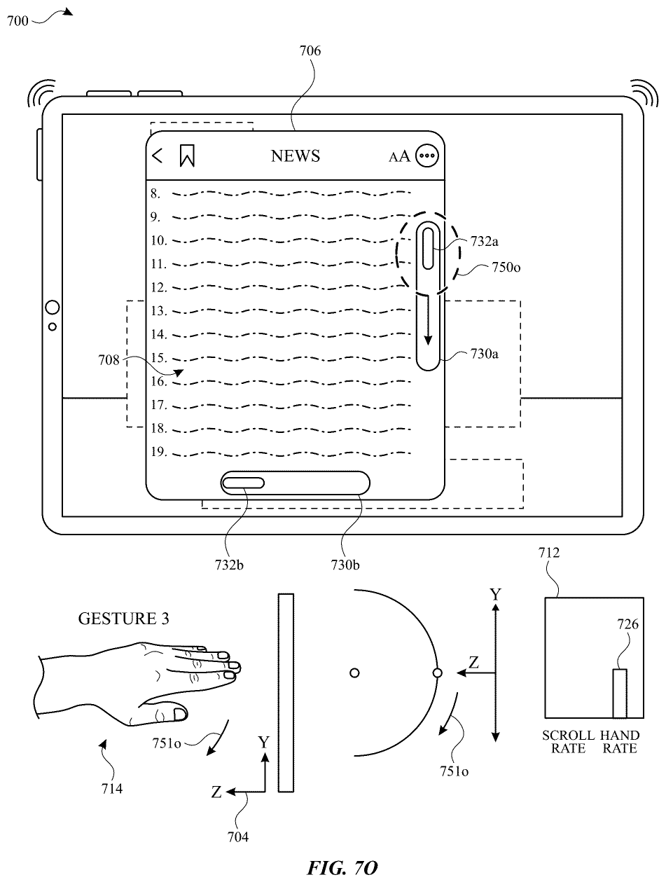

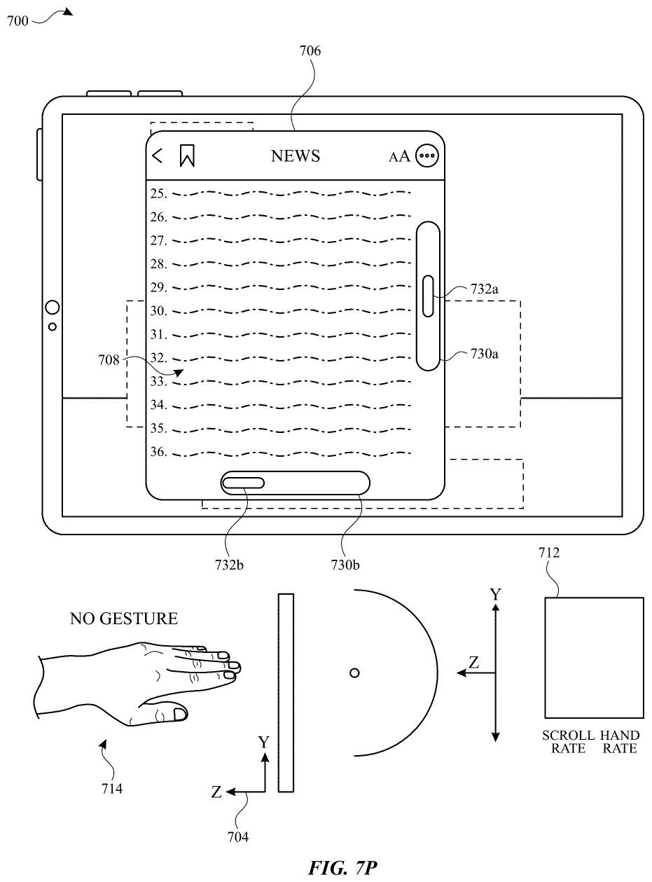

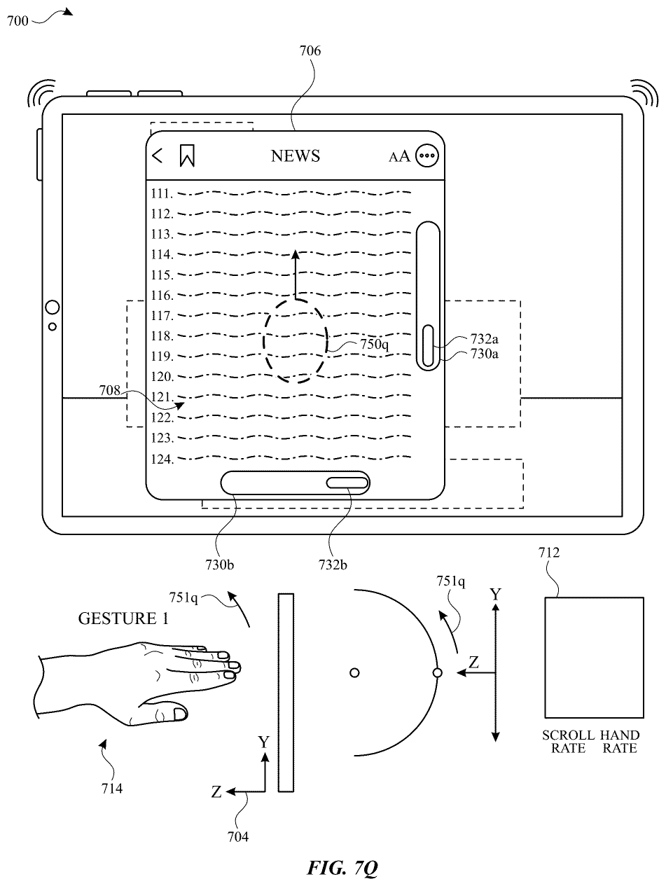

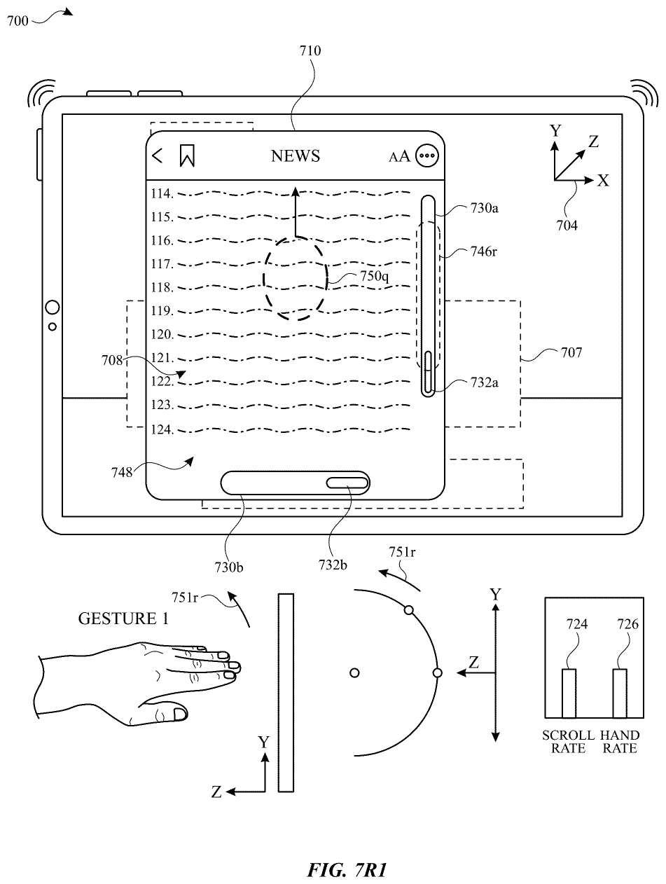

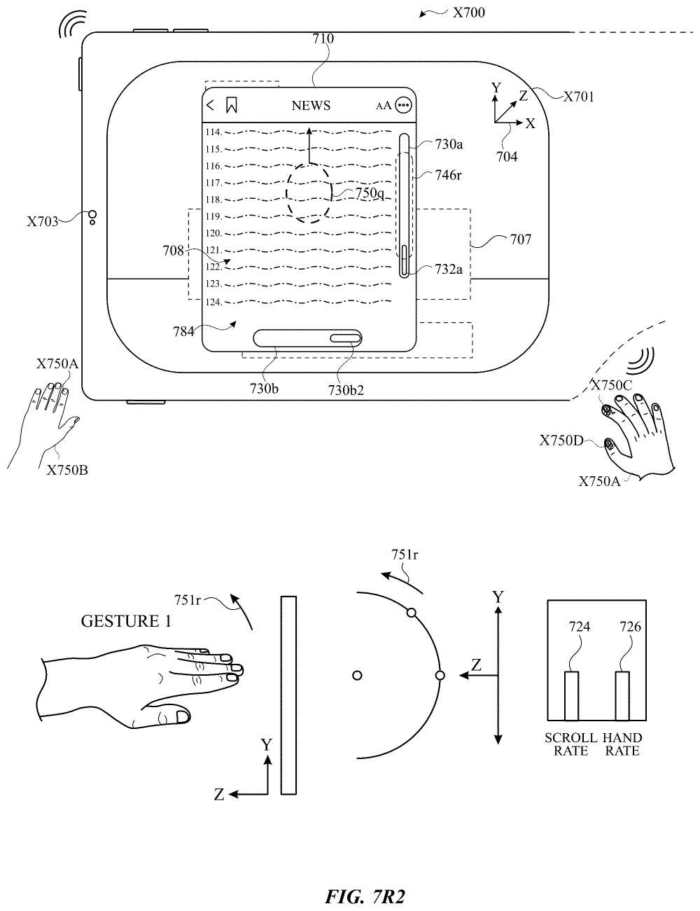

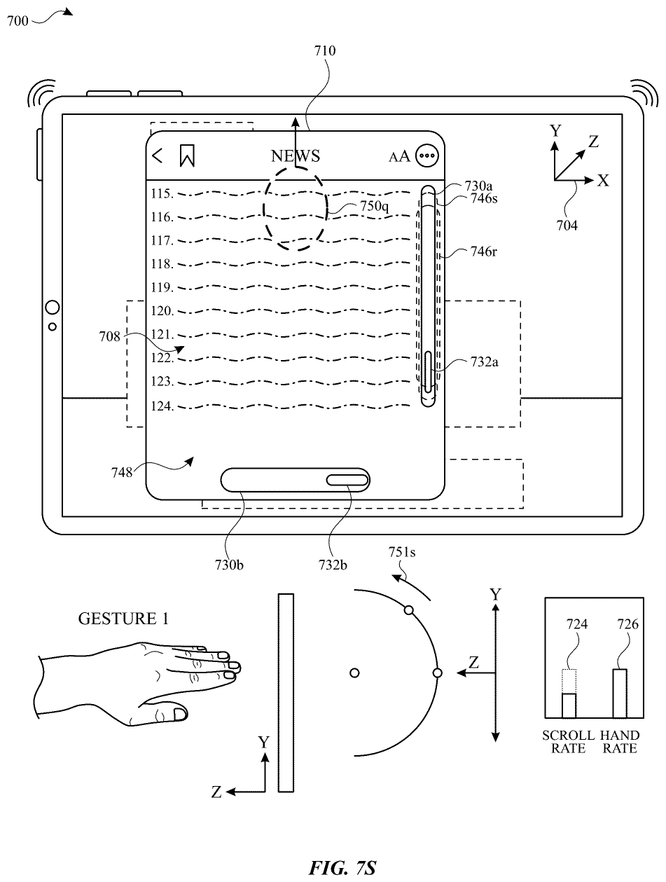

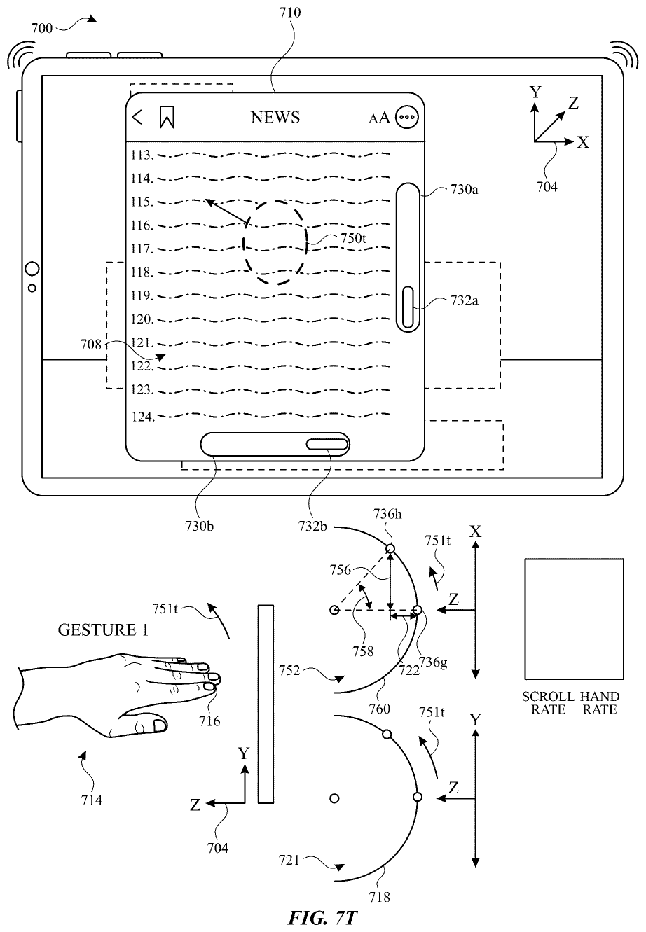

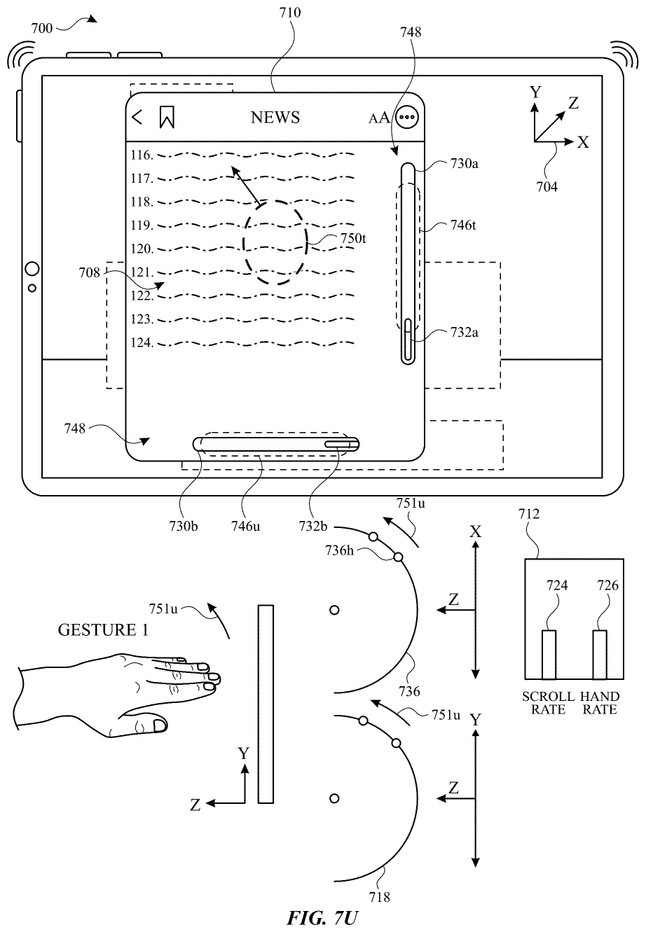

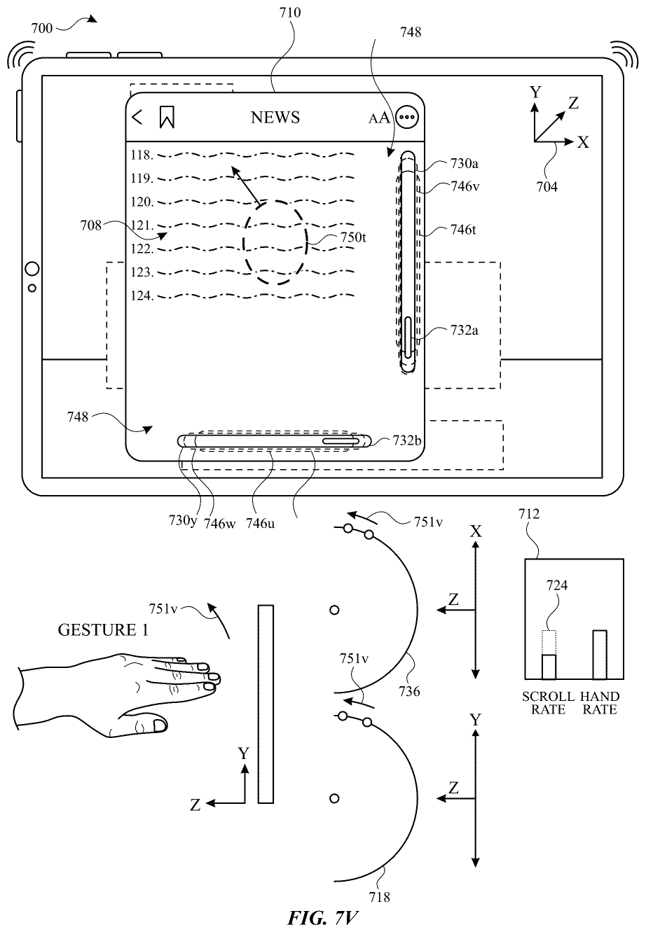

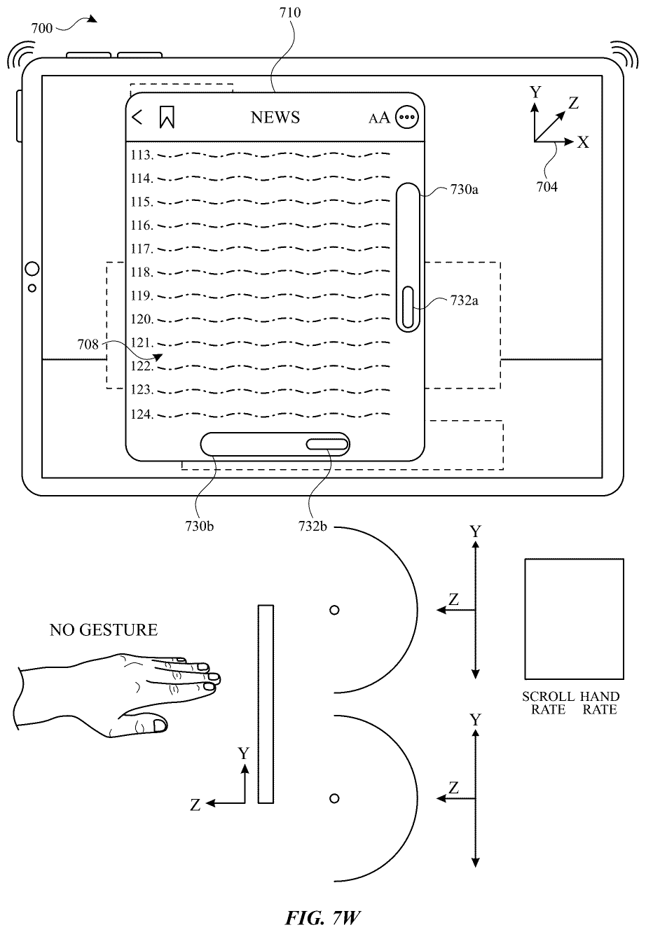

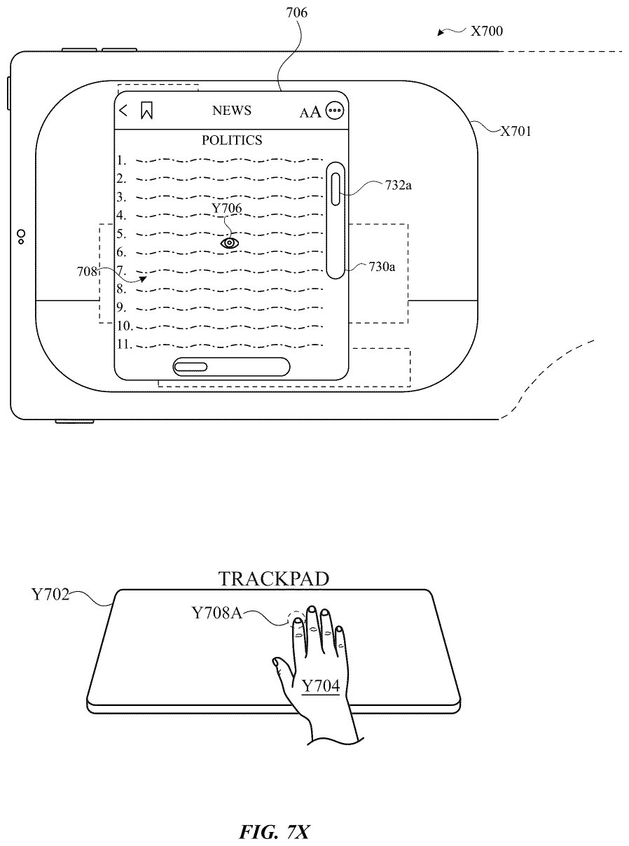

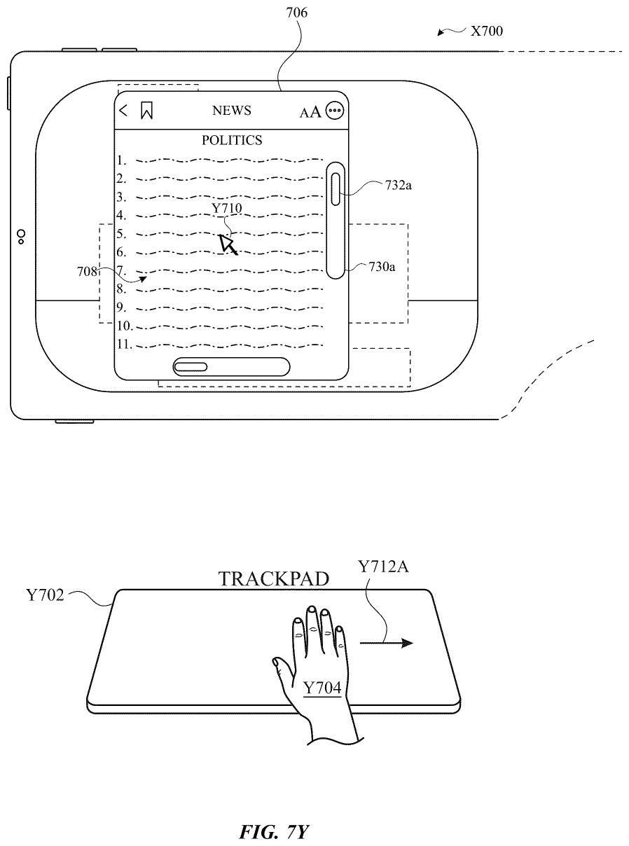

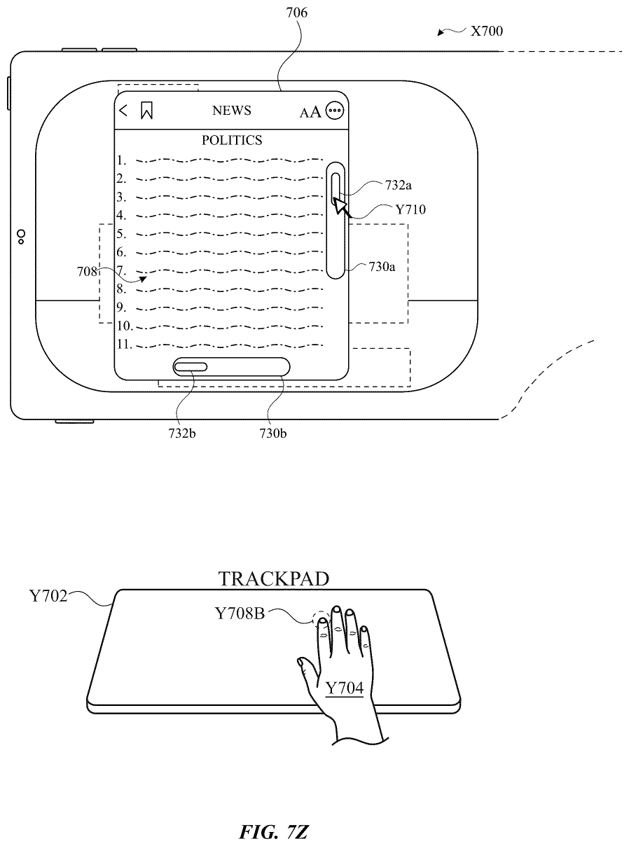

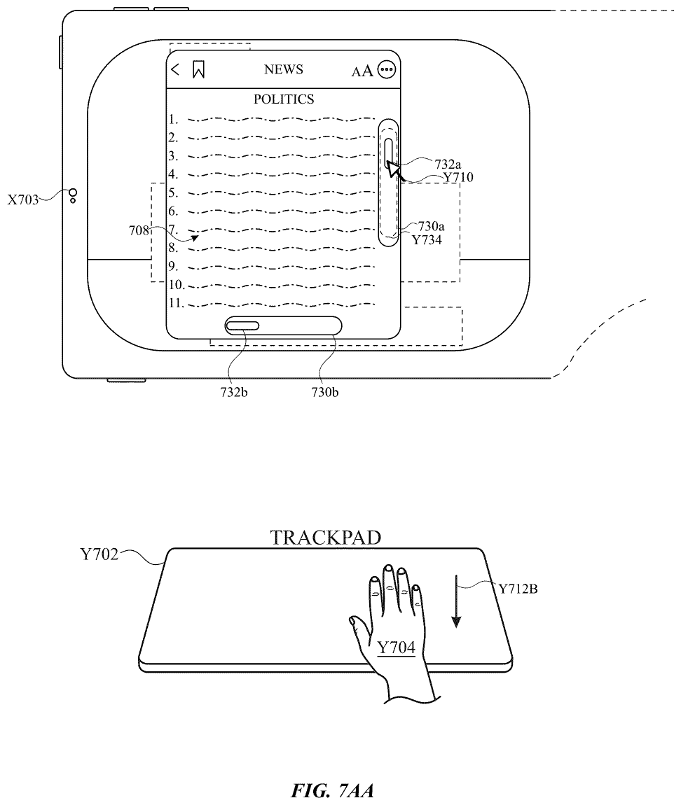

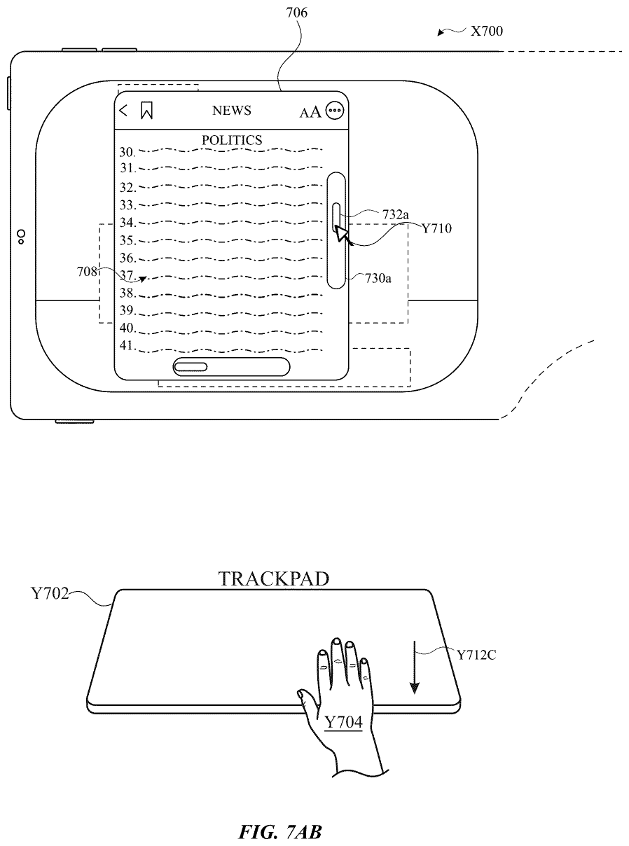

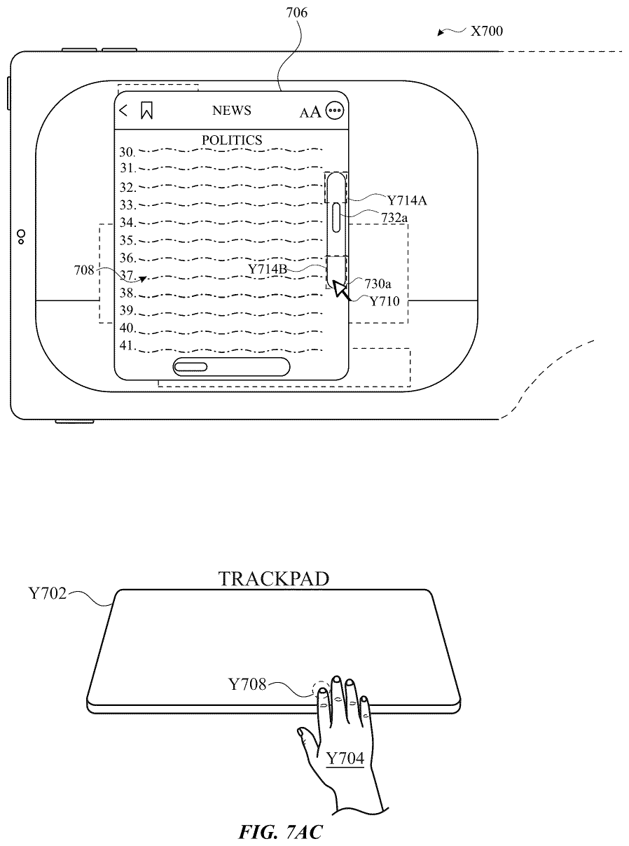

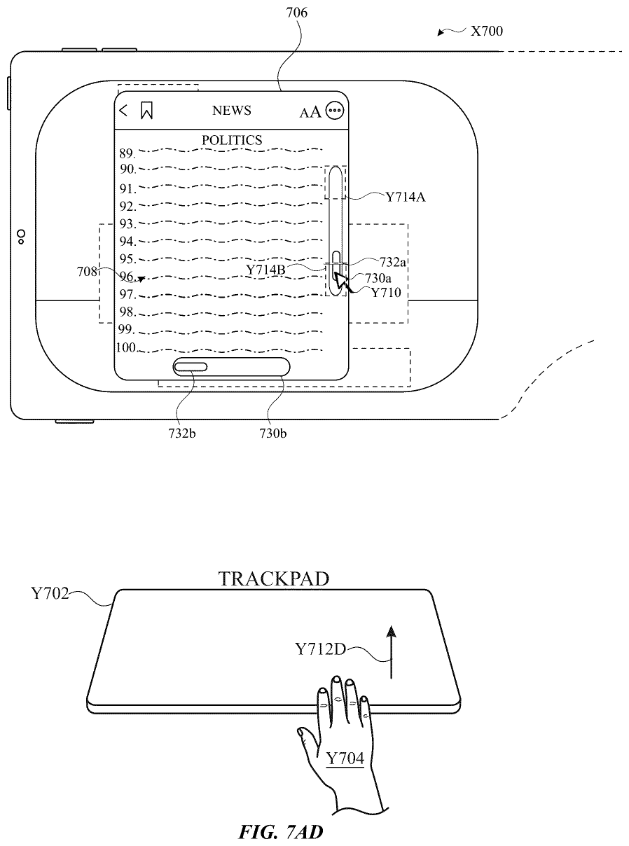

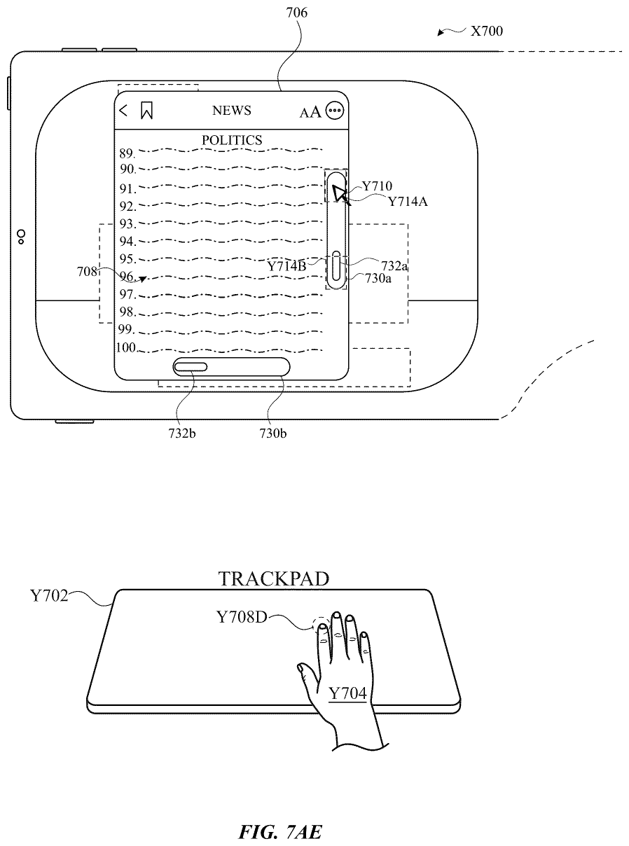

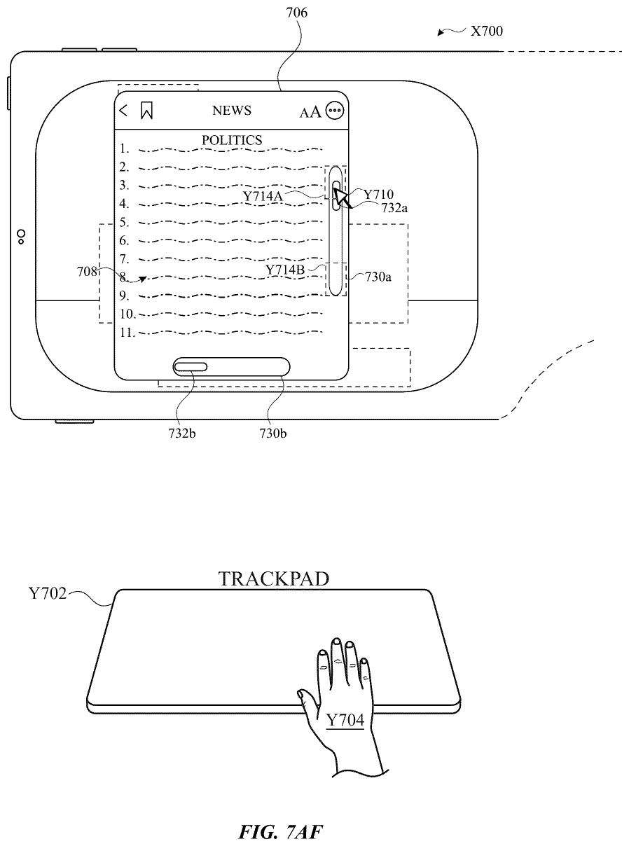

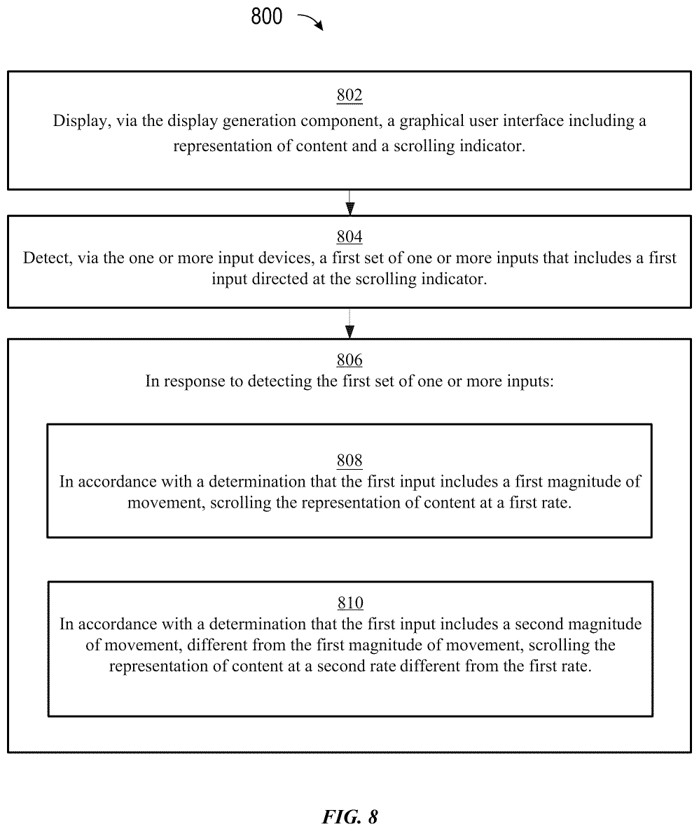

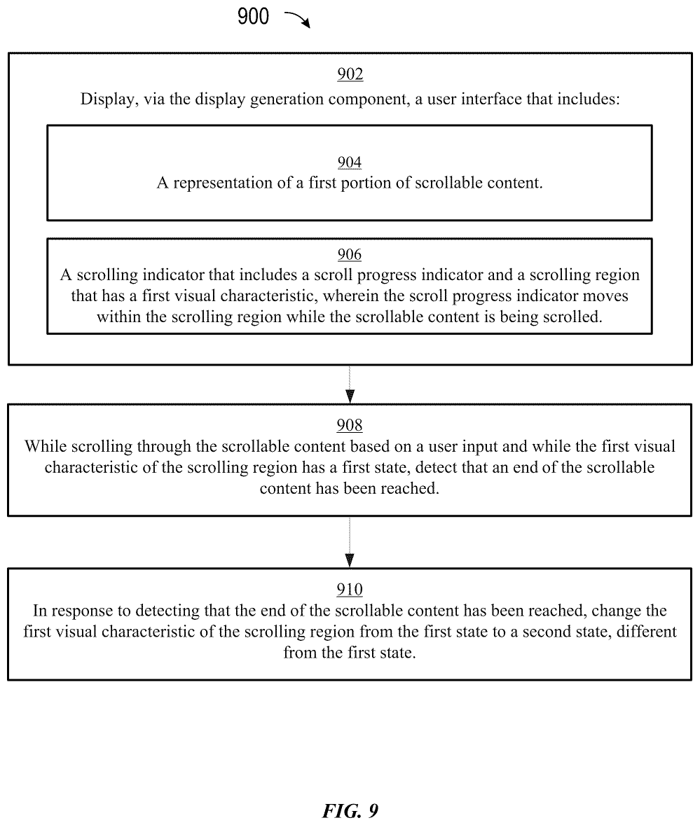

FIGS. 1A-6 provide a description of example computer systems for providing XR experiences to users. FIGS. 7A-7AF illustrate example techniques for scrolling content, in some embodiments. FIG. 8 is a flow diagram of methods of scrolling content, in some embodiments. FIG. 9 is a flow diagram of methods of changing an appearance of a scrolling indicator, in some embodiments. The user interfaces in FIGS. 7A-7AF are used to illustrate the processes in FIGS. 8 and 9.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the one or more input devices 125, one or more output devices 155, one or more sensors 190, and peripheral devices 195 are integrated with the display generation component 120 (e.g., in a head-mounted device or a handheld device).

When describing a XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a×R system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may include speakers and/or other audio output devices integrated into the head-mounted system for providing audio output. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more input devices 125, one or more output devices 155, one or more sensors 190, and/or one or more of the peripheral devices 195, or share the same physical enclosure or support structure with one or more of the above.

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides a XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user′ head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD.

The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232 but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 11 and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processors 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processors 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the one or more input devices 125, one or more output devices 155, one or more sensors 190, and/or peripheral devices 195. To that end, in various embodiments, the data obtaining unit 241 includes instructions and/or logic therefor, and heuristics and metadata therefor.

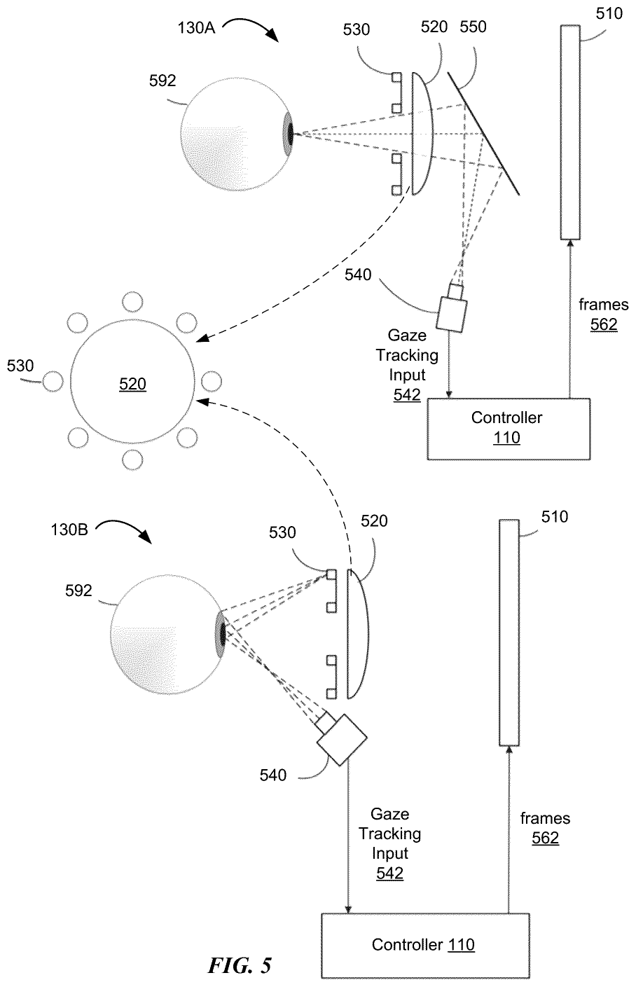

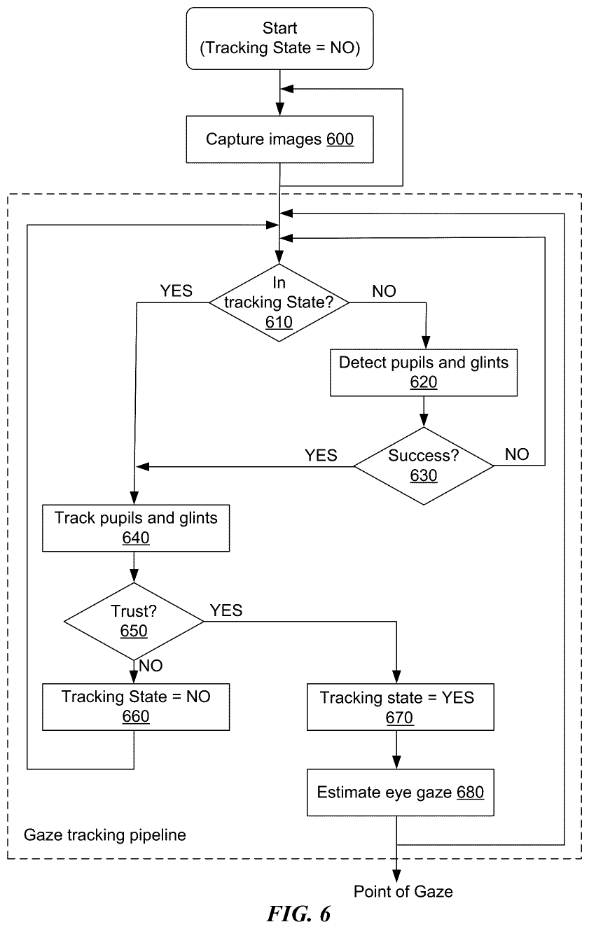

In some embodiments, the tracking unit 242 is configured to map the scene 105 and to track the position/location of at least the display generation component 120 with respect to the scene 105 of FIG. 1A, and optionally, to one or more of the one or more input devices 125, one or more output devices 155, one or more sensors 190, and/or one or more peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the one or more input devices 125, one or more output devices 155, one or more sensors 190, and/or one or more peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more image sensors 314 (optionally, interior-and/or exterior-facing image sensors), a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the one or more input devices 125, one or more output devices 155, one or more sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3 is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand). In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame.

The pose typically includes 3D locations of the user's hand joints and finger tips. The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) (or part(s) of the user's hand) for interacting with an XR environment (e.g., a virtual or mixed-reality environment), in some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand). In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands). In some embodiments, movement between the user's two hands (e.g., to increase and/or decrease a distance or relative orientation between the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user, user inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, wherein the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the eye tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in some embodiments.

As shown in FIG. 5, the eye tracking device 130 (e.g., 130A or 130B) includes eye lens(es) 520, and a gaze tracking system that includes at least one eye tracking camera(s) 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking camera(s) 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders frames 562 (e.g., AR or VR frames) (e.g., left and right frames for left and right display panels) and provides the frames 562 to the display 510. The controller 110 uses gaze tracking input 542 from the eye tracking camera(s) 540 for various purposes, for example in processing the frames 562 for display. The controller 110 optionally estimates the user's point of gaze on the display 510 based on the gaze tracking input 542 obtained from eye tracking camera(s) 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lens(es) 520 may be focusable lenses, and the gaze tracking information is used by the controller to adjust the focus of the eye lens(es) 520 so that the virtual object that the user is currently looking at has the proper vergence to match the convergence of the user's eyes 592. The controller 110 may leverage the gaze tracking information to direct the eye lens(es) 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs)), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each eye lens(es) 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, eye tracking camera(s) 540 includes a single eye tracking camera located on each side of the user's face. In some embodiments, eye tracking camera(s) 540 includes two or more NIR cameras on each side of the user's face. In some embodiments, eye tracking camera(s) 540 includes a camera with a wider field of view (FOV) and a camera with a narrower FOV on each side of the user's face. In some embodiments, eye tracking camera(s) 540 includes a camera that operates at one wavelength (e.g., 850 nm) and a camera that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

FIG. 6 illustrates a glint-assisted gaze tracking pipeline, in some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in some embodiments.

In some embodiments, the captured portions of real world environment 602 are used to provide an XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as a portable multifunction device or a head-mounted device, in communication with a display generation component, one or more input devices, and (optionally) one or cameras.

FIGS. 7A-7AF illustrate examples of scrolling content. FIG. 8 is a flow diagram of an exemplary method 800 for scrolling content. FIG. 9 is a flow diagram of an exemplary method 900 for changing an appearance of a scrolling indicator. The user interfaces in FIGS. 7A-7AF are used to illustrate the processes described below, including the processes in FIGS. 8-9.

FIGS. 7A-7AF illustrate examples of device 700, such as a handheld device and/or a desktop device. In some embodiments, device 700 is a head-mounted device. In some embodiments, a user interface is displayed as part of an extended reality user interface and/or extended reality environment/experience. In some embodiments, scrolling through content of the user interface is based on air gestures. In some embodiments, providing a rate-based scroll limits the amount of movement of the air gesture. This allows the user to scroll through content quickly based on smaller amounts of movement. Additionally, visual and/or non-visual feedback is provided so that a user knows when the content is scrolling and/or when a user has scrolled past the end of content has been reached.

At FIG. 7A, device 700 displays, on display 701, image of a physical environment 707 in view of one or more cameras, including front-side camera 703 and/or rear-side camera 705. In some embodiments, device 700 includes one or more features of the operating environment of the computer system of FIG. 1A, one or more features of the controller of FIG. 2, one or more features of a display generation component of FIG. 3, one or more features of the hand tracking unit of FIG. 4, one or more features of the eye tracking unit of FIG. 5, and/or one or more features of the glint-assisted gaze tracking pipeline of FIG. 6.

At FIG. 7A, device 700 displays user interface 706 of a news application. User interface 706 includes content 708, such as text, pictures, or text entry fields, that are scrollable. Numeric indicators 709 are illustrated to depict a relative position of content 708 to indicate how content 708 is being scrolled up and down. User interface 706 and image of the physical environment 707 have three-dimensional coordinates on three-dimensional cartesian system 704, including a horizontal axis (e.g., an x-axis), a vertical axis (e.g., a y-axis), and depth axis (e.g., a z-axis). In some embodiments, the depth axis is perpendicular to the vertical and/or horizontal axis, where the content is scrolled along the vertical axis and/or the horizontal axis.

At FIG. 7A, content 708 is scrolled by various inputs, including air gestures, touch gestures (e.g., touch inputs that contact display 701), and/or other inputs using other input devices (such as a mouse, a trackpad, and/or a keyboard). As described herein, various inputs at different locations of user interface 706 result in different manners of scrolling, allowing the user to efficiently scroll through content 708. Device 700 optionally scrolls content 708 using movement (including rotation) of an air gesture (and/or touch input) along multiple axes to generate a scrolling input. For example, device 700 detects a location (e.g., an initial location) at which a respective gesture (such as a pinch) is detected and subsequent movement or rotation of the respective gesture along all three axes of three-dimensional cartesian system 704. Vertical rotation schematic 721 provides a two-dimensional schematic of a vertical axis (e.g., y-axis) and a depth axis (e.g., z-axis). As depicted by vertical rotation schematic 721, device 700 detects rotation of air gestures by detecting an original location (e.g., at position A) at which fingers 716 make a respective gesture and then subsequent rotation about a user's wrist (as illustrated by arc center 719) (and/or movement of the user's hand up or down). Fingers 716 make vertical arc 718 as the respective air gesture moves to position B (or position C) from position A. Movement 751al along vertical arc 718 includes movement along the vertical axis (e.g., up or down) and the depth axis (toward the user or away from the user). As fingers 716 move along vertical arc 718, device 700 detects vertical distance 720, depth distance 722, and/or rotation 723 based on the movement. For example, as fingers 716 move from position A to position B, device 700 detects vertical distance 720, depth distance 722, and/or rotation 723. In some embodiments, to scroll the content along the vertical axis (e.g., up or down), device 700 utilizes a value of vertical distance 720 and a value that is based on depth distance 722 and/or rotation 723. As described in greater detail with respect to FIG. 7T, in some embodiments, device 700 generates a scrolling input based on a movement along horizontal arc 754 (e.g., as opposed to vertical arc 718), which includes movement along the horizontal axis (e.g., left or right) and the depth axis (toward the user or away from the user). In some embodiments, to scroll the content along the horizontal axis (e.g., left or right), device 700 utilizes a value of horizontal distance 756 and a value that is based on depth distance 722 and/or rotation 758. This allows the user to reduce the amount of arm or hand movement in the vertical or horizontal direction to generate a scrolling input. As depicted in vertical rotation schematic 721, movement from position B to position C includes a smaller amount of vertical distance as compared to moving from position A to position B. By accounting for movement along both the depth direction and the vertical direction (or horizontal direction), a user can provide a greater amount of scrolling input by simply rotating the user's wrist. In some embodiments, the depth axis is perpendicular to the vertical axis. In some embodiments, device 700 scrolls content 708 along the vertical axis when scrolling the content up or down and/or using scrollbar track 730a and/or scrollbar thumb 732a as described herein.

At FIG. 7A, device 700 detects a request to scroll content 708 that includes input 750a1 (e.g., a touch input, an air gesture, a gaze, a mouse click, and/or a combination thereof) directed at content 708. In response to detecting input 750a1, device 700 scrolls content 708 and displays scrollbar tracks 730a-730b and scrollbar thumbs 732a-732b, as depicted in FIG. 7B. At FIG. 7A, in response to detecting input 750a1, device 700 generates a first type of non-visual feedback 728a (e.g., an audio feedback and/or a haptic feedback) while content 708 is scrolled. In some embodiments, device 700 detects input 750a2 (e.g., a touch input, an air gesture, a gaze, a mouse click, and/or a combination thereof) at a location near an edge of user interface 706. In some embodiments, in response to detecting input 750a2, device 700 displays scrollbar track 730 and scrollbar thumb 732 (e.g., without scrolling content 708).

At FIG. 7B, device 700 scrolls content 708 of user interface 706 in response to input 750a1 . As depicted by scroll schematic 712, device 700 scrolls content 708 at scroll rate 724 that is based on hand rate 726 (e.g., the rate of scroll is proportional to the rate of hand movement). Device 700 also displays scrollbar tracks 730a-730b and scrollbar thumbs 732a-732b. At FIG. 7B, device 700 detects a hover input 750b (e.g., an air gesture, a gaze, an input positioned above scrollbar track 730a and/or scrollbar thumb 732a, and/or a mouse hovering above scrollbar track 730a and/or scrollbar thumb 732a). In some embodiments, hover input 750b includes an air gesture (e.g., a straight hand and/or a gesture other than an air pinching gesture) and a gaze directed at scrollbar track 730a and/or scrollbar thumb 732a. In some embodiments, hover input 750b includes a gaze directed at scrollbar track 730a and/or scrollbar thumb 732a and does not include an air gesture.

At FIG. 7B, in response to detecting hover input 750b, device 700 provides non-visual feedback 728b (e.g., a hover non-visual feedback). In some embodiments, non-visual feedback described herein is audio feedback and/or haptic feedback. In some embodiments, the non-visual feedback includes a frequency, a duration, and/or a waveform of non-visual feedback. Device 700 optionally provides different non-visual feedback for different computer operations and/or functions. For example, one computer operation optionally has one type of non-visual feedback (e.g., a first frequency value, a first duration value, and/or a first waveform value) while another computer operation has a different type of non-visual feedback (e.g., a second frequency value, a second duration value, and/or a second waveform value that is different from the first frequency value, the first duration value, and/or the first waveform value). In some embodiments, non-visual feedback 728b is different from (or, optionally, the same as) non-visual feedback 728a (e.g., non-visual feedback for scrolling content via an input directed at content).

At FIG. 7C, in response to detecting hover input 750b of FIG. 7B, device 700 modifies an appearance of scrollbar track 730a and/or scrollbar thumb 732a. As depicted, scrollbar track 730a and/or scrollbar thumb 732a of FIG. 7C are larger than scrollbar track 730a and/or scrollbar thumb 732a of FIG. 7B, as depicted by dashed line 734, which represents the size of scrollbar track 730a in FIG. 7B. Dashed line 734 is not displayed but is provided for illustration purposes. Further, scrollbar track 730b and/or scrollbar thumb 732b are not modified because input 750b is directed to scrollbar track 730a and/or scrollbar thumb 732a. In some embodiments, the appearance of scrollbar track 730b and/or scrollbar thumb 732b are modified in the same manner. In some embodiments, scrollbar track 730b and/or scrollbar thumb 732b are not displayed. In some embodiments, scrollbar track 730a and/or scrollbar thumb 732a is changed in a different manner than depicted in FIG. 7C (e.g., size, shape, and/or color). While displaying scrollbar track 730a and/or scrollbar thumb 732a with a modified appearance, device 700 detects input 750c (e.g., a touch input, an air gesture (e.g., an air pinch gesture or an air tap gesture), a mouse click, a gaze, and/or a combination thereof) directed at scrollbar track 730a and/or scrollbar thumb 732a. Device 700 detects input 750c while hand 714 is at position 736a along vertical arc 718. In some embodiments, device 700 detects input 750c within a threshold distance (e.g., 1 inch, 2 inches, and/or 3 inches) of scrollbar track 730a and/or scrollbar thumb 732a. In some embodiments, input 750c includes a gaze input directed at (or near) scrollbar track 730a and/or scrollbar thumb 732a while an air gesture (e.g., a pinch) is made. In some embodiments, a location of input 750c relative to a virtual object is based on the gaze input and is independent of the location of the pinch relative to user interface 706 (e.g., the pinch can be made in any portion of the three-dimensional environment to select a virtual object so long as a user's gaze is directed at the virtual object). In some embodiments, the position at which the pinch is made (e.g., in the physical environment) will correspond to the initial location (e.g., position A in FIG. 7A). In some embodiments, movement of the pinch from the initial location is used determine an amount (e.g., magnitude and/or rate) of movement of the input. In some embodiments, the initial location of the inputs described herein (including input 750a1, 750c, 750j, 750o, 750q, and/or 750t) are optionally based on the location of the gaze input (e.g., at least for determining an intended target relative to a graphical object on the user interface) and making a pinch gesture at an initial location in the physical environment (e.g., regardless of location relative to a graphical object on the user interface). In some embodiments, movement and/or displacement of the pinch gesture from the initial pinch location is used to determine movement of the input (e.g., movement 751a, movement 751d, movement 751f, movement 751g, movement 751j, movement 750m, movement 751o, movement 751q, movement 751r, movement 751s, movement 751t, movement 751u, and/or movement 751v). In some embodiments, detecting movement of the pinch gesture is independent of a location of a user's gaze (e.g., device 700 does not account for a movement of a user's gaze to determine a movement of a pinch gesture).

At FIG. 7C, in response to detecting input 750c, device 700 provides non-visual feedback 728c corresponding to a selection of scrollbar track 730a and/or scrollbar thumb 732a. In some embodiments, device 700 generates default non-visual feedback if a selectable object does not have assigned non-visual feedback. For example, in response to detecting a selection of menu affordance 742, device 700 generates a default non-visual feedback if menu affordance 742 does not have assigned non-visual feedback. In contrast, in response to detecting a selection of scrollbar track 730a and/or scrollbar thumb 732a (and/or font affordance 745), device 700 generates the assigned non-visual feedback (e.g., a pre-designated non-visual feedback) that is different from the default non-visual feedback that is provided in response to the selection of menu affordance 742.

At FIG. 7D, in response to detecting input 750c, device 700 modifies the appearance of scrollbar track 730a and/or scrollbar thumb 732a by adding notches 738 and changing the size and/or shape of scrollbar track 730a and/or scrollbar thumb 732a. As depicted, device 700 displays notches 738 in scrollbar track 730a. Notches 738 have different appearances (e.g., shape, color, fade, transparency, and/or size) based on their position within scrollbar track. For example, notches 738 located in center region 740a are displayed as being opaque (or non-faded) while notches 738 in end region 740b are semi-transparent (e.g., faded). The difference in appearance in notches 738 is illustrated by different shapes of notches in the center region 740a and end region 740b (e.g., notches 728 are depicted as the lines in center region 740a while the notches 728 in end region 740b are depicted by x's). Additionally, notches 738 move within in scrollbar track 730a as content 708 is scrolled. Notches 738 move under scrollbar thumb 732a as the notches 738 (and/or scrollbar thumb 732a) move. In some embodiments, notches 738 move in the same direction as content 708 is being moved (e.g., notches 738 shift up when content is shifted up). In some embodiments, notches 738 move in the opposite direction of scrollbar thumb 732a as content 708 is being scrolled (e.g., notches 738 shift up when scrollbar thumb 732a shifts down).

At FIG. 7D, in addition to adding notches 738, device 700 changes the appearance of scrollbar track 730a and/or scrollbar thumb 732a by shrinking the size and/or shape of scrollbar track 730a and/or scrollbar thumb 732a. For example, scrollbar track 730a and/or scrollbar thumb 732a of FIG. 7D are the same as the size and/or shape of scrollbar track 730a and/or scrollbar thumb 732a of FIG. 7B (e.g., which are both smaller compared to the size and/or shape of scrollbar track 730a and/or scrollbar thumb 732a of FIG. 7C). At FIG. 7D, in response to detecting input 750c, device 700 does not modify the appearance of the horizontal scroll bar (e.g., scrollbar track 730b and/or scrollbar thumb 732b) (e.g., notches 738 are not added and/or the size is not changed). In some embodiments, in response to detecting input 750c, device 700 modifies the appearance of the horizontal scrollbar (e.g., scrollbar track 730b and/or scrollbar thumb 732b) (e.g., notches 738 are added and/or size is changed).

At FIG. 7D, device 700 continues to detect input 750c (e.g., at least a portion thereof, such as a pinch portion of an input that includes both a pinch input and gaze input). In some embodiments, where input 750c is an air gesture, input 750c represents a user maintaining a respective hand gesture (e.g., a pinch gesture). In some embodiments, where input 750c is a touch input, input 750c represents a user maintaining contact with display 701). Device 700 further detects movement 751d of input 750c. For example, device 700 detects a movement of an air gesture (e.g., while the gesture is still being made) and/or a movement of a touch input (e.g., while the touch input maintains contact). In some embodiments, movement 751d of input 750c is independent of a movement a user's gaze (e.g., while a user's gaze is used to determine an initial position of a pinch gesture relative to a graphical object, device 700 does not account for the user's gaze in determining subsequent movement in the physical environment of the pinch gesture. Movement 751d includes distance along vertical arc 718 from position 736a to position 736b of FIG. 7E1. In some embodiments, device 700 detects vertical distance 720, depth distance 722, and/or rotation 723 of movement 751d. At FIG. 7D, device 700 provides non-visual feedback 728d at the beginning of scrolling. For example, device 700 provides non-visual feedback 728d when a start of movement 751d is detected. In some embodiments, non-visual feedback 728d is the same as (or different from) non-visual feedback 728a, 728b, and/or 728c.

At FIG. 7E1, in response to detecting movement 751d, device 700 is scrolling content 708, as depicted by the updated content 708. Content 708 continues to be scrolled while input 750c is no longer moving, which is illustrated by scroll rate 724 and no hand rate 726. This is further illustrated by hand 714 maintaining gesture 1 at position 736b along vertical arc 718. While scrolling content, both scrollbar thumb 732a and notches 738 move within scrollbar track 730b.

At FIG. 7E1, device 700 provides non-visual feedback 728e while scrolling content 708 that is based on input 750c (e.g., based on continuing to detect input 750c) directed at scrollbar track 730a and/or scrollbar thumb 732a. In some embodiments, non-visual feedback 728e is different from non-visual feedback 728a (generated based on scrolling via an input directed at content 708), non-visual feedback 728b (generated based on a hover input), non-visual feedback 728c (generated based on selecting the vertical scroll bar), and/or non-visual feedback 728d (generated based beginning to scroll content 708). In some embodiments, providing different non-visual feedback for functions and/or inputs allows a user to distinguish between what function and/or input was detected.

In some embodiments, the techniques and user interface(s) described in FIGS. 7A-7AF are provided by one or more of the devices described in FIGS. 1A-1P. For example, FIG. 7E2 illustrates an embodiment in which user interface 706 (e.g., as described in FIG. 7E1) is displayed on display module X701 of head-mounted device (HMD) X700. Display module X701 is analogous to display 701 in FIG. 7E1. In some embodiments, HMD X700 includes a pair of display modules that provide stereoscopic content to different eyes of the same user. For example, HMD X700 includes display module X701 (which provides content to a left eye of the user) and a second display module (which provides content to a right eye of the user). In some embodiments, the second display module displays a slightly different image than display module X701 to generate the illusion of stereoscopic depth. As depicted in FIG. 7E2, HMD X700 also displays the image of the physical environment 707. In some embodiments, HMD X700 also displays objects that represent physical and/or virtual objects in the three-dimensional environment. In some embodiments, HMD X700 includes sensors that are analogous to cameras 703 and/or 705 of device 700. For example, HMD X700 includes camera X703 which is analogous to front-side camera 703. In some embodiments HMD X700 includes a camera or sensor that is analogous to rear-side camera 705 of device 700.

At FIG. 7E2, in response to detecting movement 751d in FIG. 7D, HMD X700 is scrolling content 708, as depicted by the updated content 708 displayed via display module X701. Content 708 continues to be scrolled while input 750c is no longer moving, which is illustrated by scroll rate 724 and no hand rate 726. This is further illustrated by hand 714 maintaining gesture 1 at position 736b along vertical arc 718. While scrolling content, both scrollbar thumb 732a and notches 738 move within scrollbar track 730b.

At FIG. 7E2, HMD X700 provides non-visual feedback X728e while scrolling content 708 that is based on input 750c (e.g., based on continuing to detect input 750c) directed at scrollbar track 730a and/or scrollbar thumb 732a. In some embodiments, non-visual feedback X728e is different from non-visual feedback 728a (generated based on scrolling via an input directed at content 708), non-visual feedback 728b (generated based on a hover input), non-visual feedback 728c (generated based on selecting the vertical scroll bar), and/or non-visual feedback 728d (generated based beginning to scroll content 708). In some embodiments, providing different non-visual feedback for functions and/or inputs allows a user to distinguish between what function and/or input was detected.

In some embodiments, HMD X700 detects movement 751d or input 750c based on an air gesture performed by a user of HMD X700. In some embodiments, HMD X700 detects hands X750A and/or X750B of the user of HMD X700 and determines whether motion of hands X750A and/or X750B perform a predetermined air gesture corresponding to movement 751d and/or input 750c. In some embodiments, the predetermined air gesture for input 750c includes a pinch gesture. In some embodiments, the pinch gesture includes detecting movement of finger X750C and thumb X750D toward one another. In some embodiments, HMD X700 detects input 750c based on a gaze and air gesture input performed by the user of HMD X700. In some embodiments, the gaze and air gesture input includes detecting that the user of HMD X700 is looking at scrollbar track 730a and/or scrollbar thumb 732a (e.g., for more than a predetermined amount of time) and hands X750A and/or X750B of the user of HMD X700 perform a pinch gesture.

Any of the features, components, and/or parts, including the arrangements and configurations thereof shown in FIGS. 1B-1P can be included, either alone or in any combination, in HMD X700. For example, in some embodiments, HMD X700 includes any of the features, components, and/or parts of HMD 1-100, 1-200, 3-100, 6-100, 6-200, 6-300, 6-400, 11.1.1-100, and/or 11.1.2-100, either alone or in any combination. In some embodiments, display module X701 includes any of the features, components, and/or parts of display unit 1-102, display unit 1-202, display unit 1-306, display unit 1-406, display generation component 120, display screens 1-122a-b, first and second rear-facing display screens 1-322a, 1-322b, display 11.3.2-104, first and second display assemblies 1-120a, 1-120b, display assembly 1-320, display assembly 1-421, first and second display sub-assemblies 1-420a, 1-420b, display assembly 3-108, display assembly 11.3.2-204, first and second optical modules 11.1.1-104a and 11.1.1-104b, optical module 11.3.2-100, optical module 11.3.2-200, lenticular lens array 3-110, display region or area 6-232, and/or display/display region 6-334, either alone or in any combination. In some embodiments, HMD X700 includes a sensor that includes any of the features, components, and/or parts of any of one or more sensors 190, sensors 306, one or more image sensors 314, image sensors 404, sensor assembly 1-356, sensor assembly 1-456, sensor system 6-102, sensor system 6-202, sensors 6-203, sensor system 6-302, sensors 6-303, sensor system 6-402, and/or sensors 11.1.2-110a-f, either alone or in any combination. In some embodiments, HMD X700 includes one or more input devices, which include any of the features, components, and/or parts of any of first button 1-128, button 11.1.1-114, second button 1-132, and or dial or button 1-328, either alone or in any combination. In some embodiments, HMD X700 includes one or more audio output components (e.g., electronic component 1-112) for generating audio feedback (e.g., audio output), optionally generated based on detected events and/or user inputs detected by the HMD X700.

At FIG. 7F, device 700 continues to scroll content 708 while detecting that input 750c (e.g., at least a portion thereof) is maintained. For example, device 700 continues to detect gesture 1 of hand 714 regardless of whether a user's gaze has moved away from scrollbar track 730a and/or scrollbar thumb 732a. While device 700 continues to scroll content 708, device 700 provides non-visual feedback 728f. In some embodiments, non-visual feedback 728f is the same as (or different from) non-visual feedback 728e (which is generated while scrolling content 708 based on an input directed at scrollbar track 730a and/or scrollbar thumb 732a). At FIG. 7F, device 700 detects movement 751f of input 750c. In some embodiments, movement 751f is movement of an air gesture while the air gesture is still being made (e.g., independent of a movement of a user's gaze) and/or a movement of a touch input while the touch input maintains contact.

At FIG. 7G, device 700 updates the scroll rate based on movement 751f. In response to detecting movement 751f of FIG. 7F, device 700 scrolls content 708 at a faster rate, as depicted by scroll rate 724. Scroll rate 724 of FIG. 7G is higher as compared to scroll rate 724 of FIG. 7F, which is depicted as a single hatching in FIG. 7G. No hand rate 726 is depicted at a time that is after movement 751f and before detecting further movement, device 700 scrolls content 708 at scroll rate 724 without detecting any movement of hand 714 (e.g., any additional movement of the hand). Device 700 of FIG. 7G updates the scroll rate based on various components of movement 751f. Movement 751f of FIG. 7F includes distance along vertical arc 718 from position 736b to position 736c of FIG. 7H. In some embodiments, device 700 detects vertical distance 720, depth distance 722, and/or rotation 723 of movement 751f. In some embodiments, movement 751f includes an amount of vertical movement (e.g., vertical distance 720) that is different from an amount of vertical movement of movement 751d based on traveling along vertical arc 718. Despite the difference in the vertical movement, device 700 increases a scroll rate by a similar amount. This is illustrated by how the single hatched region (depicting the previous scroll rate) of scroll rate 724 is similar to the non-single hatched region, which represents the increase in scroll rate. This is because, as described with respect to FIG. 7A, device 700 will detect movement along different axes (and not just the vertical axis) when detecting a scroll input. As depicted in scroll schematic 712, device 700 continues to scroll content 708 at a moment in time when there is no movement of hand 714. Additionally, while device 700 continues to scroll content 708, device 700 provides non-visual feedback 728g. In some embodiments, non-visual feedback 728g is the same as (or different from) non-visual feedback 728a, 728b, 728c, 728d, 728e, and/or 728f.

At FIG. 7G, device 700 changes the appearance of scrollbar track 730a and scrollbar thumb 732a based on the appearance of underlying content. For example, scrollbar track 730a and scrollbar thumb 732a are overlaid on content 762 that has a different appearance than content 708 of FIG. 7F. Content 762 is illustrated with cross-hatching 760 to indicate content 762 is darker (e.g., has less luminance and/or not as bright) than content 708. Device 700 detects that scrollbar track 730a and scrollbar thumb 732a are overlaid on content 762 that is darker and, in response, lightens (e.g., greater luminance and/or is brighter) the appearance of scrollbar track 730a and scrollbar thumb 732a. In some embodiments, device 700 detects that scrollbar track 730a and scrollbar thumb 732a are overlaid on content that is lighter and, in response, darkens (e.g., has less luminance and/or not as bright) the appearance of scrollbar track 730a and scrollbar thumb 732a. Device 700 detects movement 751g of input 750c (e.g., movement of hand 714 while making gesture 1 and/or movement of a touch gesture that maintains contact with display 701). In some embodiments, movement 751g is movement of an air gesture while the air gesture is maintained (e.g., independent of a movement of a user's gaze) and/or a movement of a touch input while the touch input maintains contact.

At FIG. 7H, in response to detecting movement 751g of input 750c of FIG. 7G, device 700 updates scroll rate 724. Content 708 in FIG. 7H is now being scrolled upward as compared to being scrolled downward in FIG. 7G. This is because the location of input 750c is above original location 744 (e.g., initial position and/or position A) of input 750c. For example, gesture 1 is now at position 736d along vertical arc 718, which is above position 736a. While device 700 continues to scroll content 708 (e.g., at scroll rate 724), device 700 provides non-visual feedback 728h. In some embodiments, non-visual feedback 728h is the same as (or different from) non-visual feedback 728a, 728b, 728c, 728d, 728e, 728f, and/or 728g.

At FIG. 7I, device 700 has detected that input 750c has ended. For example, hand 714 is no longer making gesture 1. In some embodiments, a touch input has broken contact with display 701. In response to detecting the end of input 750c, device 700 continues to scroll content 708 with a simulated inertia (e.g., and without detecting a hand rate and/or input). In some embodiments, the simulated inertia has an initial rate that is based on the rate of scrolling at the release of input 750c. Device 700 gradually decreases scroll rate 724 of the simulated inertia over time until content 708 is no longer being scrolled, which is illustrated by a region of scroll rate 724 in FIG. 7I being smaller than a region of scroll rate 724 of 7H (depicted by a dotted line in FIG. 7I). In response to detecting the end of input 750c, device 700 changes the appearance of scrollbar track 730a and/or scrollbar thumb 732a. For example, notches 738 are no longer displayed.

At FIG. 7I, device 700 provides non-visual feedback 728i in response to detecting input 750c has ended. In some embodiments, non-visual feedback 728i is the same as (or different from) non-visual feedback 728a, 728b, 728c, 728d, 728e, 728f, 728g, and/or 728h. In some embodiments, non-visual feedback 728h is different from non-visual feedback 728d (e.g., non-visual feedback provided at the beginning scrolling) and/or non-visual feedback 728e, 728f, 728g, and/or 728h (non-visual feedback provided while scrolling).

At FIG. 7J, device 700 has stopped scrolling content 708. Device 700 detects input 750j (e.g., a touch input, an air gesture (e.g., an air pinch gesture or air tap gesture), a mouse click, a gaze, and/or a combination thereof) directed at scrollbar track 730a and/or scrollbar thumb 732a. In some embodiments, input 750j is based on a user's gaze (e.g., to determine a target relative to user interface 710) and a pinch gesture. In some embodiments, input 750j is a touch input. Device 700 detects input 750j at position 736e (e.g., in the physical environment), which is the initial location that is used for detecting subsequent movement. In response to detecting input 750j, device 700 changes the appearance of scrollbar track 730a and scrollbar thumb 732a to indicate that a movement of input 750j (e.g., a movement of hand 714 while gesture 1 is maintained) will result in a rate-based scrolling manner (e.g., as opposed to a swipe, which results in scrolling content 708 at a rate that is based on a rate of movement of the input as described with respect to FIG. 7A). Device 700 also provides non-visual feedback 728j, which is a designated type of non-visual feedback that is provided in response to detecting a selection of scrollbar track 730a and/or scrollbar thumb 732a so as to indicate that scrollbar track 730a and/or scrollbar thumb 732a have been selected, as described in greater detail with respect to FIG. 7C. In some embodiments, non-visual feedback 728j is the same as non-visual feedback 728c as both indicate that scrollbar track 730a and/or scrollbar thumb 732a have been selected. In some embodiments, non-visual feedback 728j is different from non-visual feedback 728a, 728b, 728d, 728e, 728f, 728g, 728h, and/or 728i. At FIG. 7J, device 700 detects movement 751j of input 750j away from position 736e and to position 736f. In some embodiments, movement 751j is movement of an air gesture while the air gesture is maintained (e.g., independent of a movement of a user's gaze) and/or a movement of a touch input while the touch input maintains contact.

At FIG. 7K, device 700 has scrolled up to a top end of content 708 in response to detecting movement 751j to position 736f. For example, device 700 scrolls content 708 at scroll rate 724. No hand rate is illustrated to indicate that after movement 751j is detected, device 700 still scrolls content 708 at scroll rate 724 of FIG. 7K, even though no further hand movement is detected (e.g., as long as hand 714 is maintained at position 736f in the physical environment). At FIG. 7K, device 700 detects that input 750j is maintained at position 736f even after the top end of content 708 is reached and, in response, scrolls content 708 beyond the top end of content 708 by shifting the top end of content 708 down and away from a top edge of user interface 706 such that blank portion 748 (e.g., a portion not having content 708) begins to be displayed. In response to detecting that content is scrolled beyond the top end of content 708, device 700 changes the appearance of scrollbar track 730a and/or scrollbar thumb 732a by stretching scrollbar track 730a and/or scrollbar thumb 732a. For example, scrollbar track 730a and/or scrollbar thumb 732a of FIG. 7K is longer (e.g., along the y-axis) and is not as wide (e.g., along the x-axis) than scrollbar track 730a and/or scrollbar thumb 732a of FIG. 7J, as depicted by the relationship of scrollbar track 730a and/or scrollbar thumb 732a to dashed line 746k (which indicates a size of scrollbar track 730a and/or scrollbar thumb 732a of FIG. 7J and is provided for illustrative purposes). In some embodiments, device 700 changes the appearance of scrollbar track 730a and/or scrollbar thumb 732a based on how far device 700 has scrolled past the end of content 708 (e.g., device 700 detects that content has scrolled beyond an end point of content by a respective amount and, in response, changes the appearance of the scrollbar track 730a and/or scrollbar thumb 732a accordingly). As such, scrolling further past the end of content 708 results in a greater change in appearance. As depicted, scrollbar track 730b and/or scrollbar thumb 732b does not change appearance while scrollbar track 730a and/or scrollbar thumb 732a change appearance because a left or right end (e.g., along the x-axis) has not been reached. Device 700 also provides non-visual feedback 728k. In some embodiments, non-visual feedback 728k is the same as non-visual feedback 728e, 728f, 728g, and 728h so as to indicate that content 708 is being scrolled. In some embodiments, non-visual feedback 728k is different from non-visual feedback 728e, 728f, 728g, and 728h to indicate that an end of content 708 has been reached.

At FIG. 7L, device 700 has scrolled further from the top end of content 708 in response to detecting that input 750j is maintained at position 736f. Additionally, device 700 scrolls content 708 at scroll rate 724 that is less than scroll rate 724 of FIG. 7L based on beginning to rubber band and/or bounce content 708 back. Device 700 scrolls content 708 further from the top end of content 708 by shifting the top end of content 708 further down and away from the top edge of user interface 706 such that blank portion 748 (e.g., a portion not having content 708) is larger than blank portion 748 of FIG. 7K. In response to detecting that content is scrolled further beyond the top end of content 708, device 700 changes the appearance of scrollbar track 730a and/or scrollbar thumb 732a by stretching scrollbar track 730a and/or scrollbar thumb 732a even further than scrollbar track 730a and/or scrollbar thumb 732a of FIG. 7K. For example, scrollbar track 730a and/or scrollbar thumb 732a of FIG. 7L is longer (e.g., along the y-axis) and is not as wide (e.g., along the x-axis) than scrollbar track 730a and/or scrollbar thumb 732a of FIG. 7K, as depicted by the relationship of scrollbar track 730a and/or scrollbar thumb 732a of FIG. 7L to dashed line 7461 (e.g., where dashed line 7461 indicates a previous size of scrollbar track 730a and/or scrollbar thumb 732a in FIG. 7K). In some embodiments, the change in appearance of scrollbar track 730a and/or scrollbar thumb 732a of FIG. 7L is based on scrolling past the end of content 708 by a greater amount than in FIG. 7K. As depicted, scrollbar track 730b and/or scrollbar thumb 732b does not change appearance while scrollbar track 730a and/or scrollbar thumb 732a change appearance because a left or right end (e.g., along the x-axis) has not been reached. Device 700 also provides non-visual feedback 728k. In some embodiments, non-visual feedback 7281 is the same as non-visual feedback 728j.

At FIG. 7M, device 700 completes the rubber-banding effect. For example, device 700 bounces content 708 back to its original position that it had before scrolling beyond the end of content. For example, device 700 has shifted a position of the end of content 708 up toward the top edge of user interface 706. In some embodiments, device 700 shifts the end of content 708 back in response to detecting that input 750j has ended. In some embodiments, device 700 shifts the end of content 708 back when the end of content 708 has been scrolled pasts content 708 by a threshold amount (e.g., 1 inch, 2 inches, or 3 inches) even though device 700 detects that input 750j is maintained. Device 700 also changes the appearance of scrollbar track 730a and/or scrollbar thumb 732a. For example, scrollbar track 730a and/or scrollbar thumb 732a of FIG. 7M is the same size and/or shape that it was prior to scrolling beyond the end of content 708 (e.g., the size and/or shape of scrollbar track 730a and/or scrollbar thumb 732a of FIG. 7J). Device 700 also stops displaying notches 738 in response to detecting that input 750j has ended. In some embodiments, if input 750j is maintained, device 700 continues to display notches 738.

At FIG. 7M, device 700 scrolls content 708 in different manners based on different types of scrolling input directed at content 708. In some embodiments, the different types of scrolling inputs are based on different types of gestures (e.g., touch-and-move gesture versus a flick gesture). In some embodiments, the different types of scrolling inputs are based on detecting an input using different types of input devices (e.g., touchpad, mouse, and/or one or more cameras). For example, device 700 detects input 750 ml (e.g., a touch input, an air gesture (e.g., an air pinch gesture or an air tap gesture), a mouse click, a gaze, and/or a combination thereof) of one type (e.g., a type of gesture and/or an input from a first type of input device) directed at content 708. Device 700 also detects input 750m2 (e.g., a touch input, an air gesture (e.g., an air pinch gesture or an air tap gesture), a mouse click, a gaze, and/or a combination thereof) of a different type (e.g., a different type of gesture and/or an input from a different type of input device) directed at content 708. In some embodiments, input 750 ml is gesture 1 while input 750m2 is gesture 2 that is different from gesture 1. In some embodiments, input 750 ml is an air gesture (e.g., detected via various cameras) while input 750m2 is a touch gesture (e.g., detected via a touchpad and/or a mouse) or vice versa. In some embodiments, input 750m2 is a flick input (e.g., an input where device 700 detects a release of a gesture while the gesture is moving above a threshold amount of movement (e.g., 0.5 ft/second, 1 ft/second, and/or 2 ft/second)). At FIG. 7M, device 700 also detects a movement of input 750 ml and/or of input 750m2.

For illustrative purposes, movement 751m is used to depict the movement of input 750 ml and/or of input 750m2. In some embodiments, movement 751m is movement of an air gesture while the air gesture is maintained (e.g., independent of a movement of a user's gaze) and/or a movement of a touch input while the touch input maintains contact. In some embodiments, movement 751m is the same amount of movement for both input 750 ml and input 750m2. In some embodiments, movement 751m is different for both input 750 ml and input 750m2. Device 700 also provides different non-visual feedback 728m in response to scrolling content 708 via different types of input directed at content 708. In some embodiments, non-visual feedback 728m is a first type non-visual feedback in response to detecting input 750 ml. In some embodiments, in response to detecting input 750m2, device 700 provides a second type of non-visual feedback 728m that is different from (and/or the same as) the first type.

At FIG. 7N, in response to detecting input 750 ml, device 700 scrolls content 708 at scroll rate 724 that is based on hand rate 726 of movement 750m. In some embodiments, scrolling content 708 in response to detecting input 750 ml includes scrolling with a simulated inertia. As depicted in FIG. 7N, device 700 shifts content 708 in a direction that is the same as a direction of movement 750m (e.g., movement 750m is up and content 708 is shifted up). In some embodiments, device 700 shifts content 708 in a direction that is opposite of a direction of movement 750m (e.g., movement 750m is up and content 708 is shifted down).

At FIG. 7O, in response to detecting input 750m2, device 700 scrolls content 708 by a predefined amount (e.g., a bump scroll) (e.g., an amount that does not dependent on hand rate 726 of movement 750m). As depicted, device 700 has scrolled content 708 of FIG. 7O further than content 708 of FIG. 7N. In some embodiments, device 700 has scrolled content 708 of FIG. 7O further than content 708 of FIG. 7N even though input 750 ml and input 750m2 both have the same amount of movement (e.g., movement 751m). Scrolling schematic 712 does not include scroll rate 724 to illustrate that content 708 was scrolled by a predefined amount. In some embodiments, the predefined amount includes a predefined amount of shifting of content 708. In some embodiments, device 700 shifts content 708 by the predefined amount in a direction that is the same as a direction of movement 750m (e.g., movement 750m is up and content 708 is shifted up). As depicted in FIG. 7O, device 700 shifts content 708 by the predefined amount in a direction that is the same as a direction of movement 750m (e.g., movement 750m is up and content 708 is shifted up). In some embodiments, device 700 shifts content 708 by the predefined amount in a direction that is opposite of a direction of movement 750m (e.g., movement 750m is up and content 708 is shifted down).

At FIG. 7O, device 700 scrolls content 708 in a different manner based on a different type of input directed at scrollbar track 730a and/or scrollbar thumb 732a. In some embodiments, the different types of scrolling inputs directed to scrollbar track 730a and/or scrollbar thumb 732a are based on different types of gestures (e.g., touch-and-move gesture versus a flick gesture). In some embodiments, the different types of scrolling inputs scrollbar track 730a and/or scrollbar thumb 732a are based on detecting an input using different types of input devices (e.g., touchpad, mouse, and/or one or more cameras).

At FIG. 7O, device 700 detects input 750o (e.g., a touch input, an air gesture (e.g., an air pinch gesture or an air tap gesture), a mouse click, a gaze, and/or a combination thereof) of one type (e.g., a type of gesture and/or an input from a first type of input device) directed at scrollbar track 730a and/or scrollbar thumb 732a. In some embodiments, input 750o is a different type of gesture than gesture 1 (e.g., of FIGS. 7C-7H, and 7J). In some embodiments, input 750o is detected via a different type of input device (e.g., a touch pad and/or a mouse) than the input device used to detect gesture 1 (e.g., of FIGS. 7C-7H, and 7J). Device 700 also detects movement 751o of input 750o. In some embodiments, movement 751o is movement of an air gesture while the air gesture is maintained (e.g., independent of a movement of a user's gaze) and/or a movement of a touch input while the touch input maintains contact. Device 700 also provides non-visual feedback 728o in response to scrolling content 708 via an input directed at scrollbar track 730a and/or scrollbar thumb 732a (e.g., as opposed to input 750 ml or input 750m2, which is directed to content 708). In some embodiments, non-visual feedback 728o is different from non-visual feedback 728m. In some embodiments, device 700 does not change the appearance of scrollbar track 730a and/or scrollbar thumb 732a in response to detecting input 750o.

At FIG. 7P, device 700 has scrolled content 708 by a predefined amount (e.g., as opposed to using a rate-based scroll that is based on movement from an original location as described with respect to FIGS. 7C-7H, and 7J).

At FIG. 7Q, device 700 displays a bottom end of content 708. While displaying the bottom end of content 708, device 700 detects input 750q (e.g., a touch input, an air gesture (e.g., an air pinch gesture or an air tap gesture), a mouse click, a gaze, and/or a combination thereof), including movement 751q, to scroll content 708. In some embodiments, movement 751q is movement of an air gesture while the air gesture is maintained (e.g., independent of a movement of a user's gaze) and/or a movement of a touch input while the touch input maintains contact. Device 700 provides non-visual feedback 728q to indicate scrolling content 708 via an input directed at content 708.

At FIG. 7R1, device 700 scrolls beyond the bottom end of content 708. For example, device 700 shifts the bottom end of content 708 up and away from a bottom edge of user interface 710 so as to begin to display blank portion 748. In response to detecting that content is scrolled beyond the bottom end of content 708, device 700 changes the appearance of scrollbar track 730a and/or scrollbar thumb 732a by stretching scrollbar track 730a and/or scrollbar thumb 732a. For example, scrollbar track 730a and/or scrollbar thumb 732a of FIG. 7R1 is longer (e.g., along the y-axis) and is not as wide (e.g., along the x-axis) as scrollbar track 730a and/or scrollbar thumb 732a of FIG. 7Q, as depicted by the relationship of scrollbar track 730a and/or scrollbar thumb 732a to dashed line 746r (which indicates a size of scrollbar track 730a and/or scrollbar thumb 732a of FIG. 7Q). In some embodiments, device 700 changes the appearance of scrollbar track 730a and/or scrollbar thumb 732a based on how far device 700 has scrolled past the end of content 708 (e.g., device 700 detects that content has scrolled beyond an end point of content by a respective amount and, in response, changes the appearance of the scrollbar track 730a and/or scrollbar thumb 732a accordingly). In some embodiments, device 700 changes the appearance of scrollbar track 730a and/or scrollbar thumb 732a based on the amount of movement 751q (and/or the amount of movement of content 708). In some embodiments, a lower amount of movement 751q results in a lower degree of change in appearance while a greater amount of movement 751q results in a greater degree of change in appearance. As depicted, scrollbar track 730b and/or scrollbar thumb 732b does not change because a left or right end (e.g., along the x-axis) has not been reached. At FIG. 7R1, device 700 continues to detect input 750q, including movement 75Ir. In some embodiments, movement 751r is movement of an air gesture while the air gesture is maintained (e.g., independent of a movement of a user's gaze) and/or a movement of a touch input while the touch input maintains contact.

As previously mentioned, the techniques and user interface(s) described in FIGS. 7A-7AF are provided, in some embodiments, by one or more of the devices described in FIGS. 1A-1P. For example, FIG. 7R2 illustrates an embodiment in which user interface 710 (e.g., as described in FIG. 7R1) is displayed on display module X701 of HMD X700. Display module X701 is analogous to display 701 in FIG. 7R1. In some embodiments, HMD X700 includes a pair of display modules that provide stereoscopic content to different eyes of the same user. For example, HMD X700 includes display module X701 (which provides content to a left eye of the user) and a second display module (which provides content to a right eye of the user). In some embodiments, the second display module displays a slightly different image than display module X701 to generate the illusion of stereoscopic depth. As depicted in FIG. 7R2, HMD X700 also displays the image of the physical environment 707. In some embodiments, HMD X700 also displays objects that represent physical and/or virtual objects in the three-dimensional environment.

In FIG. 7R2, HMD X700 scrolls beyond the bottom end of content 708. For example, HMD X700 shifts the bottom end of content 708 up and away from a bottom edge of user interface 710 so as to begin to display blank portion 748. In response to detecting that content is scrolled beyond the bottom end of content 708, HMD X700 changes the appearance of scrollbar track 730a and/or scrollbar thumb 732a by stretching scrollbar track 730a and/or scrollbar thumb 732a. For example, scrollbar track 730a and/or scrollbar thumb 732a of FIG. 7R2 is longer (e.g., along the y-axis) and is not as wide (e.g., along the x-axis) as scrollbar track 730a and/or scrollbar thumb 732a of FIG. 7Q, as depicted by the relationship of scrollbar track 730a and/or scrollbar thumb 732a to dashed line 746r (which indicates a size of scrollbar track 730a and/or scrollbar thumb 732a of FIG. 7Q). In some embodiments, HMD X700 changes the appearance of scrollbar track 730a and/or scrollbar thumb 732a based on how far HMD X700 has scrolled past the end of content 708 (e.g., HMD X700 detects that content has scrolled beyond an end point of content by a respective amount and, in response, changes the appearance of the scrollbar track 730a and/or scrollbar thumb 732a accordingly). In some embodiments, HMD X700 changes the appearance of scrollbar track 730a and/or scrollbar thumb 732a based on the amount of movement 751q (and/or the amount of movement of content 708). In some embodiments, a lower amount of movement 751q results in a lower degree of change in appearance while a greater amount of movement 751q results in a greater degree of change in appearance. As depicted, scrollbar track 730b and/or scrollbar thumb 732b does not change because a left or right end (e.g., along the x-axis) has not been reached.

At FIG. 7R2, HMD X700 continues to detect input 750q, including movement 751r. For example, in some embodiments, HMD X700 detects input 750q based on an air gesture performed by a user of HMD X700. In some embodiments, movement 751r is movement of the air gesture while the air gesture is maintained (e.g., independent of a movement of a user's gaze) and/or a movement of a touch input while the touch input maintains contact. In some embodiments, HMD X700 detects hands X750A and/or X750B of the user of HMD X700 and determines whether motion of hands X750A and/or X750B perform a predetermined air gesture corresponding to input 750q. In some embodiments, the predetermined air gesture for input 750q includes a pinch gesture. In some embodiments, the pinch gesture includes detecting movement of finger X750C and thumb X750D toward one another. In some embodiments, HMD X700 detects input 750q based on a gaze and air gesture input performed by the user of HMD X700. In some embodiments, the gaze and air gesture input includes detecting that the user of HMD X700 is looking at content 708 (e.g., for more than a predetermined amount of time) and hands X750A and/or X750B of the user of HMD X700 perform a pinch gesture.

At FIG. 7S, device 700 has scrolled further from the bottom end of content 708 in response to detecting movement 751r of FIG. 7R1. Device 700 scrolls content 708 at scroll rate 724 that is less than scroll rate 724 of FIG. 7R1 based on beginning to rubber band and/or bounce content 708 back. Device 700 scrolls content 708 further by shifting the bottom end of content 708 further up and away from the bottom edge of user interface 706 such that blank portion 748 of FIG. 7S is larger than blank portion 748 of FIG. 7R1. Device 700 also changes the appearance of scrollbar track 730a and/or scrollbar thumb 732a by stretching scrollbar track 730a and/or scrollbar thumb 732a even further than the size and/or shape of scrollbar track 730a and/or scrollbar thumb 732a of FIG. 7R1 (where dashed line 746s indicates the size of scrollbar track 730a and/or scrollbar thumb 732a in FIG. 7R1). For example, scrollbar track 730a and/or scrollbar thumb 732a of FIG. 7S is longer than (e.g., along the y-axis) and is not as wide (e.g., along the x-axis) as scrollbar track 730a and/or scrollbar thumb 732a of FIG. 7R1. As depicted, scrollbar track 730b and/or scrollbar thumb 732b does not change appearance because a left or right end (e.g., along the x-axis) has not been reached. Device 700 detects further movement 751s of input 750q. In some embodiments, movement 751s is movement of an air gesture while the air gesture is maintained (e.g., independent of a movement of a user's gaze) and/or a movement of a touch input while the touch input maintains contact.

At FIG. 7T, device 700 bounces content 708 back to its original position before scrolling beyond the end of content so as to complete the rubber banding effect. For example, device 700 has shifted a position of the end of content 708 down as compared to a position of the end of content 708 of FIG. 7S. In some embodiments, device 700 shifts the end of content 708 back in response to detecting that input 750q has ended. In some embodiments, device 700 shifts the end of content 708 back when the content 708 has been scrolled passed an end of content 708 by a threshold amount (e.g., 1 inch, 2 inches, or 3 inches) even though device 700 detects that input 750q is maintained. Device 700 also changes the appearance of scrollbar track 730a and/or scrollbar thumb 732a. For example, scrollbar track 730a and/or scrollbar thumb 732a of FIG. 7T is at a size and/or shape that scrollbar track 730a and/or scrollbar thumb 732a was prior to scrolling beyond the end of content 708 (e.g., the size and/or shape of scrollbar track 730a and/or scrollbar thumb 732a of FIG. 7Q).

At FIG. 7T, device 700 detects input 750t (e.g., a touch input, an air gesture (e.g., an air pinch gesture or an air tap gesture) to scroll content vertically and horizontally based on movement 751t. In some embodiments, movement 751t is movement of an air gesture while the air gesture is maintained (e.g., independent of a movement of a user's gaze) and/or a movement of a touch input while the touch input maintains contact. As described with respect to FIG. 7A, device 700 scrolls content 708 using movement (e.g., including rotation) of an air gesture along multiple axes. As depicted by vertical rotation schematic 721, movement 751t includes movement along the vertical axis (e.g., up) and the depth axis (toward the user). As depicted by horizontal rotation schematic 752, movement 751t includes movement along the horizontal axis (e.g., to the left) and the depth axis (toward the user). As fingers 716 move along horizontal arc 754 from position 736g to 736h, device 700 detects horizontal distance 756 (e.g., along the x-axis), depth distance 722 (e.g., along the z-axis), and/or rotation 758. In some embodiments, to scroll the content along the horizontal axis (e.g., left or right), device 700 uses a value based on the horizontal distance 756 and a value that is based on the depth distance 722 and/or rotation 758. In some embodiments, the depth axis is perpendicular to the horizontal axis. In some embodiments, device scrolls content 708 along the horizontal axis when scrolling the content left or right and/or using scrollbar track 730b and/or scrollbar thumb 732b. At FIG. 7R1, movement 751t includes a greater amount of vertical movement than horizontal movement, as depicted by a larger indicator of movement 751t in vertical rotation schematic 721 than the indicator of movement 751t depicted in horizontal rotation schematic 752.

At FIG. 7U, device 700 scrolls beyond the bottom end and the right end of content 708. For example, device 700 shifts the bottom end of content 708 up and away from a bottom edge of user interface 710 and shifts the right end of content 708 to the left and away from a right edge of user interface 710. Accordingly, device 700 displays blank portion 748 both below the bottom end of content 708 and to the right of the right end of content 708.

At FIG. 7U, device 700 changes the appearance of scrollbar track 730a and/or scrollbar thumb 732a, as depicted by the comparison in size and/or shape of scrollbar track 730a and/or scrollbar thumb 732a to the size and/or shape of dashed line 746t (which represents the size and/or shape of scrollbar track 730a and/or scrollbar thumb 732a in FIG. 7T). Device 700 also changes the appearance of scrollbar track 730b and/or scrollbar thumb 732b, as depicted by the comparison in size and/or shape of scrollbar track 730b and/or scrollbar thumb 732b to the size and/or shape of dashed line 746u (which represents the size and/or shape of scrollbar track 730b and/or scrollbar thumb 732b in FIG. 7T). The appearance of scrollbar track 730b and/or scrollbar thumb 732b has changed less than scrollbar track 730a and/or scrollbar thumb 732a because device 700 has scrolled beyond an end of content 708 in the vertical direction by a greater amount than what device 700 has scrolled beyond an end of content 708 in the horizontal direction (and/or because device 700 detects that movement 751t is greater along vertical arc 718 than horizontal arc 736). At FIG. 7U, device 700 detects movement 751u of input 750t, where movement 751u that has a greater amount of vertical movement than horizontal movement.

At FIG. 7V, device 700 scrolls further beyond the bottom end and the right end of content 708 in response to detecting movement 751u. For example, device 700 shifts the bottom end of content 708 further up and away from a bottom edge of user interface 710 and shifts the right end of content 708 further to the left and away from a right edge of user interface 710. Accordingly, device 700 displays a larger blank portion 748 both below and to the right of content 708 as compared to blank portion 748 of FIG. 7U.

At FIG. 7V, device 700 also changes the appearance of scrollbar track 730a and/or scrollbar thumb 732a in response to detecting movement 751u, as depicted by the comparison in size and/or shape of scrollbar track 730a and/or scrollbar thumb 732a to the size and/or shape of dashed line 746v (which represents the size and/or shape of scrollbar track 730a and/or scrollbar thumb 732a in FIG. 7U). Device 700 also changes the appearance of scrollbar track 730b and/or scrollbar thumb 732b in response to detecting movement 751u. The appearance of scrollbar track 730b and/or scrollbar thumb 732b has changed as depicted by the comparison in size and/or shape of scrollbar track 730b and/or scrollbar thumb 732b to the size and/or shape of dashed line 746w (which represents the size and/or shape of size and/or shape of scrollbar track 730b and/or scrollbar thumb 732b in FIG. 7U). The appearance of scrollbar track 730b and/or scrollbar thumb 732b has changed less than scrollbar track 730a and/or scrollbar thumb 732a because device 700 has scrolled beyond an end of content 708 in the vertical direction by a greater amount than what device 700 has scrolled beyond an end of content 708 in the horizontal direction (e.g., device has scrolled beyond the bottom end of content 708 more than the right end of content 708) (and/or because movement 751u is greater along vertical arc 718 than horizontal arc 736). At FIG. 7U, device 700 detects movement 751v of input 750t, where movement 751v that has a greater amount of vertical movement than horizontal movement. Additionally, device 700 scrolls content 708 at scroll rate 724 that is less than scroll rate 724 of FIG. 7V based on beginning to rubber band and/or bounce content 708 back.

At FIG. 7W, device 700 bounces content 708 back to its original position before scrolling beyond the right end and bottom end of content 708 so as to complete the rubber banding effect. For example, device 700 has shifted the bottom end of content 708 down and has shifted the right end of content 708 to the right. In some embodiments, device 700 shifts content 708 back in response to detecting that input 750t has ended. In some embodiments, device 700 shifts content 708 back when the end of content 708 has been scrolled past an end of the content by a threshold amount (e.g., 1 inch, 2 inches, or 3 inches) even though device 700 detects that input 750t is maintained. Device 700 also changes the appearance of scrollbar track 730a and/or scrollbar thumb 732a and scrollbar track 730b and/or scrollbar thumb 732b. For example, scrollbar track 730a and/or scrollbar thumb 732a of FIG. 7W is the same size and/or shape as it was prior to scrolling beyond the bottom end of content 708 (e.g., the size and/or shape of scrollbar track 730a and/or scrollbar thumb 732a of FIG. 7T). Scrollbar track 730b and/or scrollbar thumb 732b of FIG. 7W is also the same size and/or shape that it was prior to scrolling beyond the right end of content 708 (e.g., the size and/or shape of scrollbar track 730b and/or scrollbar thumb 732b of FIG. 7T).

At FIG. 7X, HMD X700 displays, via display module X701, user interface 706 that includes content 708, in a similar manner as seen in FIG. 7B. As was seen in FIG. 7B, user interface 706 in FIG. 7X includes scrollbar track 730a and scrollbar thumb 732a. At FIG. 7X, HMD X700 is in communication (e.g., wireless or wired communication) with trackpad Y702, which is a touch-sensitive surface that can detect and track contacts, such as contacts from hand Y704 of the user of HMD X700. At FIG. 7X, HMD X700 detects that the user's gaze is currently directed to gaze location Y706. In some embodiments, HMD X700 displays a visual indication of the currently detected gaze location (e.g., an eye symbol, a dot, or a circle). In some embodiments, such a visual indication is not displayed. At FIG. 7X, HMD X700 also detects, via trackpad Y702, input Y708A, which is a tap of the index finger of hand Y704, while the user's gaze is detected at gaze location Y706. In some embodiments, input Y708A is a different type of contact, such as a double tap or two finger tap or an air gesture (e.g., an air pinch or an air tap or double tap) that is detected without the use of trackpad Y702.

At FIG. 7Y, in response to input Y708A, HMD X700 activates a cursor mode that includes displaying cursor Y710 at gaze location Y706 (e.g., HMD X700 activates a cursor that is initially placed at the user's gaze location). In some embodiments, HMD X700 outputs one or more non-visual (e.g., audio and/or haptic) indications that the cursor mode has been activated. In some embodiments, the cursor mode provides an alternative input to a gaze-and-air-gesture input mode, such as that depicted in FIGS. 7A-7W. In some embodiments, the cursor mode allows the user to manipulate a cursor via movements of the user's hand (e.g., detected with trackpad Y702 or via one or more cameras of HMD X700). In some embodiments, after being invoked, the position of cursor Y708 is controlled by the user's gaze. At FIG. 7Y, HMD X700 detects movement input Y712A, which is movement of hand Y704 (e.g., movement of the index finger of hand Y704 while input Y708A continues to be detected) to the right. In some embodiments, movement input Y712A is detected without the use of a trackpad (e.g., the movement is an air gesture or a part of an air gesture detected via one or more cameras of HMD X700).

At FIG. 7Z, in response to movement Y712A, HMD X700 moves cursor Y710 to a location over scrollbar thumb 732a. At FIG. 7Z, HMD X700 detects input Y708B (e.g., a tap or double tap of the index finger of hand Y704) while cursor Y710 is over scrollbar thumb 732a.

At FIG. 7AA, in response to input Y708B, HMD X700 modifies an appearance of cursor Y710, scrollbar track 730a, and/or scrollbar thumb 732a, in a similar manner to that discussed at FIG. 7C. As depicted, scrollbar track 730a and/or scrollbar thumb 732a of FIG. 7AA are larger than scrollbar track 730a and/or scrollbar thumb 732a of FIG. 7Z, as depicted by dashed line Y734, which represents the size of scrollbar track 730a in FIG. 7Z. Dashed line Y734 is not displayed but is provided for illustration purposes. Further, scrollbar track 730b and/or scrollbar thumb 732b are not modified because cursor Y710, and therefore input Y708B, is directed to scrollbar track 730a and/or scrollbar thumb 732a, rather than scrollbar track 730b and/or scrollbar thumb 732b. In contrast to FIG. 7AD, HMD X700 does not cause notches 738 to be displayed, so as to provide the user with visual guidance that a different scrolling mode (e.g., a cursor-based and/or amount-based scrolling mode) is currently active. At FIG. 7AA, HMD X700 detects movement input Y712B, which is movement of hand Y704 (e.g., movement of the index finger of hand Y704 while input Y708B continues to be detected) in a downward direction. In some embodiments, movement input Y712B is detected without the use of a trackpad (e.g., the movement is an air gesture or a part of an air gesture detected via one or more cameras of HMD X700).

At FIG. 7AB, in response to detecting movement input Y712B while cursor Y710 is over scrollbar thumb 732a, HMD X700 scrolls content 708 such that lines 30-41 of content 708 is now visible and also updates the position of cursor Y710 and scrollbar thumb 732a to reflect the detected movement and the current position within content 708. HMD X700 scrolls content 708 and moves scrollbar thumb 732a by an amount that is based on (e.g., proportional to and/or matching) the distance that hand Y704 (e.g., or a portion of hand Y704, such as the index finger) was moved (e.g., by a distance of movement input Y712B). In some embodiments, the rate of scrolling of content 708 and/or the rate that scrollbar thumb 732a moves is based on a rate/velocity of movement input Y712B. Thus, in contrast to the scrolling depicted in FIGS. 7A-7E1 where the velocity at which content 708 was scrolled was based on the amount of movement of movement 751d of input 750c, the amount of movement of movement input Y712B controls the amount by which content 708 is scrolled at FIGS. 7AA-7AB. For example, had the amount of movement of movement input Y712B been only half of that shown in FIGS. 7AA-7AB, content 708 would have been scrolled by 15 lines, rather than the 30 lines shown in FIG. 7AB. In further contrast to the scrolling depicted in FIGS. 7A-7E1 where scrolling continued while the user's hand remained deflected away from the hand's starting position, the scrolling of content in FIG. 7AB stops once movement input 712B stops. In some embodiments, HMD X700 further modifies the appearance of scrollbar track 730a and/or the appearance of scrollbar thumb 732a (e.g., by stretching the track or thumb (e.g., elongating and/or thinning) or implementing a rubberbanding effect) to reflect the scrolling of content, as described in more detail with respect to FIGS. 7B to 7M, depending on the nature of the scrolling. At FIG. 7AB, HMD X700 detects movement input Y712C, which is movement of hand Y704 (e.g., movement of the index finger of hand Y704 after input Y708B is released (e.g., the user's input finger is lifted and then placed back down again) in a downward direction. In some embodiments, movement input Y712C is detected without the use of a trackpad (e.g., the movement is an air gesture or a part of an air gesture detected via one or more cameras of HMD X700).

At FIG. 7AC, in response to movement input 712C, HMD X700 repositions cursor Y710 without repositioning scrollbar thumb 732a and without scrolling content 708 (e.g., because input Y708B was released/terminated prior to movement input 712C). Cursor Y710 is now positioned at a lower portion of scrollbar track 730a; specifically, within a lower 25% portion of scrollbar track 730a that is demarked by dashed outline Y714B, which is provided for illustrative purposes and not displayed as part of user interface 706. Dashed outline Y714A depicts an upper 25% portion of scrollbar track 730a. At FIG. 7AC, HMD X700 detects input Y708C (e.g., a tap or double tap of the index finger of hand Y704) while cursor Y710 is positioned within the lower 25% portion of scrollbar track 730a.

At FIG. 7AD, in response to detecting input Y708C, HMD X700 navigates to a lower end portion of content 708 that includes lines 89-100 of content 708. In some embodiments, navigating to the lower end portion of content 708 includes displaying content 708 animatedly scrolling to lines 89-100. In some embodiments, the navigation does not include animated scrolling. Thus, a user of HMD X700 can quickly navigate to an end portion of content 708 by providing an input while cursor Y710 is positioned in a predetermined portion of scrollbar track 730a (e.g., an upper or lower 5%, 10%, 15%, 25%, or 50% portion of the track). In some embodiments, lines 89-100 are the last lines of content 708 that are currently preloaded, with additional content corresponding to content 708 being available, but not yet loaded. In such embodiments, content 708 can be scrolled further (e.g., using one or more of the scrolling methods discussed herein) to cause additional content to be loaded (e.g., to cause lines 101-200 of content 708 to be loaded). In such embodiments, the position of scrollbar thumb 732a can be updated to reflect the new amount of preloaded content (e.g., lines 1-200). Further in such embodiments, a subsequent input within the lower 25% portion of scrollbar track 730a, similar to input Y708C, can be provided to quickly navigate to the end of the updated, preloaded content (e.g., to quickly navigate to display line 200 of content 708). At FIG. 7AD, HMD X700 detects movement input Y712D, which is movement of hand Y704 (e.g., movement of the index finger of hand Y704 after input Y708C is released (e.g., the user's input finger is lifted and then placed back down again) in an upward direction. In some embodiments, movement input Y712D is detected without the use of a trackpad (e.g., the movement is an air gesture or a part of an air gesture detected via one or more cameras of HMD X700).

At FIG. 7AE, in response to detecting movement input 712D, HMD X700 repositions cursor Y710 without repositioning scrollbar thumb 732a and without scrolling content 708 (e.g., because input Y708B was released/terminated before movement input 712D). Cursor Y710 is now positioned at an upper portion of scrollbar track 730a; specifically, within an upper 25% portion of scrollbar track 730a that is demarked by dashed outline Y714A, which is provided for illustrative purposes and not displayed as part of user interface 706. At FIG. 7AE, HMD X700 detects input Y708D (e.g., a tap or double tap of the index finger of hand Y704) while cursor Y710 is positioned within the upper 25% portion of scrollbar track 730a.

At FIG. 7AF, in response to detecting input Y708D, HMD X700 navigates to an upper end portion of content 708 that includes lines 1-11 of content 708 (e.g., the same starting portion of content as seen in FIG. 7X). In some embodiments, navigating to the upper end portion of content 708 includes displaying content 708 animatedly scrolling to lines 1-11. In some embodiments, the navigation does not include animated scrolling. Thus, a user of HMD X700 can quickly navigate to either end of content 708 by providing an input within predetermined portions (e.g., an upper or lower 5%, 10%, 25%, or 50% of the scrollbar track) of scrollbar track 730a, regardless of the length of content 708.

Additional descriptions regarding FIGS. 7A-7AF are provided below in reference to method 800 described with respect to FIG. 8 and method 900 described with respect to FIG. 9.

FIG. 8 is a flow diagram of an exemplary method 800 for scrolling content, in some embodiments. In some embodiments, method 800 is performed at a computer system (e.g., 700 and/or X700) (e.g., computer system 101 in FIG. 1A) (e.g., a smartphone, a tablet computer, a laptop computer, a desktop computer, and/or a head mounted device (e.g., a head mounted augmented reality and/or extended reality device)) including a display generation component (e.g., 701 and/or X701) (e.g., display generation component 120 in FIGS. 1A, 3, and 4) (e.g., a display controller, a touch-sensitive display system, a monitor, and/or a head mounted display system) (e.g., a heads-up display, a display, a touchscreen, a projector, etc.), one or more input devices (e.g., 701, X701, 703, X703, and/or 705) (e.g., one or more cameras, a touch-sensitive surface, a keyboard, integrated and/or connected motion sensors, a controller, and/or a mouse) (in some embodiments, the computer system in communication with one or more cameras (e.g., an infrared camera, a depth camera, and/or a visible light camera)), and, optionally, one or more cameras (e.g., a camera (e.g., color sensors, infrared sensors, and other depth-sensing cameras) that points downward at a user's hand or a camera that points forward from the user's head). In some embodiments, method 800 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 800 are, optionally, combined and/or the order of some operations is, optionally, changed.

The computer system (e.g., 700 and/or X700) displays (802), via the display generation component (e.g., 701 and/or X701), a graphical user interface (e.g., 706) (in some embodiments, the graphical user interface includes a representation of an application and/or a representation of a three-dimensional environment) including a representation of content (e.g., 708) (e.g., text, images, selectable interface objects, and/or text entry fields) (e.g., of an application and/or of a document) and a scrolling indicator (e.g., scrollbar track 730a, scrollbar thumb 732a, scrollbar track 730b, scrollbar thumb 732b) (e.g., a scroll progress indication (e.g., a scroll bar thumb) and/or a scroll track graphical object (e.g., a scroll bar trough)). In some embodiments, the scrolling indicator is displayed as being overlaid on a portion of a representation of the application (and/or adjacent to the representation of the content). In some embodiments, the scrolling indicator is displayed as not being overlaid on a portion of the representation of the application (and/or not adjacent to the representation of the content). In some embodiments, the scrolling indicator is overlaid on a representation of the three-dimensional environment. In some embodiments, the displayed representation of content is a sub-portion of a larger piece of content (e.g., a web page, an e-book, a document) and the scrolling indicator indicates the position that the representation of content occupies within the larger piece of content (e.g., the representation of content is page 5 in a 100-page document). The computer system detects (804), via the one or more input devices, a first set of one or more inputs (e.g., an air gesture, a gaze, a touch input, and/or a mouse click or a combination thereof) that includes a first input directed at the scrolling indicator (e.g., 750c) (in some embodiments, within a threshold distance from the scrolling indicator). In some embodiments, the first set of one or more inputs includes a gaze input and/or an air gesture input. In response to detecting the first set of one or more inputs (806) (in some embodiments, and while continuing to detect an input (e.g., a component and/or portion) of the first set of one or more inputs (e.g., the computer system continues to detect the air gesture, contact of the touch input (e.g., touch-and-hold input), and/or the mouse selection)) and in accordance with a determination that the first input (e.g., an air gesture, a gaze, a touch input, and/or a mouse click) includes a first magnitude of movement (e.g., 751d, 751r, and/or 751g) (e.g., distance of the movement and/or magnitude of rotation of the movement), the computer system scrolls (808) (shifts and/or navigates) the representation of content at a first rate (e.g., scroll rate 724 of FIGS. 7F, 7G, 7H) (e.g., velocity and/or pace) (in some embodiments, a rate that is not dependent on a rate (e.g., velocity and/or speed) of movement of the first input). In response to detecting the first set of one or more inputs (806) and in accordance with a determination that the first input includes a second magnitude of movement (e.g., 751d, 751r, and/or 751g) (e.g., distance of the movement and/or magnitude of rotation of the movement), different from the first magnitude of movement (e.g., the first and second magnitudes of movements include different distances and/or the first and second magnitudes of movements include different magnitudes of rotation), the computer system scrolls (810) the representation of content at a second rate (e.g., scroll rate 724 of FIGS. 7F, 7G, 7H) (e.g., velocity and/or pace) different from (e.g., faster and/or slower than) the first rate. In some embodiments, the scroll bar moves (or does not move) within the scroll track while scrolling at the first and/or second rate. In some embodiments, the computer system displays an animation of the content shifting as the representation of the content is scrolled at the first and/or second rate. In some embodiments, the rate of scrolling of the content is independent of the rate of movement of the first set of one or more inputs (e.g., for different rates of movement that have the same magnitude, the rate of scrolling of the representation of the content is the same). Conditionally scrolling the representation of content at a first rate or a second rate based on whether the first input includes a first magnitude of movement or a second magnitude of movement performs an operation when a set of conditions has been met without requiring any further input, improves how user interfaces are scrolled using various inputs, and improves how user interfaces are navigated using a rate-based scroll.

In some embodiments, after scrolling the representation of content at a respective rate (e.g., scroll rate 724 of FIGS. 7E1, 7E2, 7F, 7G, 7H) (e.g., the first rate or the second rate) and while continuing to detect the first input, the computer system (e.g., 700 and/or X700) detects that movement of the first input has ceased (e.g., movement of 750c has stopped in FIG. 7E1 and/or 7E2) (e.g., touch input, air gesture, gaze, and/or a mouse click). In some embodiments, a second portion of the first input is not maintained (a gaze input is not maintained) while the first portion of the first input is maintained. In some embodiments, the first input is maintained at a first position (e.g., a location of an input is maintained without detecting further movement of the first input). In response to detecting that movement of the first input has ceased, while the first input continues to be detected, the computer system continues to scroll the representation of content at the respective rate (e.g., FIG. 7E1 and/or FIG. 7E2) (e.g., scrolling further at the respective rate (in some embodiments, as long as the first input is maintained)). In some embodiments, detecting the first portion of the first input includes continuing to detect an air-pinch. Detecting that movement of the first input has ceased, while the first input continues to be detected, and, in response continuing to scroll the representation of content at the respective rate improves how user interfaces are scrolled using a set of one or more inputs.

In some embodiments, while continuing to scroll the representation of content at the respective rate, the computer system (e.g., 700 and/or X700) detects that the first input has ended (e.g., 750c has ended in 7I) (e.g., has ceased and/or been released). In some embodiments, detecting the end of the first input includes detecting a de-pinch gesture. in response to detecting that the first input has ended, the computer system ceases to scroll the representation of the content (e.g., scrolling rate continues to slow until content 708 stops scrolling, as depicted in FIG. 7J) (e.g., stopping to scrolling and/or gradually slowing the scrolling to a stop). In some embodiments, ceasing to scroll the representation of the content includes ceasing to scroll the representation of content at the respective rate and gradually decreasing the scroll rate over time. Detecting that the first input has ended while continuing to scroll the representation of content at the respective rate and, in response, ceasing to scroll the representation of content improves how user interfaces are scrolled in response to detecting various inputs and improves how user interfaces are navigated using a rate-based scroll.

In some embodiments, ceasing to scroll the representation of content includes gradually (e.g., over time) decreasing a rate at which the representation of the content is being scrolled until scrolling ceases (e.g., the rate of scrolling content 708 at FIG. 7I gradually decreases) (e.g., the representation of content is scrolled based on simulated inertia). In some embodiments, ceasing to scroll the representation of content at the first rate includes slowing the rate of scrolling over time until the representation of the content is no longer being scrolled. In some embodiments, scrolling ceases according to a physics-based model (e.g., simulated inertial movement with simulated friction). Gradually decreasing a rate at which the representation of the content is being scrolled until scrolling ceases improves how user interfaces are scrolled in response to detecting various inputs and improves how user interfaces are navigated using a rate-based scroll.

In some embodiments, after detecting that the movement of the first input has ceased and while the first input continues to be detected, the computer system (e.g., 700 and/or X700) detects additional movement of the first input (e.g., 751f) (e.g., a touch input and/or air gesture is maintained but moves). In response to detecting the additional movement of the first input, the computer system changes the respective rate of scrolling the representation of content (e.g., 708 is scrolled faster in FIG. 7G) (e.g., the representation of content is scrolled at a faster or slower rate). Detecting additional movement of the first input and, in response, changing the respective rate of scrolling the representation of content improves how user interfaces are scrolled in response to various inputs and improves how user interfaces are navigated using a rate-based scroll.

In some embodiments, before scrolling the representation of content at a second respective rate (e.g., the first rate or the second rate), the computer system (e.g., 700 and/or X700) detects, via the one or more input devices: a first portion (e.g., pinch and/or touch input of 750c) (e.g., a pinch and/or contact of touch input) of the first input at a first position (e.g., 736a) (e.g., an initial position of a pinch and/or an initial position of a touch input) (e.g., in a three-dimensional environment), and a second portion (e.g., movement 751d in FIG. 7D), after the first portion, of the first input that includes a respective magnitude of movement (e.g., the first magnitude of movement or the second magnitude of movement) away from the first position (e.g., movement 751d to 736b in FIG. 7D) (e.g., a pinch gesture is moved and/or the touch input is moved). In some embodiments, in response to detecting the second portion of the first input, the computer system begins to scroll the representation of content at the second respective rate (e.g., 724 of FIG. 7E1 and/or FIG. 7E2). In some embodiments, the respective rate increases (or decreases) as the respective magnitude of movement away from the first position increases (or decreases). Detecting a first portion of the first input at a first position and a second portion that includes a respective magnitude of movement away from the second position, and in response, begin scrolling the representation of content at a second respective rate improves how user interfaces are scrolled in response to various inputs and improves how user interfaces are navigated using a rate-based scroll.

In some embodiments, the representation of content is scrolled in a first direction (e.g., scrolling down in FIGS. 7D-7G) (e.g., up, down, left, and/or right). In some embodiments, a respective magnitude of movement (e.g., the first magnitude of movement or the second magnitude of movement) includes a first component (e.g., vertical distance 720) (e.g., movement in a respective direction) that is based on movement of the first input along an axis that is parallel to (e.g., in line and/or along) the first direction (e.g., vertical distance 720 is parallel to the direction of scrolling in FIGS. 7D-7G). In some embodiments, only movement of the first input along the axis parallel to the first direction is used to determine the first magnitude (e.g., movement that is not parallel to the axis is ignored). Scrolling the representation of content in a first direction and at a respective magnitude of movement that is based on movement of the first input along an axis that is parallel to the first direction improves how user interfaces are scrolled using a set of one or more inputs.

In some embodiments, the representation of content is scrolled in a second direction (e.g., scrolling down in FIGS. 7D-7G) (e.g., up, down, left, and/or right) (the same and/or different from the first direction). In some embodiments, a second respective magnitude of movement of the first input (e.g., the first magnitude of movement and/or the second magnitude of movement) includes (e.g., accounts for and/or is based at least in part on) a second component (e.g., 723 and/or 722) (e.g., movement in a respective direction) that is based on movement of the first input along an axis that is perpendicular (e.g., normal to and/or at a 90 degree angle of) to the second direction (e.g., the depth axis is perpendicular to scrolling down in FIGS. 7D-7G). Scrolling the representation of content based on a second component that is based on movement of the first input along an axis that is perpendicular to a direction that the representation of content is being scrolled improves how user interfaces are scrolled using a set of one or more inputs.

In some embodiments, the movement of the first input along the axis that is perpendicular to the second direction is movement of the first input along an axis (e.g., z-axis of 704) (e.g., along a z-axis and/or an axis that is perpendicular to a plane of the graphical user interface) that is parallel a depth direction that extends outward away from a viewpoint of a user of the computer system (e.g., z-axis of 704 is parallel a depth direction that extends outward away from viewpoint of a user of 701) (e.g., a direction of the user's head and/or along a line of sight of the user) of the computer system. In some embodiments, movement along the axis toward a point of view of a user is movement toward and/or away from the user. Detecting a magnitude of movement that includes movement along an axis that is parallel to a point of view of a user improves how user interfaces are scrolled using a set of one or more inputs having multi-dimensional movement components.

In some embodiments, the respective magnitude of movement is based on (e.g., is in accordance with) (e.g., at least in part) a rotation (e.g., 723 and/or 758) (e.g., angular movement) of a body part (e.g., 714) (e.g., finger, hand, arm, head, and/or foot) of the user of the computer system. Basing the respective magnitude of movement on a rotation of a body part of a user of the computer system improves how user interfaces are scrolled using a set of one or more inputs in a three-dimensional environment.

In some embodiments, the rotation of the body part includes a rotation (e.g., 723) of a wrist of the user (e.g., as depicted by rotation about 719 in FIG. 7A) (e.g., a bending of the wrist and/or the user's hand rotates with respect to the user's arm). Basing the respective magnitude of movement on a rotation of a user's wrist improves how user interfaces are scrolled using air gestures.

In some embodiments, the respective magnitude of movement is based on (e.g., accounts for, is a summation of, and/or is in accordance with a determination of) (e.g., at least in part) a movement of the first input (e.g., 751d) along an arc (e.g., 718) defined by the wrist of the user and one or more fingers of the user (e.g., 716) and a distance of movement (e.g., 720) of the first input (e.g., (e.g., in a respective direction) along an axis (e.g., y-axis of 704) that is parallel to the first direction of scrolling the content (e.g. content is scrolled up and down along the y-axis). Basing the respective magnitude of movement on movement along an arc defined by the wrist of the user and one or more fingers of the user and a distance of movement of the first input that is parallel to the first direction of scrolling the content improves how user interfaces are scrolled using air gestures.

In some embodiments, scrolling the representation of content at the first rate includes scrolling the representation of content in a same direction (e.g., 708 is scrolled down) (e.g., up, down, left, and/or right) as a direction of the first input (e.g., 751d is in a downward direction) (e.g., the representation of content is scrolled up if the first magnitude of movement is an upward movement). In some embodiments, scrolling the representation of content at the second rate includes scrolling the representation of content in a same direction (e.g., 708 is scrolled down) (e.g., up, down, left, and/or right) as a direction of the first input (e.g., 751d is in a downward direction). Scrolling the representation in a same direction as the first input improves how user interfaces are scrolled using user input.

In some embodiments, detecting the first set of one or more inputs includes detecting a gaze input (e.g., a gaze input directed at 730a and/or 732a and/or an area that is within a threshold distance of 730a and/or 732a) and a movement of an air gesture (e.g., 751d). In some embodiments, the gaze input is used when determining a location of the input. In some embodiments, a respective magnitude of movement is based on the magnitude of movement of the air gesture after making the air gesture. Detecting both a gaze input and a movement of an air gesture improves how user interfaces are scrolled using air gestures and improves the accuracy of when an air gesture is directed at a graphical object.

In some embodiments, the computer system (e.g., 700 and/or X700) detects, via the one or more input devices, a fourth input (e.g., 750a1) (e.g., an air gesture, a gaze, a touch input, and/or a mouse click or a combination thereof) directed to the representation of content (e.g., directly to the content rather than to the scrolling indicator). In response to detecting the fourth input and in accordance with a determination that the fourth input includes a first amount (e.g., rate and/or magnitude) of movement (e.g., 750al includes hand rate 726 of FIG. 7B), the computer system scrolls the representation of content at a first rate of scrolling that is based on the first amount of movement (e.g., scroll rate 724 of FIG. 7B is based on hand rate 726) (e.g., the content is scrolled at a rate that is based on the first amount of movement as opposed to a magnitude of movement). In response to detecting the fourth input and in accordance with a determination that the fourth input includes a second amount of movement (e.g., 750al includes a hand rate different from (e.g., faster or slower than) hand rate 726 of FIG. 7B), scrolling the representation of content at a second rate of scrolling that is based on the second amount of movement and that is different from the first rate of movement (e.g., the content is scrolled at a scroll rate that is faster or slower than scroll rate 724 of FIG. 7B). Detecting a fourth input directed to the representation of content and, in response, conditionally scrolling the representation of content at a rate that is based on the first amount of movement performs an operation when a set of conditions has been met without requiring further user input, provides additional control options without cluttering the user interface, and improves how user interfaces are scrolled.

In some embodiments, the first input is a first input type (e.g., 750c is an air gesture) (e.g., an air gesture, a gaze, a touch input, and/or a mouse click or a combination thereof) (in some embodiments, the first input type is detected via a first type of input device (e.g., a camera and/or a motion sensor)). In some embodiments, the computer system (e.g., 700 and/or X700) detects, via the one or more input devices, a fifth input (e.g., 750al and/or 750 ml is touch input detected via a trackpad and/or mouse) (e.g., an air gesture, a gaze, a touch input, and/or a mouse click or a combination thereof) of a second input type, different from the first input type (e.g., 750a1 and/or 750 ml are detected via a trackpad and 750c is detected via one or more cameras), directed to the representation of content. In some embodiments, the second input type is detected via second type of input device (e.g., a trackpad and/or a mouse) different from the first type of input device. In response to detecting the fifth input and in accordance with a determination that the fifth input includes a fifth rate of movement (e.g., 751a1), scrolling the representation of content at a rate of scrolling that is based on the fifth rate of movement of the input (e.g., scroll rate 724 is based on hand rate 726 in FIG. 7B) (e.g., the content is scrolled at a rate that is based on the fifth rate of movement as opposed to a magnitude of movement). In some embodiments, in accordance with a determination that the fifth input includes a respective rate of movement, different from the fifth rate of movement, scrolling the representation of content at a rate of scrolling that is based on the respective rate of movement of the input. Detecting a fifth input directed to the representation of content and, in response, conditionally scrolling the representation of content at a rate that is based on the fifth rate of movement performs an operation when a set of conditions has been met without requiring further user input, provides additional control options without cluttering the user interface, and improves how user interfaces are scrolled.

In some embodiments, prior to displaying the graphical user interface that includes the scrolling indicator, the computer system (e.g., 700 and/or X700) displays the graphical user interface including the representation of content without including the scrolling indicator (e.g., as depicted in FIG. 7A). While displaying the graphical user interface including the representation of content without including the scrolling indicator, the computer system detects a request (e.g., 750a1) (e.g., an air gesture, a gaze, a touch input, and/or a mouse click or a combination thereof) to scroll the representation of content. In some embodiments, the request to scroll the representation of content is based a user input (e.g., an air gesture or a gaze directed to an edge of the content). In response to detecting the request to scroll the representation of content, the computer system scrolls the representation of content (e.g., 708 is scrolled in FIG. 7B) and displays, via the display generation component, the scrolling indicator (e.g., scrollbar track 730a, scrollbar thumb 732a, scrollbar track 730b, and/or scrollbar thumb 732b are displayed in FIG. 7B). Detecting a request to scroll the representation of content of the user interface without the scrolling indicator and, in response, scrolling the representation of content and displaying the scrolling indicator declutters the user interface (e.g., by not including a scrolling indicator when it is not needed) and provides visual feedback that input was detected.

In some embodiments, detecting the first set of one or more inputs includes detecting a fifth portion (e.g., 750c) (e.g., a touch down and/or an air pinch) of the first input. In response to detecting the fifth portion of the first input, the computer system changes an appearance (e.g., size, shape, and/or color) of the scrolling indicator (e.g., a size and/or shape of scrollbar track 730a and/or scrollbar thumb 732a; and notches 738 are added in FIG. 7D) (e.g., a scrollbar track and/or a scrollbar thumb; in some embodiments a scrollbar thumb moves along the scrollbar track). Detecting a fifth portion of the first input and, in response, changing an appearance of a scrollbar track of the scrolling indicator provides visual feedback of a scrolling state of the computer system and provides visual feedback that an input was detected.

In some embodiments, changing the appearance includes adding (e.g., including and/or incorporating) a set of one or more graphical elements (e.g., notches 738 are added in FIG. 7D) (e.g., symbols, shapes, and/or colors) (e.g., notches and/or dots) to the scrolling indicator that scroll (e.g., shift and/or move) under (e.g., are hidden and/or obscured by) a moveable element (e.g., a scrollbar thumb and/or progress indicator) of the scrolling indicator that is moved when the representation of content is being scrolled (e.g., notches 738 move under scrollbar thumb 732a) (e.g., both the set of one or more graphical elements and the movable graphical element move along the scrollbar track when the content is being scrolled). In some embodiments, the set of one or more graphical elements scrolls in one direction and the movable graphical element moves in a different (e.g., opposite) direction. Including, as part of changing the appearance, a set of one or more graphical elements that scroll under a movable element of the scrolling indicator that moves when content is scrolled provides visual feedback of a scrolling state of the computer system and provides visual feedback that an input was detected.

In some embodiments, displaying the graphical user interface includes displaying the scrolling indicator (e.g., the scrollbar track, the scroll progress indicator, or a combination thereof) with a first appearance (e.g., the appearance of scrollbar track 730a and/or scrollbar thumb 732a in FIG. 7B) (e.g., size, shape, and/or color) while not detecting input directed to the scrolling indicator (e.g., no input is directed to scrollbar track 730a and/or scrollbar thumb 732a of FIG. 7B) (e.g., not scrolling and/or idle). In some embodiments, displaying the graphical user interface includes displaying the scrolling indicator with a second appearance (e.g., the appearance of scrollbar track 730a and/or scrollbar thumb 732a in FIG. 7C) (e.g., size, shape, and/or color), different from the first appearance, when a first hover input (e.g., 750b) (or, optionally, a first type of input) (e.g., a hover air gesture and/or a gaze input) (in some embodiments, a hover input directed to the scrolling indicator) is detected. In some embodiments, the first hover input includes an air gesture (e.g., flat hand, an air gesture that is different from an air pinch gesture, and/or a non-pinching gesture) and a gaze input (e.g., directed at the scrolling indicator). Displaying the scrolling indicator with a first appearance while not detecting input directed to the scrolling indicator and displaying the scrolling indicator with a second appearance, different from the first appearance, when a first hover input is detected provides visual feedback of a scrolling state of the computer system and provides visual feedback that a hover input was detected.

In some embodiments, prior to scrolling the representation of content at a respective rate (e.g., the first rate or the second rate) and while detecting a second hover input directed at the scrolling indicator, the scrolling indicator is displayed with a third appearance (e.g., the appearance of scrollbar track 730a and/or scrollbar thumb 732a in FIG. 7C) (the same as or different from the first appearance and/or the second appearance). While scrolling the representation of content at a respective rate in response to detecting the first set of one or more inputs, the scrolling indicator is displayed with a fourth appearance (e.g., the appearance of scrollbar track 730a and/or scrollbar thumb 732a in FIG. 7D), different from the third appearance. Displaying the scrolling indicator with a third appearance while a second hover input is detected and displaying the scrolling indicator with an appearance while scrolling the representation of content at a respective rate provides visual feedback of a scrolling state of the computer system and provides visual feedback that an input was detected.

In some embodiments, the computer system (e.g., 700 and/or X700) detects, via the one or more input devices, a first flick input (e.g., 750m2 is a flick input) (e.g., detecting a release of a gesture while the gesture is moving above a threshold amount of movement (e.g., 0.5 ft/second, 1 ft/second, and/or 2 ft/second)) (e.g., an air gesture, a touch input, and/or a mouse click or a combination thereof) directed to the representation of content and in a third direction (e.g., 750m2 is in an upward or downward direction) (e.g., up, down, left, and/or right). In response to detecting the first flick input, scrolling the representation of content by a predetermined amount (e.g., as described with respect to FIG. 7O) (e.g., that is independent of a rate of movement and/or a magnitude of movement of the flick input) (e.g., in the third direction or in a direction opposite the third direction). In some embodiments, a first flick input scrolls the representation of content by the same amount as a second flick input that is different from the flick input (e.g., each flick movement scrolls the representation of content by the same amount, even when the flicks have different characteristics). Detecting a first flick input directed to the representation of content and in a third direction and, in response, scroll the representation of content by a predetermined amount improves how content is scrolled in response to various inputs and provides visual feedback that an input was detected.

In some embodiments, the computer system (e.g., 700 and/or X700) detects, via the one or more input devices, a second flick input (e.g., 750m2 is an flick input) (e.g., detecting a release of a gesture while the gesture is moving above a threshold amount of movement (e.g., 0.5 ft/second, 1 ft/second, and/or 2 ft/second)) (e.g., an air gesture, a touch input, and/or a mouse click or a combination thereof) directed to the representation of content and in a fourth direction (e.g., 750m2 is in an upward or downward direction) that is different from (in some embodiments, opposite) the third direction (e.g., up, down, left, and/or right). In response to detecting the second flick input, the computer system scrolls the representation of content by the predetermined amount (e.g., as described with respect to FIG. 7O) (e.g., in the fourth direction or in a direction opposite the fourth direction). Detecting a second flick input directed to the representation of content and in a fourth direction that is different from the third direction and, in response, scroll the representation of content by the first amount improves how content is scrolled in response to various inputs and provides visual feedback that an input was detected.

In some embodiments, scrolling the representation of content at the first rate includes scrolling in a horizontal direction (e.g., 708 is scrolled in response to device 700 and/or X700 detecting 750c is directed at 732a and/or 730a and that there is subsequent horizontal movement of input 750c) (e.g., along an x-axis and/or along a first axis) and/or a vertical direction (e.g., 708 is scrolled in response to device 700 and/or X700 detecting 750c is directed at 732a and/or 730b and that there is subsequent horizontal movement of input 750c) (e.g., along a y-axis and/or along a second axis that is perpendicular to the first axis). In some embodiments, scrolling the representation of content at the second rate includes scrolling in the horizontal direction (e.g., 708 is scrolled left and/or right) (e.g., along an x-axis and/or along a first axis) and/or the vertical direction (e.g., 708 is scrolled up and/or down) (e.g., along a y-axis and/or along a second axis that is perpendicular to the first axis). In some embodiments, the computer system scrolls the representation of content in the horizontal direction or the vertical direction if the first input is directed to a horizontal scrolling indicator or if the first input is directed to a vertical scrolling indicator, respectively. In some embodiments, the computer system scrolls in the horizontal direction in response to detecting a horizontal movement of the first input (e.g., movement along a horizontal axis (e.g., x-axis) and/or rotation about the horizontal axis). In some embodiments, the computer system scrolls in the vertical direction in response to detecting a vertical movement of the first input (e.g., movement along a vertical axis (e.g., y-axis) and/or rotation about the vertical axis). Scrolling the representation of content at the first rate and the second rate in a horizontal direction and/or the vertical direction improves how user interfaces are scrolled in response to various inputs and improves how user interfaces are navigated using a rate-based scroll.

In some embodiments, the first input that includes the first magnitude of movement is an input of a first type (e.g., 750c is a pinch hand gesture and/or is detected via one or more cameras) (e.g., a pinch and hold gesture and/or a pinch gesture directed at the scrollbar thumb). In some embodiments, the first input that includes the second magnitude of movement is an input of the first type. In some embodiments, scrolling the representation of the content at the first rate or at the second rate corresponds to a first manner of scrolling (e.g., rate based scrolling described with respect to FIGS. 7E1-7G) (e.g., scrolling at a velocity that is based on the magnitude of the first input). In some embodiments, in response to detecting the first set of one or more inputs and in accordance with a determination that the first input is a fourth input type (e.g., 750c is a hand gesture that is different from the pinch gesture and/or is detected via a touch pad and/or mouse) (e.g., an air gesture different from a pinch gesture, a flick input, and/or an input at a region of the scroll indicator that does not include the scrollbar thumb (e.g., at a unoccupied region of the scroll track)), different from the first input type, scrolling the representation of content in a second manner (e.g., scrolling content 708 by a predefined amount as described with respect to FIGS. 7O-7P) (e.g., a bump scroll (e.g., scrolling by a predefined amount) or scrolling at a fixed velocity) that is different from the first manner. In some embodiments, in accordance with a determination that the first input is a respective input type (e.g., the first input type or an input type different from the first input type), different from the fourth input type, scrolling the representation the representation of content in a manner that is different from the second manner (e.g., the first manner or a manner different from the first manner) (or, optionally, forgoing scrolling in the second manner). In some embodiments, the second manner scrolls at a rate that is not based on the magnitude of movement of the first input. In some embodiments, the second manner scrolls to a target location based on location of the input along the scroll bar indicator. In some embodiments, the second manner is independent of the magnitude of movement. Conditionally scrolling the representation of content in a first manner or second manner based on a first input type or a fourth input type performs an operation when a set of conditions has been met without requiring any further input and improves how user interfaces are scrolled in response to various inputs.

In some embodiments, scrolling the representation of content at the first rate (and/or the second rate) includes providing a first type of non-visual feedback (e.g., 728e, X728e, and/or 728f) (e.g., an audio feedback and/or a haptic feedback) while scrolling the representation of content. In some embodiments, the computer system detects a request to scroll a representation of content via the scrolling indicator and, in response, provides the first non-visual feedback while scrolling the representation of content (e.g., scrolling the representation at the first rate and/or scrolling in a different manner (e.g., by selecting and moving a scroll progress indicator)). Providing a first type of non-visual feedback while scrolling the representation of content provides non-visual feedback that content is being scrolled using the scrolling indicator.

In some embodiments, scrolling the representation of content at the first rate (and/or the second rate) includes a first scrolling portion (e.g., beginning to scroll content 708 as described with respect to FIG. 7D) (e.g., a beginning portion of scrolling at the first rate and/or initiating the first rate scrolling) and second scrolling portion (e.g., an end portion of scrolling at the first rate and/or terminating the first rate scrolling) that corresponds to an end (e.g., release) of the first input (e.g., input 750c has ended in FIG. 7I and/or content 708 has continued to scroll after input 750c has ended) (in some embodiments, the computer system still scrolls the representation of content after the release of the first input based on a simulated inertia), including providing a second type of non-visual feedback (e.g., 728d) (e.g., an audio feedback and/or a haptic feedback) (e.g., the same as or different from the first type of non-visual feedback) during (e.g., at) the first portion of scrolling and providing a third type of non-visual feedback (e.g., 728i) (e.g., the same as or different from the first non-visual feedback), different from the second type of non-visual feedback, during (e.g., at) the second portion of scrolling. In some embodiments, the computer system detects a request to scroll a representation of content via the scrolling indicator and, in response, provides the second non-visual feedback at the start of scrolling the representation of content using the scrolling indicator (e.g., scrolling the representation at the first rate and/or scrolling in a different manner (e.g., by selecting and moving a scroll progress indicator)) and provides the third non-visual feedback at the end of scrolling the representation of content using the scrolling indicator (e.g., by releasing the scroll progress indicator). Providing a second type non-visual feedback at a first portion of scrolling at the first rate and providing a third type of non-visual feedback, different from the second non-visual feedback, at the second portion of scrolling that corresponds to an end of the first input provides non-visual feedback that content is beginning to be or released from being scrolled at the first rate.

In some embodiments, the computer system (e.g., 700 and/or X700) detects a request to scroll the representation of content that includes a sixth input (e.g., 750a1) (e.g., an air gesture, a gaze, a touch input, and/or a mouse click) directed at the representation of content. In response to detecting the request to scroll the representation of content that includes the sixth input directed at the representation of content, the computer system provides a fourth type of non-visual feedback (e.g., 728a), different from the first type of non-visual feedback, while scrolling the representation of content (e.g., at a rate that is based on a rate of movement of the input (e.g., as opposed to a rate that is based on a magnitude of movement)). Detecting a request to scroll the representation of content that includes a sixth input directed at the representation of content and, in response, providing a fourth type of non-visual feedback, different from the first non-visual feedback, while scrolling the representation of content provides visual feedback regarding how content is being scrolled and improves how content is scrolled using various inputs at different portions of a user interface.

In some embodiments, the computer system (e.g., 700 and/or X700) displays the graphical user interface including the representation of content and the scrolling indicator. While displaying the graphical user interface including the representation of content and the scrolling indicator, the computer system detects, via the one or more input devices, a request to scroll the representation of content (e.g., 750a and/or 750c) (e.g., an air gesture, a gaze, a touch input, and/or a mouse click). In response to detecting the request to scroll the representation of content and in accordance with a determination that the request to scroll the representation of content includes an input (e.g., 750c and/or 751d) directed to a scrolling indicator (e.g., 730 and/or 732) (e.g., the request is scroll the content in a manner using the scrolling indicator; in some embodiments, scrolling the representation of content using an input directed to the scrolling indicator includes scrolling the representation at a rate that is based on a magnitude of movement), the computer system provides a first type of non-visual feedback (e.g., 728d, 728e, and/or X728e) (e.g., an audio feedback and/or a haptic feedback) (e.g., a first frequency, a first duration, and/or a first waveform of non-visual feedback) while scrolling the representation of content. In response to detecting the request to scroll the representation of content and in accordance with a determination that the request to scroll the representation of content includes an input (e.g., 750a1) directed to the representation of content (e.g., 708), the computer system provides a second type non-visual feedback (e.g., 728a) (e.g., an audio feedback and/or a haptic feedback) (e.g., a second frequency, a second duration, and/or a second waveform of non-visual feedback), different from the first type non-visual feedback, while scrolling the representation of content (e.g., scrolling the content by a rate that is based by the rate of movement (e.g., as opposed to the magnitude of movement)). Detecting a request to scroll the representation of content and, in response, conditionally providing a first type of non-visual feedback or providing a second type non-visual feedback, different from the first type, while scrolling the representation of content performs an operation when a set of conditions has been met without requiring any further input and improves how user interfaces are scrolled using various inputs.

In some embodiments, the computer system (e.g., 700 and/or X700) detects a request to select a selectable user interface object (e.g., scrollbar track 730a, scrollbar thumb 732a, and/or menu affordance 742 as described with respect to FIG. 7C) (e.g., an object in the graphical user interface, a scrolling indicator, a text entry field, and/or a button). In response to detecting the request to select the selectable user interface object, providing a respective type of non-visual feedback (e.g., selecting scrollbar track 730a, scrollbar thumb 732a, and/or menu affordance 742 results in non-visual feedback as described with respect to FIG. 7C) (e.g., a respective type of audio feedback and/or a respective type of haptic feedback). In some embodiments, respective type of non-visual feedback includes a first amplitude, a first frequency, a first duration, and/or a first waveform of non-visual feedback. Detecting a request to select a selectable user interface object and, in response, providing a respective type of non-visual feedback provides non-visual feedback that an input was detected.

In some embodiments, providing the respective type of non-visual feedback is based on a non-visual feedback setting, including in accordance with a determination that the object being selected as the selectable user interface object has a designated (e.g., assigned and/or specified) type of non-visual feedback, the respective non-visual feedback is the designated type of non-visual feedback (e.g., if scrollbar track 730a, scrollbar thumb 732a, and/or menu affordance 742 has an assigned non-visual feedback then device 700 and/or HMD X700 provides the assigned non-visual feedback, as described with respect to FIG. 7C). In some embodiments, the designated type of non-visual feedback is an audio feedback and/or a haptic feedback. In accordance with a determination that the object being selected as the selectable user interface object does not have a designated type of non-visual feedback (e.g., the selectable interface object does not have an assigned and/or specific type of non-visual feedback), the respective type of non-visual feedback is a default type of non-visual feedback (e.g., if scrollbar track 730a, scrollbar thumb 732a, and/or menu affordance 742 does not have an assigned non-visual feedback, then device 700 and/or HMD X700 provides a default non-visual feedback, as described with respect to FIG. 7C). In some embodiments, the default type of non-visual feedback is an audio feedback and/or a haptic feedback. In some embodiments, the designated type of non-visual feedback includes an amplitude, frequency, duration, and/or waveform that is different from an amplitude, frequency, duration, and/or waveform of the default type of non-visual feedback. Conditionally providing a designated type of non-visual feedback or a default non-visual feedback based on whether the selectable user interface object has a designated type of non-visual feedback performs an operation when a set of conditions has been met without requiring any further input and provides non-visual feedback that an input was detected.

In some embodiments, while displaying the graphical user interface (e.g., 706) that includes the representation of content (e.g., 708) and the scrolling indicator (e.g., 730a and/or 732a): the computer system detects, via the one or more input devices, a second set of one or more inputs (e.g., an air gesture, a gaze, a touch input, and/or a mouse click or a combination thereof) (e.g., Y708B and/or Y12B) that includes a first respective input (e.g., Y708B) directed at the scrolling indicator (in some embodiments, within a threshold distance from the scrolling indicator). In response to detecting the second set of one or more inputs (in some embodiments, and while continuing to detect an input (e.g., a component and/or portion) of the second set of one or more inputs (e.g., the computer system continues to detect the air gesture, contact of the touch input (e.g., touch-and-hold input), and/or the mouse selection)): in accordance with a determination that the first respective input (e.g., an air gesture, a gaze, a touch input, and/or a mouse click) includes a first amount of movement (e.g., distance and or magnitude of movement) (e.g., Y712B), the computer system scrolls (shifting and/or navigating) the representation of content by a first amount (e.g., amount, distance, and/or units (e.g., lines or characters) of content scrolling) (in some embodiments, the first amount is proportional to the first amount of movement) (e.g., 30 lines, as shown in FIG. 7AB); and in accordance with a determination that the first respective input includes a second amount of movement, different from the first amount of movement, the computer system scrolls the representation of content by a second amount (e.g., 15 lines, as discussed with reference to FIG. 7AB for an input with half the movement of Y712B), different from (e.g., lesser than or greater than) the first amount. In some embodiments, scrolling the representation of the content at a velocity that is based on a velocity of movement of the first respective input. In some embodiments, while displaying the graphical user interface that includes the representation of content the scrolling indicator: detecting, via the one or more input devices, a third set of one or more inputs (e.g., an air gesture, a gaze, a touch input, and/or a mouse click or a combination thereof) that includes a respective input directed at the scrolling indicator (in some embodiments, within a threshold distance from the scrolling indicator). In response to detecting the third set of one or more inputs (in some embodiments, and while continuing to detect an input (e.g., a component and/or portion) of the third set of one or more inputs (e.g., the computer system continues to detect the air gesture, contact of the touch input (e.g., touch-and-hold input), and/or the mouse selection)): in accordance with a determination that the respective input (e.g., an air gesture, a gaze, a touch input, and/or a mouse click) is an input of a first type (e.g., an input that is received while the computer system is in a first input mode (e.g., a cursor-based input mode; an amount-based and/or magnitude-based input mode) and a determination that the respective input includes a first amount of movement (e.g., distance and or magnitude of movement), scrolling (shifting and/or navigating) the representation of content by a first amount (e.g., amount, distance, and/or units (e.g., lines or characters) of content scrolling) (in some embodiments, the first amount is proportional to the first amount of movement); in accordance with a determination that the respective input is an input of the first type and a determination that the respective input includes a second amount of movement, different from the first amount of movement, scrolling the representation of content by a second amount, different from (e.g., lesser than or greater than) the first amount; in accordance with a determination that the respective input (e.g., an air gesture, a gaze, a touch input, and/or a mouse click) is an input of a second type (e.g., a non-cursor-based input mode; a velocity-based input mode), different from the first type and a determination that the respective input includes a first magnitude of movement (e.g., distance of the movement and/or magnitude of rotation of the movement), scrolling (shifting and/or navigating) the representation of content at a first rate (e.g., velocity and/or pace) (in some embodiments, a rate that is not dependent on a rate (e.g., velocity and/or speed) of movement of the first input); and in accordance with a determination that the respective input is an input of the second type and a determination that the respective input includes a second magnitude of movement, scrolling the representation of content at a second rate different from the first rate. Conditionally scrolling the representation of content by a first amount or a second amount based on whether the first input includes a first amount of movement or a second amount of movement performs an operation when a set of conditions has been met without requiring any further input, improves how user interfaces are scrolled using various inputs, improves how user interfaces are navigated using a rate-based scroll, and provides the user with additional control options, without further cluttering the user interface.

In some embodiments, displaying the graphical user interface includes displaying a cursor (e.g., Y710) (a graphical indication of a position and/or location in the user interface that will respond to input (e.g., that is currently in focus)); and detecting the second set of one or more inputs includes detecting an air gesture (e.g., as discussed with reference to an embodiment of 712B) that includes movement of at least a portion of a hand of a user of the computer system (e.g., detecting via a camera, and/or an accelerometer). In such embodiments, in response to detecting the second set of one or more inputs, the computer system moves a position of the cursor based on the detected movement of the at least a portion of the hand of the user of the computer system (e.g., as discussed with reference to FIGS. 7AA-7AB). In some embodiments, the graphical user interface includes a cursor that is controlled by movements of a hand of the user. Displaying a cursor that is controlled by a hand of the user provides the user with additional control options, without further cluttering the user interface.

In some embodiments, the one or more input devices includes a touch-sensitive surface (e.g., Y702) (e.g., a surface integrated into the computer system or in communication (e.g., wireless communication) with the computer system or separate from the computer system, such as a touchpad, and/or a trackpad); displaying the graphical user interface includes displaying a cursor (e.g., Y710) (a graphical indication of a position and/or location in the user interface that will respond to input (e.g., that is currently in focus)) (in some embodiments, the second cursor and the first cursor are the same); and detecting the second set of one or more inputs includes detecting, via the touch-sensitive surface, movement of a contact (e.g., 712B) (e.g., a contact of a finger and/or a contact of a stylus or pen input device). In such embodiments, in response to detecting the second set of one or more inputs, the computer system moves a position of the cursor based on the detected movement of the contact (e.g., as seen in FIGS. 7Y to 7Z and FIGS. 7AA to 7AB). In some embodiments, the graphical user interface includes a cursor that is controlled via a touchpad and/or a trackpad. Displaying a cursor that is controlled by a hand of the user provides the user with additional control options, without further cluttering the user interface.

In some embodiments, detecting the first set of one or more inputs includes detecting a sixth portion (e.g., a touch down and/or an air pinch) of the first input. In such methods, in response to detecting the sixth portion of the first input (e.g., 750c as shown in FIGS. 7C-7D), changing an appearance (e.g., size, shape, and/or color) of the scrolling indicator (e.g., 730a) (e.g., a scrollbar track and/or a scrollbar thumb; in some embodiments, a scrollbar thumb moves along the scrollbar track) in a first manner (e.g., adding notches 738 as shown in FIG. 7D) (e.g., by adding a set of one or more graphical elements (e.g., symbols, shapes, and/or colors) (e.g., notches and/or dots) to the scrolling indicator that scroll (e.g., shift and/or move) under (e.g., are hidden and/or obscured by) a moveable element (e.g., a scrollbar thumb and/or progress indicator) of the scrolling indicator that is moved when the representation of content is being scrolled); and in response to detecting the second set of one or more inputs, forgoing changing the appearance of the scrolling indicator in the first manner (e.g., as seen in FIGS. 7AA and 7AB) (e.g., forgoing adding a set of one or more graphical elements (e.g., symbols, shapes, and/or colors) (e.g., notches and/or dots) to the scrolling indicator that scroll (e.g., shift and/or move) under (e.g., are hidden and/or obscured by) a moveable element (e.g., a scrollbar thumb and/or progress indicator) of the scrolling indicator that is moved when the representation of content is being scrolled). Changing the appearance of scrolling indicator in the first manner when scrolling in response to the first set of one or more inputs and forgoing changing the appearance of scrolling indicator in the first manner when scrolling in response to the second set of one or more inputs provides the user with improved visual feedback as the manner of scrolling (e.g., velocity-based scrolling or amount-based scrolling).

In some embodiments, while displaying the graphical user interface (e.g., 706) that includes the representation of content and the scrolling indicator: the computer system detects, via the one or more input devices, a third set of one or more inputs (e.g., Y708C) (e.g., an air gesture, a gaze, a touch input, and/or a mouse click or a combination thereof) that includes a second respective input (e.g., Y708C) directed at the scrolling indicator (e.g., 730a) (in some embodiments, within a threshold distance from the scrolling indicator); and in response to detecting the third set of one or more inputs: in accordance with a determination that the second respective input is directed to a first portion of the scrolling indicator (e.g., portion demarked by Y714B) (a predetermined portion (e.g., an upper portion (e.g., the upper or lower 5%, 10%, 25%, or 50% of the scrolling indicator)), the computer system navigates (in some embodiments, scrolling) to a first predetermined position (e.g., a lower end of content 708) within the representation of the content (e.g., the beginning, top, and/or start or the end, bottom, and/or terminus of the representation of the content). In some embodiments, in accordance with a determination that the second respective input is directed to a second portion of the scrolling indicator, different from the first portion, navigating (in some embodiments, scrolling) to a second predetermined position within the representation of the content. Navigating to a predetermined position within the representation of the content in response to the third set of one or more inputs provides the user with additional control (e.g., navigation) options, without further cluttering the user interface.

In some embodiments, the second respective input is a stationary input (e.g., Y708C) (e.g., a long press or click, multiple tap such as a double tap or double click, long air pinch, or multiple pinch such as a double pinch). In some embodiments, an input that has less than a predetermined threshold amount of movement.

In some embodiments, the first predetermined position within the representation of the content is at a first end of the representation of the content (e.g., the portion of 730a demarked by 714A and/or 714B) (e.g., a beginning, an end, a top, a bottom, and/or a terminus). In some embodiments, the content is a portion (e.g., a predetermined, preloaded portion) of a larger set of content; for example, when the content is items 1-100 that is preloaded from a larger set of 1000 items. In such embodiments, additional portions of the larger set of content can be loaded as the representation is scrolled (e.g., when reaching an end of the content or other predetermined portion of the content). In such embodiments, the first end of the representation of the content can be a first end of a currently loaded portion of the content, rather than necessarily an end of the larger set of total content. In such embodiments, after navigating to the predetermined position that is the first end of the currently loaded portion of the content, a further set of inputs, similar to the third set of one or inputs can be provided after additional portions of the content have been loaded; alternatively, other methods of scrolling (e.g., velocity-based or amount-based scrolling) can be employed to navigate through the additional portions of content, after it is loaded. Navigating to a first end of the representation of the content in response to the third set of one or more inputs provides the user with additional control (e.g., navigation) options for rapidly navigating to an end of the content, without further cluttering the user interface.

In some embodiments, in response to detecting the third set of one or more inputs and in accordance with a determination that the second respective input (e.g., Y708D) is directed to a second portion of the scrolling indicator (e.g., the portion demarked by 714A), different from the first portion, the computer system navigates (in some embodiments, scrolling) to a second predetermined position within the representation of the content (e.g., a beginning or upper end, as shown in FIG. 7AF). Navigating to different predetermined portions of the content depending on whether the second respective input corresponds to a first or second portion of the scrolling indicator provides the user with additional control (e.g., navigation) options for rapidly navigating to different portions of the content, without further cluttering the user interface.

In some embodiments, aspects/operations of methods 800 and 900 may be interchanged, substituted, and/or added between these methods. For example, method 900 includes features of method 800 for scrolling content using a rate-based scroll. Method 900 also optionally includes features of method 800 for scrolling content for generating non-visual haptic feedback. For brevity, these details are not repeated here.

FIG. 9 is a flow diagram of an exemplary method 900 for changing an appearance of a scroll bar. The user interfaces in FIGS. 7A-7AF are used to illustrate the processes described below, including the processes in FIG. 9.

FIG. 9 is a flow diagram of an exemplary method 900 for scrolling content, in some embodiments. In some embodiments, method 900 is performed at a computer system (e.g., 700 and/or X700) (e.g., computer system 101 in FIG. 1A) (e.g., a smartphone, a tablet computer, a laptop computer, a desktop computer, and/or a head mounted device (e.g., a head mounted augmented reality and/or extended reality device)) including a display generation component (e.g., 701 and/or X701) (e.g., display generation component 120 in FIGS. 1A, 3, and 4) (e.g., a display controller, a touch-sensitive display system, a monitor, and/or a head mounted display system) (e.g., a heads-up display, a display, a touchscreen, a projector, etc.), one or more input devices (e.g., 701, X701, 703, X703, and/or 705) (e.g., one or more cameras, a touch-sensitive surface, a keyboard, integrated and/or connected motion sensors, a controller, and/or a mouse) (in some embodiments, the computer system in communication with one or more cameras (e.g., an infrared camera, a depth camera, and/or a visible light camera)), and, optionally, one or more cameras (e.g., a camera (e.g., color sensors, infrared sensors, and other depth-sensing cameras) that points downward at a user's hand or a camera that points forward from the user's head). In some embodiments, method 900 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 900 are, optionally, combined and/or the order of some operations is, optionally, changed.

The computer system (e.g., 700 and/or X700) displays (902), via the display generation component (e.g., 701 and/or X701), a user interface (e.g., 710). The user interface includes (904) a representation of a first portion of scrollable content (e.g., a portion of 708) (e.g., text, images, selectable interface objects, and/or text entry fields) (in some embodiments, the graphical user interface includes a representation of an application and/or a representation of a three-dimensional environment). The user interface includes (906) a scrolling indicator (e.g., 730a, 732a, 730b, and/or 732b) (e.g., a graphical object for controlling a scrolling function and/or graphical element for scrolling scrollable content) that includes a scroll progress indicator (e.g., 732a and/or 732b) (e.g., a scroll thumb and/or scroll bar graphical object) and a scrolling region (e.g., 730a and/or 730b) (e.g., a track and/or trough of the scroll progress indicator) that has a first visual characteristic (e.g., the size and shape of 730a, 732a, 730b, and/or 732b in FIG. 7Q) (e.g., size, shape, and/or color) (in some embodiments, a visual characteristic that is independent of the position of the scroll progress indicator relative to the scrolling region). In some embodiments, the scroll progress indicator has a first scroll progress indicator visual characteristic of a first scroll progress indicator state. The scroll progress indicator moves (e.g., changes positions and/or slides) within the scrolling region while the scrollable content is being scrolled (e.g., 732a and/or 732b move while 708 is being scrolled). While scrolling through the scrollable content based on a user input (e.g., 750j and/or 750t) (e.g., in response to a user input requesting scrolling, such as a drag input, an air pinch and drag input, or other content navigation input described in greater detail with respect to FIG. 8 and FIG. 9) and while the first visual characteristic of the scrolling region has a first state (e.g., the size and shape of 730a, 732a, 730b, and/or 732b in FIG. 7Q) (e.g., a first value (e.g., a first size, shape, and/or color)), the computer system detects (908) that an end (e.g., a terminus and/or an edge) (in some embodiments, the scrollable content has two ends (e.g., a first end in one direction of scrolling and a second end in the other direction of scrolling) (e.g., top and bottom end and/or left and right end)) of the scrollable content has been reached (e.g., as described and depicted in FIGS. 7J-7L, and/or 7R1-7V). In response to detecting that the end of the scrollable content has been reached, the computer system changes (910) the first visual characteristic of the scrolling region from the first state to a second state (e.g., the size and shape of 730a, 732a, 730b, and/or 732b changes, as described and depicted in FIGS. 7J-7L, and/or 7R1-7V) (e.g., a set of states and/or a plurality of states), different from the first state (e.g., the scrolling region changes size, color, and/or shape). In some embodiments, while maintaining the scroll progress indicator with the same appearance (e.g., forgoing modifying a visual characteristic of the scroll progress indicator). In some embodiments, in response to detecting that the end of the scrollable content has been reached, the computer system changes the first scroll progress indicator visual characteristic to a second scroll progress indicator visual characteristic different from the first scroll progress indicator visual characteristic (e.g., the appearances of both the scroll progress indicator and the scrolling region change). In some embodiments, in response to detecting that the end of the scrollable content has been reached, the computer system ceases to display the scroll progress indicator. In some embodiments, in response detecting that the end of the scrollable content has been reached (e.g., and while the first visual characteristic is in the second state), the computer system displays a visual indication (e.g., shifting animation, a bounce-back animation, a rubberband-effect animation of the scrollable content) that the scrollable content is at the end. In response detecting that the end of the scrollable content has been reached (e.g., and while the first visual characteristic of the scrolling region is in the second state), the computer system shifts (in some embodiments, does not shift) the scrollable content further from an edge of the graphical user interface. Detecting that an end of the scrollable content has been reached while scrolling through the scrollable content and while the first visual characteristic of the scrolling region has a first state and, in response, changing the first visual characteristic of the scrolling region from the first state to a second state, different from the first state, provides visual feedback that an end of the content has been reached.

In some embodiments, changing the first visual characteristic of the scrolling region from the first state to the second state includes elongating the scrolling region (e.g., the size and shape of 730a and/or 730b is stretched) (e.g., along an axis that is parallel to a direction that the content is being scrolled). In some embodiments, elongating the scrolling region includes changing the scrolling region from a first length to a second length that is longer than the first length. Changing the first visual characteristic of the scrolling region by elongating the scrolling region provides visual feedback that an end of the content has been reached.

In some embodiments, changing the first visual characteristic of the scrolling region from the first state to the second state includes reducing a width of the scrolling region (e.g., the width of 730a and/or 730b is reduced) (e.g., along an axis that is perpendicular to a direction that the content is being scrolled). In some embodiments, reducing the width the scrolling region includes changing the scrolling region from a first width to a second width that is shorter than the first width. Changing the first visual characteristic of the scrolling region by reducing the width of the scrolling region provides visual feedback that an end of the content has been reached.

In some embodiments, changing the first visual characteristic of the scrolling region from the first state to the second state includes visually changing the scrolling region by a respective amount (e.g., the size and shape of 730a and/or 730b changes by a respective amount) (in some embodiments, a magnitude) of change, including in accordance with a determination that there is a first magnitude of scrolling (e.g., 751r, 751s, 751t, and/or 751u) (e.g., a magnitude of an input that corresponds to scrolling the content), the respective amount of change is a first amount (e.g., the size and shape of 730a and/or 730b changes based on the input as described and depicted in FIGS. 7J-7L, and/or 7R1-7V) and in accordance with a determination that there is a second magnitude of scrolling (e.g., 751r, 751s, 751t, and/or 751u), different from the first magnitude of scrolling, the respective amount of change is a second amount that is different from the second amount (e.g., the size and shape of 730a and/or 730b changes based on the input as described and depicted in FIGS. 7J-7L, and/or 7R1-7V). Conditionally changing the first visual characteristic of the scrolling region based a magnitude of scrolling performs an operation when a set of conditions has been met without requiring any further input.

In some embodiments, changing the first visual characteristic of the scrolling region from the first state to the second state includes changing a size and/or a shape of the scrolling region by a respective amount of change in size and/or shape (e.g., the size and shape of 730a and/or 730b changes based on the input as described and depicted in FIGS. 7J-7L, and/or 7R1-7V), including in accordance with a determination that the scrollable content has scrolled past the end of the scrollable content by a first amount (e.g., the size and shape of 730a and/or 730b changes based on how far device 700 and/or HMD X700 scrolls past content 708 as described and depicted in FIGS. 7J-7L, and/or 7R1-7V) (e.g., the scrollable content has shifted away from an edge of the document and/or user interface by a first amount), the respective amount of change in size and/or shape is a first amount of change and in accordance with a determination that the scrollable content has scrolled past the end of the scrollable content by a second amount (e.g., the size and shape of 730a and/or 730b changes based on how far device 700 and/or HMD X700 scrolls past content 708 as described and depicted in FIGS. 7J-7L, and/or 7R1-7V) (e.g., the scrollable content has shifted away from an edge of the document and/or user interface by a second amount), different from the first amount, the respective amount of change in size and/or shape is a second amount of change that is different from the second amount of change (e.g., the size and shape of 730a and/or 730b changes as described and depicted in FIGS. 7J-7L, and/or 7R1-7V). Conditionally changing size and/or shape of the scrolling region based an amount that the scrollable content has scrolled past the end of the scrollable content performs an operation when a set of conditions has been met without requiring any further input.

In some embodiments, the change of the first visual characteristic of the scrolling region includes in accordance with a determination that the end is a first end (e.g., top end of content 708, bottom end of content 708, right end of content 708, and/or left end of content 708) (e.g., top, bottom, left, and/or right) of the scrollable content, changing the first visual characteristic of the scrolling region in a first manner (e.g., the size and shape of 730a and/or 730b changes as described and depicted in FIGS. 7J-7L, and/or 7R1-7V) (e.g., size, shape, and/or color). In some embodiments, the change of the first visual characteristic of the scrolling region includes in accordance with a determination that the end is a second end (e.g., top end of content 708, bottom end of content 708, right end of content 708, and/or left end of content 708) (e.g., top, bottom, left, and/or right), different from the first end, changing the first visual characteristic of the scrolling region in the first manner (e.g., the first visual characteristic is changed in the same manner for two different ends). In some embodiments, the second end is opposite the first end. Changing the first visual characteristic of the scrolling region in the same manner when reaching a first end and when reaching a second end provides visual feedback that an end of the content has been reached.

In some embodiments, the computer system (e.g., 700 and/or X700) scrolls the scrollable content beyond the end of the scrollable content in response to detecting a first portion of the user input (e.g., scrolling past the end of content 708 in response to the input described and depicted in FIGS. 7J-7L, and/or 7R1-7V). After scrolling the scrollable beyond the end of the scrollable content, the computer system displays, via the display generation component (e.g., 701 and/or X701), an area (e.g., 748) beyond the end of the scrollable content (e.g., the scrollable content has been scrolled further from an edge of the user interface and/or the area does not include any content based scrolling beyond the end of the scrollable content). After scrolling the scrollable content beyond (e.g., past and/or further than) the end (e.g., in a first direction) and after displaying the area beyond the end of the scrollable content, the computer system scrolls (e.g., shifting and/or moving) the scrollable content back to the end of the scrollable content (e.g., scrolling back to the end of content 708 as described and depicted in FIGS. 7M, 7T, 7W) (e.g., by scrolling the scrollable content in a second direction opposite the first direction) (e.g., and, optionally, ceasing to display the area beyond the end of the scrollable content). In some embodiments, the scrollable content snaps (e.g., rubber bands) back to the end. In some embodiments, the scrollable content snaps back in response to detecting a response to the end of an input that caused the scrolling through of the content to occur. In some embodiments, ceasing to display the area beyond the end of the content. Scrolling the scrollable content back to the end of the scrollable content after the scrollable content has been scrolled beyond the end and after an area beyond the scrollable content is displayed reduces the number of inputs to scroll the content.

In some embodiments, the scrollable content is scrolled back to the end of the scrollable content in response to detecting an end of the input (e.g., scrolling back to the end of content 708 in response to an input as described and depicted in FIGS. 7M, 7T, and/or 7W) (e.g., a removal of a touch input, a release of an air gesture, and/or a release of a mouse click). Scrolling the scrollable content back to the end in response to detect an end of an input provides visual feedback that an end of an input has been detected.

In some embodiments, the scrollable content is scrolled back to the end of the scrollable content before detecting an end of the user input (e.g., scrolling back to the end of content 708 before an input has ended as described and depicted in FIGS. 7M, 7T, and/or 7W) (e.g., in response to reaching the end of a document, even if the input is maintained). Scrolling the scrollable content back to the end before detecting an end of an input automatically performs an action without requiring the user provide end the input.

In some embodiments, the computer system (e.g., 700 and/or X700) scrolls through the scrollable content includes scrolling at least a portion of the content at a respective rate (e.g., scroll rate 724) based on the user input. While scrolling the content at the respective rate, the computer system detects that the user input has ended (e.g., 750c has ended in FIG. 7I). In response to detecting that the user input has ended, the computer system scrolls the content with a simulated inertia (e.g., the rate of scrolling content 708 gradually slows down) (e.g., according to a physics-based model (e.g., inertial movement with friction)). Moving the scrollable content with a simulated inertia after an input improves how content is scrolled in user interfaces and reduces the number of user inputs.

In some embodiments, scrolling the content with a simulated inertia includes scrolling the content by a magnitude of scrolling (e.g., scroll rate 724) (e.g., scrolling the content by an amount) that is based on a rate of scrolling at a time that the user input ended (e.g., the rate of scrolling content 708 of FIG. 7I is based on the scroll rate 724 at the point in time that input 750c has ended in FIG. 7I) (e.g., once the user input ends, scrolling the content continues for a distance that is based on applying an inertial movement model to the velocity of scrolling at the time the input ended). Scrolling the content by a magnitude of scrolling that is based on a rate of scrolling at the time that the input ended improves how content is scrolled in user interfaces and reduces the number of user inputs.

In some embodiments, the rate of scrolling at the time that the user input ended is based on (e.g., is dependent on and/or is in accordance with a determination of) a movement (e.g., 751d, 751f, and/or 751g) (e.g., a rate of movement and/or magnitude of movement) of the user input while the user input is directed to the scrolling indicator (e.g., the rate of scrolling content 708 of FIG. 7I is based on the scroll rate 724 at the point in time that input 750c has ended in FIG. 7I) (and/or scrolling region). In some embodiments, the respective rate of scrolling is based on a magnitude of movement of the input while the input is directed to the progress indicator and/or the scrolling region (e.g., as described in greater detail with respect to FIGS. 7A-7AF and 8). Basing the rate of scrolling at the time that the respective input ended on a movement of the respective input while the respective input is directed to the scrolling indicator improves how content is scrolled in user interfaces and reduces the number of user inputs.

In some embodiments, while scrolling through the scrollable content, the computer system displays a set of one or more graphical elements (e.g., 738) (e.g., symbols, shapes, and/or colors) (e.g., notches and/or dots) moving in the scrolling region and under the scroll progress indicator (e.g., 738 move under 302a and/or 302b) (e.g., a graphical element is hidden from view by the scroll progress indicator as the graphical element moves along the scrolling region). Displaying a set of one or more graphical elements moving in the scrolling region and under the scroll progress indicator as the scrollable content is being scrolled provides visual feedback of the scrolling state and provides visual feedback that the content is being scrolled.

In some embodiments, the set of one or more graphical elements (e.g., symbols, shapes, and/or colors) (e.g., notches and/or dots) fade (e.g., 728 are x's or dots in 740b in FIG. 7D) (e.g., an opacity value is reduced and/or transparency is increased) at (e.g., within a threshold distance (e.g., 50 pixels, 100 pixels, 1 inch, and/or 2 inches) from) an end portion (e.g., 740b) (e.g., edge portion and/or side portion) (e.g., a top end, a bottom end, a right end, and/or a left end) of the scrolling region. Fading the set of one or more graphical elements at an end portion of the scrolling region provides visual feedback of the scrolling state and provides visual feedback that the content is being scrolled.

In some embodiments, the set of one or more graphical elements (e.g., symbols, shapes, and/or colors) (e.g., notches and/or dots) are not faded (e.g., 728 are lines in 740a) (e.g., an opacity value is reduced and/or transparency to disappear) at (e.g., within a threshold distance (e.g., 50 pixels, 100 pixels, 1 inch, and/or 2 inches) from) a center portion (e.g., 740a) (e.g., a middle portion and/or a portion between a first end portion and a second end portion) of the scrolling region. In some embodiments, graphical elements nearer to the center of the scrolling region have a visual prominence that is greater than the visual prominence of graphical elements that are nearer to an end of the scrolling region (e.g., the graphical elements are progressively less visually prominent in proportion to their distance from the center). Not fading the set of one or more graphical elements at a center of the scrolling region provides visual feedback of the scrolling state and provides visual feedback that the content is being scrolled.

In some embodiments, scrolling through the scrollable content occurred in response to detecting a first portion of the user input and wherein a size and/or a shape of the scrolling region is changed in response to detecting an end of the user input (e.g., in response to detecting an end of input 750j, 750q, and/or 750t, device 700 and/or HMD X700 changes the size and/or shape of scrollbar track 730a and/or scrollbar thumb 732a) (e.g., a release of a touch input, a release of an air gesture, and/or a release of a mouse click). In some embodiments, the computer system scrolls the scrollable content in response to detecting a movement of the user input while the user input is maintained. Changing a size and/or shape of the scrolling region in response to detecting an end of an input provides visual feedback of the scrolling state and provides visual feedback that the input has ended.

In some embodiments, the computer system (e.g., 700 and/or X700) scrolls the scrollable content beyond the end of the scrollable content (e.g., scrolling past the end of content 708 in response to the input described and depicted in FIGS. 7J-7L, and/or 7R1-7V). After scrolling the scrollable beyond the end of the scrollable content, the computer system displays, via the display generation competent, an area (e.g., 748) beyond the end of the scrollable content (e.g., the scrollable content has been scrolled further from an edge of the user interface and/or the area does not include any content based scrolling beyond the end of the scrollable content). After scrolling the scrollable beyond the end of the scrollable content, the computer system displays, via the display generation component, the scrolling region with a respective size and/or a respective shape (e.g., the appearance of 730a, 732a, 730b, and/or 732b depicted in FIGS. 7K-7L, 7R1-7S, and/or 7U-7V). After scrolling the scrollable content beyond (e.g., past and/or further than) the end (e.g., in a first direction) and after displaying the area beyond the end of the scrollable content, the computer system scrolls (e.g., shifting and/or moving) the scrollable content back to the end of the scrollable content (e.g., scrolling back to the end of content 708 as described and depicted in FIGS. 7M, 7T, and/or 7W) (e.g., in a position that it was prior to displaying the area beyond the end of the scrollable content) and changes the respective size and/or the respective shape of the scrolling region (e.g., changing the appearance of 730a, 732a, 730b, and/or 732b as described and depicted in FIGS. 7M, 7T, and/or 7W) (e.g., the size and/or shape changes when the scrollable content snaps back). Changing a size and/or shape of the scrolling region when the scrollable content scrolls back after having been moved beyond an end of the scrollable content provides visual feedback of the scrolling state and provides visual feedback that the content has been scrolled beyond the end of the content.

In some embodiments, the scrolling indicator is displayed as having a respective state for a second visual characteristic (e.g., color, shade, and/or brightness of 730a and/or 732b) (e.g., color, shade, and/or luminance) including: in accordance with a determination that the underlying scrollable content (e.g., color, shade, and/or brightness of content 708) (e.g., the scrollable content that under the scrolling region) has a first appearance (e.g., brighter and/or darker) (e.g., color, shade, graphical content, and/or luminance), the respective state for the second visual characteristic is a first state (e.g., brighter or darker, as described in greater detail with respect to FIG. 7G) (e.g., color, shade, and/or luminance); and in accordance with a determination that the underlying scrollable content has a second appearance (e.g., brighter and/or darker), different from the first appearance, the respective state for the second visual characteristic is a second state (e.g., brighter and/or darker, as described in greater detail with respect to FIG. 7G) that is different from the first state. In some embodiments, the scrolling indicator is transparent or translucent. Conditionally displaying the scrolling indicator as having a first or second state for the second visual characteristic based on an appearance of the underlying content ensures the scrolling region is distinguishable and/or blends in with the underlying content.

In some embodiments, the first state of the second visual characteristic is darker (e.g., 730a and/or 732b a darker color) (e.g., less bright and/or lower luminance) than the second state of the second visual characteristic. In some embodiments, the first appearance of the underlying scrollable content is lighter (e.g., content 708 is a brighter color) (e.g., brighter and/or greater luminance) than the second appearance of the underlying scrollable content (e.g., the scrolling indicator is darker over lighter underlying content). Having a darker state for the scrolling region when the underlying content is lighter ensures the scrolling region is distinguishable from the underlying content.

In some embodiments, the first state of the second visual characteristic is lighter (e.g., 730a and/or 732b a lighter color, as described in greater detail with respect to FIG. 7G) (e.g., brighter and/or greater luminance) than the second state of the second visual characteristic. The first appearance of the underlying scrollable content is darker (e.g., content 708 is a darker color, as described in greater detail with respect to FIG. 7G) (e.g., less bright and/or lower luminance) than the second appearance of the underlying scrollable content (e.g., the scrolling indicator is lighter over darker underlying content). Having a lighter state for the scrolling region when the underlying content is darker ensures the scrolling region is distinguishable from the underlying content.

In some embodiments, while displaying the user interface, the computer system (e.g., 700 and/or X700) detects a hover input (e.g., 750b) (e.g., a hover air gesture and/or a gaze input) directed at the scrolling indicator. In some embodiments, the hover input includes an air gesture (e.g., flat hand, an air gesture that is different from an air pinch gesture, and/or a non-pinching gesture) and a gaze input. In response to detecting the hover input, the computer system changes a third visual characteristic (e.g., size and/or shape of 730a and/or 732a or 730b and/or 732b) (e.g., size, shape, and/or color) of the scrolling indicator from a first state, to a second state that is different from the first state. Detecting a hover input and, in response, changing a third visual characteristic of the scrolling indicator from a first state to a second state that is different from the first state provides visual feedback of a scrolling state of the computer system and provides visual feedback that a hover input was detected.

In some embodiments, displaying the user interface includes while a fourth visual characteristic (e.g., size, shape, and/or color) of the scrolling region from a first state (e.g., size and/or shape of 730a and/or 732a or 730b and/or 732b before a scrolling input; and/or 730a and/or 732a or 730b and/or 732b do not have notches 738 before a scrolling input), the computer system (e.g., 700 and/or X700) detects, via the one or more input devices, the user input to scroll the scrollable content. In response to detecting the user input to scroll the scrollable content, the computer system changes the fourth visual characteristic of the scrolling region to a second state (e.g., size and/or shape of 730a and/or 732a or 730b and/or 732b after the scrolling input; and/or 730a and/or 732a or 730b and/or 732b have notches 738 after the scrolling input), different from the first state. Detecting an input to scroll the scrollable content and, in response, changing a fourth visual characteristic of the scrolling region from a first state to the second state provides visual feedback of a scrolling state of the computer system and provides visual feedback that an input was detected.

In some embodiments, scrolling through the scrollable content includes horizontally and/or vertically scrolling through the content (e.g., the appearance of 730a, 732a, 730b, and/or 732b changes as depicted in FIGS. 7K-7L, 7R1-7S, and/or 7U-7V). In some embodiments, the end of the scrollable content is an end along a horizontal axis of the content and/or an end along a vertical axis of the content (e.g., the appearance of 730a, 732a, 730b, and/or 732b changes along the horizontal axis and/or the vertical axis, as depicted in FIGS. 7K-7L, 7R1-7S, and/or 7U-7V). In some embodiments, scrolling through the scrollable content includes scrolling in a horizontal direction (e.g., along an x-axis and/or along a first axis) and/or a vertical direction (e.g., along a y-axis and/or along a second axis that is perpendicular to the first axis). In some embodiments, the computer system scrolls the representation of content in the horizontal direction or the vertical direction if a scrolling input is directed to the horizontal scrolling region or if the scrolling input is directed to the vertical scrolling region, respectively (e.g., as described in 7A-7AF and 8). Changing the first visual characteristic of a horizontal scrolling region and/or a vertical scrolling region in response to detecting an end of the horizontal axis and/or an end of the vertical axis provides visual feedback of a scrolling state of the computer system and provides visual feedback of which direction the content is being scrolled.

In some embodiments, the scrolling indicator indicates scrolling along a first axis (e.g., 730a, 732a, 730b, and/or 732b) that is a horizontal axis (e.g., left or right) or a vertical axis (e.g., up and down). In some embodiments, displaying the user interface includes displaying, concurrently with the scrolling indicator, a second scrolling indicator (e.g., 730a, 732a, 730b, and/or 732b) that indicates scrolling along a second axis, different from the first axis (e.g., the second axis is a vertical axis when the first axis is a horizontal axis and vice versa). Concurrently displaying a scrolling indicator for one axis with a second scrolling indicator for a different axis provides visual feedback of a scrolling state of the computer system and provides visual feedback of a progress and direction the content is being scrolled.

In some embodiments, changing the first visual characteristic includes changing a size and/or a shape of the scrolling region without changing a size and/or a shape of a second scrolling region of the second scrolling indicator (e.g., as depicted in FIGS. 7R1-7T). In some embodiments, the size and/or the shape of the second scrolling region is not changed because the end of the content has not been reached along the second axis. Changing a size and/or a shape of the scrolling region without changing a size and shape of a second scrolling region provides visual feedback of a scrolling state of the computer system and provides visual feedback of a respective end of the content has been reached.

In some embodiments, changing the first visual characteristic includes changing a size and/or a shape of the scrolling region while changing a size and/or a shape of a second scrolling region of the second scrolling indicator (e.g., the size and/or shape of 730a and/or 732a while the size and/or shape of 730b and/or 732b changes, as depicted in FIGS. 7U-7V) (e.g., because the ends of both the first and second axis have been reached). In some embodiments, the size and/or the shape of both the first scrolling region and the second scrolling region are changed because two different ends of the content have been reached. In some embodiments, the size and/or the shape of both the first scrolling region and the second scrolling region are changed after one scrolling region is changed because two different ends of the content have been reached after only one end was reached. Changing a size and/or a shape of the scrolling region while changing a size and/or a shape of a second scrolling region of the second indicator provides visual feedback of a scrolling state of the computer system and provides visual feedback when multiple ends of the content have been reached.

In some embodiments, changing the size and/or the shape of the scrolling region while changing the size and/or the shape of the second scrolling region of the second scrolling indicator includes in accordance with a determination that the scrollable content has been scrolled beyond an end (the right end and/or the bottom end of content 708 of FIGS. 7U-7V) (e.g., a top end, a bottom end, a left end, and/or right end) of the scrollable content along a first axis that is a horizontal axis or a vertical axis by a third amount of scrolling (e.g., the amount of scrolling beyond the right end of content 708 and/or the amount of scrolling beyond the bottom end of content 708, as depicted in FIGS. 7U-7V), updating an appearance of the scrolling region with a first change in the size and/or the shape of the scrolling region that is based on (e.g., proportional to and/or in accordance with) the third amount of scrolling of the scrollable content (e.g., the size and/or shape of 730a and/or 732a is changed based on how far content 708 is scrolled beyond the bottom end, as depicted in FIGS. 7U-7V; and/or the size and/or shape of 730b and/or 732b is changed based on how far content 708 is scrolled beyond the right end, as depicted in FIGS. 7U-7V). In some embodiments, changing the size and/or the shape of the scrolling region while changing the size and/or the shape of the second scrolling region of the second scrolling indicator includes in accordance with a determination that the scrollable content has been scrolled beyond an end (e.g., a top end, a bottom end, a left end, and/or right end) of the scrollable content along a second axis (the right end and/or the bottom end of content 708 of FIGS. 7U-7V), different from the first axis, by a fourth amount of scrolling of the scrollable content (e.g., the amount of scrolling beyond the right end of content 708 and/or the amount of scrolling beyond the bottom end of content 708, as depicted in FIGS. 7U-7V), different from the third amount, updating an appearance of the scrolling region with a second change in the size and/or the shape of the second scrolling region that is based on (e.g., proportional to and/or in accordance with) the fourth amount of scrolling of the scrollable content, wherein the second change in the size and/or shape of the scrolling region is different from the first change in the size and/or shape of the scrolling region (e.g., the size and/or shape of 730a and/or 732a is changed based on how far content 708 is scrolled beyond the bottom end, as depicted in FIGS. 7U-7V; and/or the size and/or shape of 730b and/or 732b is changed based on how far content 708 is scrolled beyond the right end, as depicted in FIGS. 7U-7V). Conditionally changing a size and/or shape of the scrolling region and conditionally changing a size and/or shape of the second scrolling region based on an amount that the scrollable content has been scrolled beyond a third end and fourth end, respectively, performs an operation when a set of conditions has been met without requiring any further input and provides visual feedback when multiple ends of the content have been reached.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve how content is scrolled. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve how content is scrolled. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of how content is scrolled, the present technology can be configured to allow users to select to “opt in” or “opt out” of participation in the collection of personal information data during registration for services or anytime thereafter. In another example, users can select not to provide data for how content is scrolled. In yet another example, users can select to limit the length of time data is maintained or entirely prohibit the development of how content is scrolled. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, scrolling preferences can be generated based on non-personal information data or a bare minimum amount of personal information, such as the content being requested by the device associated with a user, other non-personal information available to the service, or publicly available information.

1-90. (canceled)

91. A computer system configured to communicate with a display generation component and one or more input devices, comprising:
one or more processors; and
memory storing one or more programs configured to be executed by the one or more processors, the one or more programs including instructions for:
displaying, via the display generation component, a graphical user interface including:
a representation of content; and
a scrolling indicator;
detecting, via the one or more input devices, a first set of one or more inputs that includes a first input directed at the scrolling indicator; and
in response to detecting the first set of one or more inputs:
in accordance with a determination that the first input includes a first magnitude of movement, scrolling the representation of content at a first rate; and
in accordance with a determination that the first input includes a second magnitude of movement, different from the first magnitude of movement, scrolling the representation of content at a second rate different from the first rate.

92. The computer system of claim 91, the one or more programs further including instructions for:
after scrolling the representation of content at a respective rate and while continuing to detect the first input, detecting that movement of the first input has ceased; and
in response to detecting that movement of the first input has ceased, while the first input continues to be detected, continuing to scroll the representation of content at the respective rate.

93. The computer system of claim 91, the one or more programs further including instructions for:
while continuing to scroll the representation of content at the respective rate, detecting that the first input has ended; and
in response to detecting that the first input has ended, ceasing to scroll the representation of the content.

94. The computer system of claim 93, wherein ceasing to scroll the representation of content includes gradually decreasing a rate at which the representation of the content is being scrolled until scrolling ceases.

95. The computer system of claim 92, the one or more programs further including instructions for:
after detecting that the movement of the first input has ceased and while the first input continues to be detected, detecting additional movement of the first input; and
in response to detecting the additional movement of the first input, changing the respective rate of scrolling the representation of content.

96. The computer system of claim 91, the one or more programs further including instructions for:
before scrolling the representation of content at a second respective rate, detecting, via the one or more input devices:
a first portion of the first input at a first position; and
a second portion, after the first portion, of the first input that includes a respective magnitude of movement away from the first position; and
in response to detecting the second portion of the first input, beginning to scroll the representation of content at the second respective rate.

97. The computer system of claim 91, wherein:
the representation of content is scrolled in a first direction; and
a respective magnitude of movement includes a first component that is based on movement of the first input along an axis that is parallel to the first direction.

98. The computer system of claim 91, wherein:
the representation of content is scrolled in a second direction; and
a second respective magnitude of movement of the first input includes a second component that is based on movement of the first input along an axis that is perpendicular to the second direction.

99. The computer system of claim 98, wherein:
the movement of the first input along the axis that is perpendicular to the second direction is movement of the first input along an axis that is parallel a depth direction that extends outward away from a viewpoint of a user of the computer system of the computer system.

100. The computer system of claim 98, wherein:
the respective magnitude of movement is based on a rotation of a body part of the user of the computer system.

101. The computer system of claim 100, wherein the rotation of the body part includes a rotation of a wrist of the user.

102. The computer system of claim 101, wherein:
the representation of content is scrolled in a first direction; and
the respective magnitude of movement is based on:
a movement of the first input along an arc defined by the wrist of the user and one or more fingers of the user; and
a distance of movement of the first input along an axis that is parallel to the first direction of scrolling the content.

103. The computer system of claim 91, wherein:
scrolling the representation of content at the first rate includes scrolling the representation of content in a same direction as a direction of the first input; and
scrolling the representation of content at the second rate includes scrolling the representation of content in a same direction as a direction of the first input.

104. The computer system of claim 91, wherein detecting the first set of one or more inputs includes detecting a gaze input and a movement of an air gesture.

105. The computer system of claim 91, the one or more programs further including instructions for:
detecting, via the one or more input devices, a fourth input directed to the representation of content; and
in response to detecting the fourth input:
in accordance with a determination that the fourth input includes a first amount of movement, scrolling the representation of content at a first rate of scrolling that is based on the first amount of movement; and
in accordance with a determination that the fourth input includes a second amount of movement, scrolling the representation of content at a second rate of scrolling that is based on the second amount of movement and that is different from the first rate of movement.

106. The computer system of claim 91, wherein the first input is a first input type, the one or more programs further including instructions for:
detecting, via the one or more input devices, a fifth input of a second input type, different from the first input type, directed to the representation of content; and
in response to detecting the fifth input:
in accordance with a determination that the fifth input includes a fifth rate of movement, scrolling the representation of content at a rate of scrolling that is based on the fifth rate of movement of the input.

107. The computer system of claim 91, the one or more programs further including instructions for:
prior to displaying the graphical user interface that includes the scrolling indicator, displaying the graphical user interface including the representation of content without including the scrolling indicator;
while displaying the graphical user interface including the representation of content without including the scrolling indicator, detecting a request to scroll the representation of content; and
in response to detecting the request to scroll the representation of content:
scrolling the representation of content; and
displaying, via the display generation component, the scrolling indicator.

108. The computer system of claim 91, wherein:
detecting the first set of one or more inputs includes detecting a fifth portion of the first input; and
in response to detecting the fifth portion of the first input, changing an appearance of the scrolling indicator.

109. The computer system of claim 108, wherein changing the appearance includes:
adding a set of one or more graphical elements to the scrolling indicator that scroll under a moveable element of the scrolling indicator that is moved when the representation of content is being scrolled.

110. The computer system of claim 91, wherein displaying the graphical user interface includes:
displaying the scrolling indicator with a first appearance while not detecting input directed to the scrolling indicator; and
displaying the scrolling indicator with a second appearance, different from the first appearance, when a first hover input is detected.

111. The computer system of claim 91, wherein:
prior to scrolling the representation of content at a respective rate and while detecting a second hover input directed at the scrolling indicator, the scrolling indicator is displayed with a third appearance; and
while scrolling the representation of content at a respective rate in response to detecting the first set of one or more inputs, the scrolling indicator is displayed with a fourth appearance, different from the third appearance.

112. The computer system of claim 91, the one or more programs further including instructions for:
detecting, via the one or more input devices, a first flick input directed to the representation of content and in a third direction; and
in response to detecting the first flick input, scrolling the representation of content by a predetermined amount.

113. The computer system of claim 112, the one or more programs further including instructions for:
detecting, via the one or more input devices, a second flick input directed to the representation of content and in a fourth direction that is different from the third direction; and
in response to detecting the second flick input, scrolling the representation of content by the predetermined amount.

114. The computer system of claim 91, wherein:
scrolling the representation of content at the first rate includes scrolling in a horizontal direction and/or a vertical direction; and
scrolling the representation of content at the second rate includes scrolling in the horizontal direction and/or the vertical direction.

115. The computer system of claim 91, wherein:
the first input that includes the first magnitude of movement is an input of a first type;
the first input that includes the second magnitude of movement is an input of the first type;
scrolling the representation of the content at the first rate or at the second rate corresponds to a first manner of scrolling; and
the one or more programs further including instructions for:
in response to detecting the first set of one or more inputs:
in accordance with a determination that the first input is a fourth input type, different from the first input type, scrolling the representation of content in a second manner that is different from the first manner.

116. The computer system of claim 91, wherein:
scrolling the representation of content at the first rate includes providing a first type of non-visual feedback while scrolling the representation of content.

117. The computer system of claim 91, wherein scrolling the representation of content at the first rate includes a first scrolling portion and second scrolling portion that corresponds to an end of the first input, including:
providing a second type of non-visual feedback during the first scrolling portion; and
providing a third type of non-visual feedback, different from the second type of non-visual feedback, during the second scrolling portion.

118. The computer system of claim 116, the one or more programs further including instructions for:
detecting a request to scroll the representation of content that includes a sixth input directed at the representation of content; and
in response to detecting the request to scroll the representation of content that includes the sixth input directed at the representation of content, providing a fourth type of non-visual feedback, different from the first type of non-visual feedback, while scrolling the representation of content.

119. The computer system of claim 91, the one or more programs further including instructions for:
detecting a request to select a selectable user interface object; and
in response to detecting the request to select the selectable user interface object, providing a respective type of non-visual feedback.

120. The computer system of claim 119, wherein providing the respective type of non-visual feedback is based on a non-visual feedback setting, including:
in accordance with a determination that an object being selected as the selectable user interface object has a designated type of non-visual feedback, the respective non-visual feedback is the designated type of non-visual feedback; and
in accordance with a determination that the object being selected as the selectable user interface object does not have a designated type of non-visual feedback, the respective type of non-visual feedback is a default type of non-visual feedback.

121. The computer system of claim 91, the one or more programs further including instructions for:
while displaying the graphical user interface that includes the representation of content and the scrolling indicator:
detecting, via the one or more input devices, a second set of one or more inputs that includes a first respective input directed at the scrolling indicator; and
in response to detecting the second set of one or more inputs:
in accordance with a determination that the first respective input includes a first amount of movement, scrolling the representation of content by a first amount; and
in accordance with a determination that the first respective input includes a second amount of movement, different from the first amount of movement, scrolling the representation of content by a second amount, different from the first amount.

122. The computer system of claim 121, wherein:
displaying the graphical user interface includes displaying a cursor;
detecting the second set of one or more inputs includes detecting an air gesture that includes movement of at least a portion of a hand of a user of the computer system; and
the one or more programs further including instructions for:
in response to detecting the second set of one or more inputs, moving a position of the cursor based on the detected movement of the at least a portion of the hand of the user of the computer system.

123. The computer system of claim 121, wherein:
the one or more input devices includes a touch-sensitive surface;
displaying the graphical user interface includes displaying a cursor;
detecting the second set of one or more inputs includes detecting, via the touch-sensitive surface, movement of a contact; and
the one or more programs further including instructions for:
in response to detecting the second set of one or more inputs, moving a position of the cursor based on the detected movement of the contact.

124. The computer system of claim 121, wherein:
detecting the first set of one or more inputs includes detecting a sixth portion of the first input; and
the one or more programs further including instructions for:
in response to detecting the sixth portion of the first input, changing an appearance of the scrolling indicator in a first manner; and
in response to detecting the second set of one or more inputs, forgoing changing the appearance of the scrolling indicator in the first manner.

125. The computer system of claim 91, the one or more programs further including instructions for:
while displaying the graphical user interface that includes the representation of content and the scrolling indicator:
detecting, via the one or more input devices, a third set of one or more inputs that includes a second respective input directed at the scrolling indicator; and
in response to detecting the third set of one or more inputs:
in accordance with a determination that the second respective input is directed to a first portion of the scrolling indicator, navigating to a first predetermined position within the representation of the content.

126. The computer system of claim 125, wherein the second respective input is a stationary input.

127. The computer system of claim 125, wherein the first predetermined position within the representation of the content is at a first end of the representation of the content.

128. The computer system of claim 125, the one or more programs further including instructions for:
in response to detecting the third set of one or more inputs:
in accordance with a determination that the second respective input is directed to a second portion of the scrolling indicator, different from the first portion, to a second predetermined position within the representation of the content.

129. A non-transitory computer-readable storage medium storing one or more programs configured to be executed by one or more processors of a computer system that is in communication with a display generation component and one or more input devices, the one or more programs including instructions for:
displaying, via the display generation component, a graphical user interface including:
a representation of content; and
a scrolling indicator;
detecting, via the one or more input devices, a first set of one or more inputs that includes a first input directed at the scrolling indicator; and
in response to detecting the first set of one or more inputs:
in accordance with a determination that the first input includes a first magnitude of movement, scrolling the representation of content at a first rate; and
in accordance with a determination that the first input includes a second magnitude of movement, different from the first magnitude of movement, scrolling the representation of content at a second rate different from the first rate.

130. A method, comprising:
at a computer system that is in communication with a display generation component and one or more input devices:
displaying, via the display generation component, a graphical user interface including:
a representation of content; and
a scrolling indicator;
detecting, via the one or more input devices, a first set of one or more inputs that includes a first input directed at the scrolling indicator; and
in response to detecting the first set of one or more inputs:
in accordance with a determination that the first input includes a first magnitude of movement, scrolling the representation of content at a first rate; and
in accordance with a determination that the first input includes a second magnitude of movement, different from the first magnitude of movement, scrolling the representation of content at a second rate different from the first rate.
